(19) United States
(12) Patent Application Publication
(10) Pub. No.: US 2016/0267060 A1
(43) Pub. Date: Sep. 15, 2016

(54) WEB CONTENT CAPTURING, PACKAGING, DISTRIBUTION

(71) Applicant: SAVNOR TECHNOLOGIES LLC, REHOBOTH BEACH (DE)

(72) Inventors: Alexander R. Skirpa, Richmond, CA (US); Eric Todd Fletcher, Asburn, VA (US)

(73) Assignee: SAVNOR TECHNOLOGIES LLC, REHOBOTH BEACH, DE (US)

(21) Appl. No.: 14/932,916

(22) Filed: Nov. 4, 2015

Related U.S. Application Data
(63) Continuation of application No. 13/209,422, filed on Aug. 14, 2011, now abandoned.
Application No. 13/209,422 is a continuation-in-part of application No. 12/605,313, filed on Oct. 23, 2009, now Pat. No. 8,365,082.
(60) Provisional application No. 61/254,371, filed on Oct. 23, 2009.
(60) Provisional application No. 61/107,960, filed on Oct. 23, 2008.

(51) Int. Cl. G06F 17/21; G06F 17/22; G06T 11/00

(52) U.S. Cl. CPC G06F 17/218; G06T 11/001; G06F 17/2247; G06F 17/212

(57) ABSTRACT

Computer tools, processes, and systems for capturing web content are provided. A webpage is rendered on a user device. An area within the rendered webpage is selected. Metadata describing the location of the web content within the selected area of the rendered webpage is determined and persistently stored within a database. A window is provided on a user device rendering the web content corresponding to the selected area. The web content is rendered within the window in the same context as the web content was initially rendered on the user device. The rendered web content may include partial objects or elements of the web page and provide all the functionality normally associated with the web content. The web content may be shared with other users including sending a message with a link configured to render the web content corresponding to the selected area on a user device.

### CROSS-REFERENCE TO RELATED APPLICATIONS

This application is a continuation of U.S. patent application Ser. No. 13/209,422 titled “WEB CONTENT CAPTURING, PACKAGING, DISTRIBUTION” filed Aug. 14, 2011, which is continuation-in-part of U.S. patent application Ser. No. 12/605,313 titled “A UNIVERSAL CONTENT REFERENCING, PACKAGING, DISTRIBUTION SYSTEM, AND A TOOL FOR USER CUSTOMIZATION OF WEB CONTENT” filed Oct. 23, 2009 now U.S. Pat. No. 8,365,082, which claims the benefit under 35 U.S.C. §119(e) of U.S. Provisional Application No. 61/107,960, titled “WEB PAGE CONTENT COLLECTION AND SHARING” filed on Oct. 23, 2008 in the U.S. Patent and Trademark Office and U.S. Provisional Application No. 61/254,371, titled “FOLDABLE FAVICON TITLE BAR BROWSER INTERFACE AND UNIVERSAL CONTENT REFERENCING, PACKAGING, DISTRIBUTION SYSTEM, AND WIDGET GENERATOR” filed on Oct. 23, 2009 in the U.S. Patent and Trademark Office, all of which are herein incorporated by reference in their entirety for all purposes.

### TECHNICAL FIELD

The field of the invention generally relates to a computer tool, a method, and a system and in particular with a specialized computer tool, method, and system for a browser, browser plug-in, or browser extension including a web button or mobile browser.

### BACKGROUND

The Internet provides access to unprecedented amount of information and content. On the World Wide Web, users may access content provided by web pages on websites. A web page provides content or resource of information that is suitable for the World Wide Web. Typically a web page is accessed through a web browser running on a computer which utilizes a layout or rendering engine to render the web content for presentation to a user. The content is typically provided in a hypertext markup language (HTML), eXtensible hypertext Markup Language (XHML) format and may provide navigation to other web pages via hypertext links.

Users of the Internet have numerous tools available for presenting, parsing and collecting content from web pages. User may bookmark web pages using social bookmarking content collection services, such as Digg, Kaboodle, AddThis, Netvibes, and IGoogle among others, to identify and access web content, RSS feeds, and Podcasts. These services generally allow users to easily identify, access, and reference content provided by a web publisher, but only in the form created, provided, or specified by the web publisher or creator of the content.

Generally a user accesses the content through a web browser. When a user views a web page using a conventional web browser, the user may modify how the browser displays the content to a minimal extent. For example, the user may be able to increase the size of the text displayed, maximize or minimize the browser, and adjust the size of the window displaying the content, scroll through content displayed, block or enable scripts and popup windows, and may move the position of the browser display on a desktop environment the screen. When the window or display of the browser presents less than all of the content on a page, various browser functions (e.g., scroll bars) permit the user to manipulate the content displayed within the window or display. Many web pages display a large amount of content on a single page that may include many different types of content. However, a user only may have interest in a certain portion of the web page. When trying to collect or share this information it is sometimes difficult to point to or describe the area of interest to the user. Often, a user may share a link to the web page using an identifier, such as a uniform resource locator (URL); however, the URLs merely points to the entire page making it difficult for the user to convey only the desired portion.

### SUMMARY

In one general aspect, computer tools, devices, processes, software, and systems for capturing web content are provided. In general, a webpage is rendered on a user device. An area within the rendered webpage is selected for capture. Metadata describing the location of the web content within the selected area of the rendered webpage is determined and persistently stored within a database. A window is provided on a user device rendering the web content corresponding to the selected area. In one aspect, the dimension of the window may be substantially equal to the dimensions of the area selected for capture. The web content is rendered within the window in the same context as the web content was initially rendered on the user device and may be manipulated and interacted with. The rendered web content may include partial objects or elements of the web page and provide all the functionality normally associated with the web content. The web content may be shared with other users including sending a message with a link configured to render the web content corresponding to the selected area on a user device.

In one general aspect, a system for capturing content of a web page provided by a web content provider system includes a user device and a system service provider. The user device is configured to render the webpage provided by the web content provider system; define an area of the webpage of the web content provider system measured in pixels selected by a user input device for capture; determine metadata describing a location of the capture area within the webpage; render the captured web content corresponding to the capture area of the webpage in an interface window. The service provider system is configured to receive the metadata describing the location of the capture area of the webpage from the user device; create markup tags from the received metadata configured to render the captured web content corresponding to the capture area in the interface window; and transmit the markup tags configured to render the captured web content to the user device. The service provider system may be further configured to process the metadata describing the location of the capture area for persistent storage within a database, retrieve the processed metadata, and process the retrieved metadata to create the markup tags configured to render the captured web content. The service provider system also may cache a copy of the webpage of the web content provider system from which the web captured content is captured.

The dimensions of the capture area and the dimensions of the interface window may be measured in pixels. The dimensions of the capture area may be substantially equal to the dimensions of the interface window. A pixel of the rendered webpage may be used as anchor coordinates for determining the location of the capture area within the webpage.

The markup tags also may be configured to position the interface window at the location of the capture area within the webpage, for example, as determined according to the anchor coordinates. In addition, the interface window may be configured to render the web content provides any functionality associated with the web content.

A contiguous boundary of pixels may be rendered bounding the capture area according to input received from a user input device, where the captured web content corresponding to the web content rendered within the contiguous boundary.

The user device may render any partial objects or elements of the web page that fall within the capture area in the interface window.

The service provider system may share the captured web content by providing the markup tags to one or more other user devices. The service provider system also may share the captured web content by providing the markup tags to one or more social networking or personal start page websites. The service provider system also may share web content by sending an electronic message configured to access the markup tags corresponding to the captured web content.

The service provider system also may determine an advertisement based on the captured web content; and provide the advertisement in association with presentation of the captured web content. In addition, the service provider system may determine an advertisement based on the web content; and to provide the advertisement in association with the shared web content. The service provider system may receive an indication of a user action in association with the advertisement; and credit a user who shared the captured web content associated with the advertisement.

The markup tags configured to render the web content may be configured to render substantially only the web content corresponding to the area of the webpage.

In another general aspect, a system for capturing web content of a webpage provided by a web content provider system rendered by a user device includes one or more processing devices; and one or more storage devices storing instructions that, when executed by the one or more processing devices, cause the one or more processing devices to receive metadata from the user device describing a location of a capture area within the webpage selected by a user; determine markup tags configured to present web content corresponding to the user selected capture area within the webpage in an interface window; and transmit the markup tags configured to present the web content to the user device.

The received metadata defining the user selected capture area within the webpage may include the dimensions of the user selected capture area in pixels. The received metadata may specify offsets indentifying anchor coordinates of the capture area corresponding to a pixel within the webpage used, for example, to position the interface window relative to the webpage.

The markup tags may be hypertext markup language (HTML) markup tags indicating the dimensions of the interface window measured in pixels. In addition, the dimensions of the interface window may be substantially equal to the dimensions of the capture area. The HTML may include an offset to position the interface window at a location corresponding to the user selected capture area within the webpage. The markup tags also may include an offset to position the interface window relative to the webpage to present the web content of the user selected capture area within the interface window. The markup tags also may be configured to render any partial objects or elements of the web page that fall within the selected capture area.

An indication may be received from the user device to capture cached web content, and the system may further include a cache to store a copy of the webpage.

The web content may be shared by providing the markup tags to one or more other identified users via an electronic communication or by providing metadata formatted to share the web content to one or more social networking or personal start page websites. In one example, an electronic communication may be sent with a unique identification corresponding to the captured web content. When the unique identification is received from a client device presenting the electronic communication, metadata is retrieved corresponding to the unique identification. As a result, the markup tags are transmitted to a browser of the client device configured to present the web content.

In addition, an advertisement may be determined based on the web content; and the advertisement may be provided for presentation by a user device in association with presentation of the web content. An indication of a user action in association with the advertisement may be received; and an account of a user who shared the web content associated with the advertisement may be credited.

In yet another general aspect, a user device for capture of web content of a rendered webpage provided by a web content provider system includes one or more processing devices; and one or more storage devices storing instructions that, when executed by the one or more processing devices, cause the one or more processing devices to: provide an indication of an area of the rendered webpage selected according to input from a user input device for capture; determine metadata describing a location of the selected capture area within the webpage; and present the captured web content corresponding to the selected capture area of the webpage within an interface window.

The dimensions of the selected capture area may be determined in pixels. A pixel of the rendered webpage may be identified as anchor coordinates for determining the location of the capture area within the webpage. In addition, the dimensions of the selected capture area may be substantially equal to the dimensions of the interface window.

The metadata describing the location of the selected user defined capture area of the rendered webpage may be transmitted to a service provider system. Markup tags may then be received from the service provider system configured to present the captured web content within the interface window. The received markup tags also may indicate a position for the interface window corresponding to the location of the selected capture area within the webpage. An offset determined from the received markup tags may be used to position the interface window at the location of the selected capture area within the webpage. The interface window may be positioned relative to the webpage to present the web content of the selected capture area within the window. Any partial objects or elements of the web page that fall within the selected capture area also may be presented.

An electronic communication may be initiated to share the captured web content, and a predetermined advertisement selected in association with the captured web content may be presented.

In yet another general aspect, a user device to present captured web content of a webpage provided by a web content provider system includes one or more processing devices; and one or more storage devices storing instructions that, when executed by the one or more processing devices, cause the one or more processing devices to: determine the location of a selected capture area of the webpage; and render the captured web content corresponding to the selected capture area within a window of an interface of the user device.

A pixel of the webpage may be identified as anchor coordinates for determining the location of the capture area within the webpage. The dimensions of the interface window may be determined in pixels. The dimensions of the selected capture area may be substantially equal to the dimensions of the interface window. Any partial objects or elements of the web page that fall within the selected capture area of the webpage may be presented.

Markup tags may be received from a service provider system, and the location of the selected capture area may be determined from the received markup tags. The received markup tags also may indicate a position for the window that corresponds to the location of the selected capture area within the webpage. An offset may be determined to position the window of the interface at the location of the selected capture area within the webpage to present the captured web content within the window of the interface. A predetermined advertisement selected in association with the captured web content may be presented. Data may be received from a service provider system to create mark up tags from the data and to determine the location of the selected capture area using the markup tags

In yet another general aspect, software stored in a storage device for capture of web content of a webpage provided by a web content provider system includes instructions configured to cause one or more processing devices to: receive metadata from the user device describing a location of a capture area within the webpage selected by a user; determine markup tags configured to present web content corresponding to the user selected capture area within the webpage in an interface window; and transmit the markup tags configured to present the web content to the user device.

The software may include instructions to receive metadata defining the dimensions of the user selected capture area in pixels. The software may include instructions to provide dimensions of the interface window where the dimensions of the window are substantially equal to the dimensions of the capture area. The software may include instructions to determine an offset to position the interface window at the location of the user selected capture area within the webpage. The software may include instructions to transmit markup tags configured to present the web content including an offset to position the interface window relative to the webpage to present the web content of the user selected capture area within the interface window.

The software may include instructions to receive metadata including specifying offsets indentifying anchor coordinates of the capture area corresponding to a pixel within the webpage. The software also may include instructions to receive an indication from the user device to capture cached web content and to store a copy of the webpage.

The software may include instructions to transmit markup tags configured to render any partial objects or elements of the web page that fall within the selected capture area.

The software may include instructions to share the web content by providing the markup tags configured to present the web content to one or more other identified users via an electronic communication or by providing metadata formatted to share the web content to one or more social networking or personal start page websites.

The software may include instructions to send an electronic message configured to send an electronic communication with a unique identification corresponding to the web content; receive the unique identification from a client device presenting the electronic communication; retrieving metadata corresponding to the unique identification; transmit the markup tags to a browser of the client device configured to present the web content.

The software may include instructions to determine an advertisement based on the web content; and to provide the advertisement for presentation by a user device in association with presentation of the web content.

The software may include instructions to determine an advertisement based on the web content; and to provide the advertisement for presentation in association with the shared web content. The software also may include instructions to receive an indication of a user action in association with the advertisement; and to credit an account of a user who shared the web content associated with the advertisement.

In yet another general aspect, software stored in a storage device for capture of web content of a rendered webpage provided by a web content provider system includes instructions configured to cause one or more processing devices to: provide an indication of an area of the rendered webpage selected according to input from a user input device for capture; determine metadata describing a location of the selected capture area within the webpage; and present the captured web content corresponding to the selected capture area of the webpage within an interface window.

The software may include instructions to identify a pixel of the rendered webpage as an anchor coordinates for determining the location of the capture area within the webpage. The software also may include instructions to cause the one or more processing devices to determine the dimensions of the selected capture area in pixels. The software also may include instructions to determine the dimensions of the selected capture area to be substantially equal to the dimensions of the interface window.

The software may include instructions to transmit the metadata describing the location of the selected user defined capture area of the rendered webpage to a service provider system and to receive markup tags from the service provider system configured for use by the one or more processing devices to present the captured web content within the interface window.

The software may include instructions to receive markup tags configured to position the interface window corresponding to the location of the selected capture area within the webpage. The software also may include instructions to use an offset determined from the received markup tags to position the interface window at the location of the selected capture area within the webpage. The software may include instructions to position the interface window relative to the webpage to present the web content of the selected capture area within the window.

The software may include instructions configured to initiate an electronic communication configured to share the captured web content.

The software may include instructions to present a predetermined advertisement selected in association with the captured web content.

The software may include instructions to present any partial objects or elements of the web page that fall within the selected capture area.

In yet another general aspect, software stored in a storage device to present captured web content of a webpage provided by a web content provider system includes instructions configured to cause one or more processing devices to: determine the location of a selected capture area of the webpage; and render the captured web content corresponding to the selected capture area within a window of an interface of the user device.

The software may include instructions to identify a pixel of the webpage as anchor coordinates for determining the location of the capture area within the webpage. The software also may include instructions to determine the dimensions of the interface window in pixels. The software also may include instructions to determine the dimensions of the selected capture area to be substantially equal to the dimensions of the interface window. The software may include instructions to present any partial objects or elements of the web page that fall within the selected capture area of the webpage.

The software may include instructions to receive markup tags from a service provider system and to determine the location of the selected capture area from the received markup tags. The software also may include instructions configured to receive markup tags configured to position the window corresponding to the location of the selected capture area within the webpage.

The software may include instructions to determine an offset to position the window of the interface at the location of the selected capture area within the webpage to present the captured web content within the window of the interface.

The software may include instructions to present a predetermined advertisement selected in association with the captured web content.

In yet another general aspect, a method for capturing web content of a webpage provided by a web content provider system rendered in an interface window of the user device a user device, the method comprising: rendering an indication of an area specified by a user input device for capture in the interface window; determining the dimensions of the rendered indication of the capture area by a processing device; determining coordinates associated with the rendered indication of the capture area by the processing device; determining offsets associated with the coordinates relative to the position of the rendered indication within the webpage by the processing device; and transmitting the determined dimensions and the determined offsets to a system service provider for capture of the web content rendered within the indication of the capture area.

The dimensions may be determined or measured in pixels. A pixel corresponding to the coordinates also may be determined. A rectangle bounding the capture area may be rendered according to input from the user input device. The dimensions of the rectangle may be determined, and the location of the upper left hand corner of the rectangle may be determined as the coordinates. An x offset and a y offset specifying the location of the coordinates relative to the upper left hand corner of the webpage also may be determined.

In yet another general aspect, a method of presenting web content captured from a webpage of a web content provider system performed by one or more processing devices includes: retrieving metadata corresponding to a capture operation from a database including the location of a user specified captured area within a webpage corresponding to the captured web content; determining the dimensions of an interface window to present the captured web content from the retrieved metadata; determining an offset from the retrieved metadata to position the interface window relative to the webpage to present the captured web content within the interface window; creating a data structure populated with at least some of the retrieved metadata and the determined size and the determined offset; translating the data structure into markup tags configured to display the captured web content of the webpage in the interface window on a client device; and transmitting the markup tags to a browser of the client device.

The dimensions determined in pixels. An x offset and a y offset of anchor coordinates of the captured area within the webpage also may be determined. The dimensions of a rectangle bounding the capture area measured in pixels may be determined. An x offset and a y offset specifying the location of the upper left hand corner of the rectangle relative to the upper left hand corner of the webpage also may be determined.

The method also may include determining a context of the captured web content using at least some of the metadata; selecting an electronic advertisement corresponding to the determined context; and serving the electronic advertisement for presentation by the client device.

The method also may include creating an image of the captured web content; analyzing the image to determine a context of the image; selecting an electronic advertisement corresponding to the determined context; and serving the electronic advertisement for presentation by the client device.

The method also may include receiving an indication from a user to share the captured web content with a social networking website or personal start-webpage; translating the metadata into format compatible with an application programming interface (API) of the social networking website or personal start webpage; and transmitting the translated metadata to the social networking website or personal start webpage to present the captured user specified web content.

The method also may include receiving an indication from a user to share the captured web content with a social networking website or personal start-webpage; translating the metadata into format compatible with an API of the social networking website or personal start webpage; and transmitting the translated metadata to the social networking website or personal start webpage to present the captured user specified web content.

The method also may include receiving an indication from a user to share the captured web content; sending an electronic communication with a unique identification corresponding to the captured web content; and receiving the unique identification from a client device presenting the electronic communication, wherein retrieving metadata corresponding to the capture operation including retrieving metadata corresponding to the unique identification; and transmitting the markup tags includes transmitting the markup tags to a browser of the client device presenting the electronic communication.

In yet another general aspect, a method of providing a heat map configured to present capture operations corresponding to user specified content captured from a website includes displaying an iframe instance with a source attribute set to a uniform resource locator (URL) corresponding to the website; iteratively displaying a collection of capture metadata objects associated with the capture operations of user specified captured areas within the webpage corresponding to the captured web content, including for each capture metadata object in the collection: creating a transparent markup tag element; and incrementing a z-index attribute for each markup tag element, creating a series of floating layers stacked on top of the iframe for each markup tag element, wherein each markup tag element is created using capture metadata corresponding to a capture operation of a user specified captured area within the webpage.

Each markup tag element may be created having a colored border configured to aid visually identification of a captured area associated with a corresponding capture operation. Each markup tag element also may be created with a transparent masking configured to aid visually identification of a captured area associated with a corresponding capture operation. Where two markup tag elements overlap, the masking of the corresponding overlapping area may be visually distinguished. Where two markup tag elements overlap the transparency of the corresponding overlapping area is decreased.

In yet another general aspect, a method for sharing user specified captured web content on a social networking website or personal start webpage includes capturing the user specified web content via a capture operation; receiving an indication from a user to share the captured user specified web content with the social networking website or personal start webpage; retrieving metadata describing a location of a user specified captured area within a webpage corresponding to the captured user specified web content; translating the metadata into format compatible with an application programming interface (API) of the social networking website or personal start webpage; and transmitting the translated metadata to the social networking website or personal start webpage to present the captured user specified web content.

In yet another general aspect, a system configured to serve electronic advertisements to a client device presenting captured web content of a webpage includes one or more processing devices; and one or more storage devices storing instructions that, when executed by the one or more processing devices, cause the one or more processing devices to: determine metadata of a capture operation of the captured web content corresponding to a selected user defined capture area of the webpage; determine a context of the web content using the metadata; select an electronic advertisement corresponding to the determined context; and serve the electronic advertisement for presentation by the client device.

In yet another general aspect, a system configured to serve electronic advertisements to a client device presenting captured web content of a webpage includes one or more processing devices; and one or more storage devices storing instructions that, when executed by the one or more processing devices, cause the one or more processing devices to: determine metadata of a capture operation of the captured web content corresponding to a selected user defined capture area of the webpage; create an image of the user defined capture area of the webpage; analyze the image to determine a context of the image; select an electronic advertisement corresponding to the determined context; and serve the electronic advertisement for presentation by the client device.

In yet another general aspect, a method for publishing user specified captured web content on a webpage includes: capturing the user specified web content via a capture operation; receiving an indication from a user to share the captured user specified web on a personal webpage of a user hosted by a service provider system; retrieving metadata describing a location of the user specified captured area within a webpage corresponding to the captured user specified web content; and publishing the captured user specified web content based on the location described by the retrieved metadata on the personal web.

The details of various embodiments are set forth in the accompanying drawings and the description below. Other features and advantages will be apparent from the following description, the drawings, and the claims.

### DESCRIPTION OF THE DRAWINGS

FIG. 1 is an example of a computer system providing web content.

FIG. 2 is an example of a computer device for use in a computer system.

FIG. 3 is an example of a system diagram.

FIG. 4 is an example of a process for a capture tool.

FIG. 5A is illustration of an example of metadata used in of capture operation.

FIG. 5B is illustration of a capture operation.

FIG. 5C is an example of a method for a capture operation.

FIG. 5D is an example of a method of display of a capture area.

FIG. 6 is an example of a database structure.

FIG. 7 is an example of a flow chart with regard to a capture and a display process.

FIG. 8 is an example of a flow chart for capture logic and display logic.

FIGS. 9, 10, 11, 12, 13, 14, and 15 are examples of screen shots illustrating web content and use of a capture tool.

FIG. 16 illustrates an example of a screen shot of the display window of a maximized capture interface.

FIG. 17 illustrates an example of a screen shot of the capture interface open in the tab of a browser window.

FIG. 18 is an example of a flow chart for sharing captured content.

FIGS. 19A and 19B show examples of a message for sharing captured content.

FIG. 20 shows an example of sharing content via a social networking website or personal start page.

FIG. 21 shows an example of a method for associating content.

FIG. 22 shows an example of a capture display widget.

FIG. 23 shows an example of a capture display widget showing linking navigation lists.

FIG. 24 shows an example of an association user interface including a workbench main workspace.

FIG. 25 shows an example of the workbench open to a search interface.

FIG. 26 shows an example of a user start page or home page.

FIG. 27 shows an example of a user heat map search page that is provided as part of the analytics heat map reports.

FIG. 28 shows a screenshot of one example of a heat map for a web page.

FIG. 29 shows an example of a method for sharing advertisement revenue.

FIG. 30 shows an example of a process for targeting advertisements using captured content.

FIGS. 31, 32, 33, 34, 35, 36, 37, and 38 show examples of screenshots of a desktop environment for a foldable browser configured to manipulate captured web content.

### DETAILED DESCRIPTION

The following description provides universal content referencing, capturing, packaging, and distribution methods, systems, and computer tools that work in conjunction with web content interfaces provided by a computing device. The tools, methods, and systems support manipulation and distribution of a user selected area of web content from a web page. The computer tool also may be implemented as a browser, as a plug-in or extension to a browser, a button on a webpage, or embedded within web content. In particular, the tools, methods, and systems are configured to manipulate a user defined area of a webpage, capture the area, package the area, and distribute the package to others as desired. In addition, the system allows website creator to monitor how their websites and web pages are being accessed, used, and distributed.

For example, a user may select a user input on a website (e.g., a button) to cause a tool (e.g., a marquee select tool) to define an area of the webpage (e.g., a rectangular box), and package the defined area (e.g., using a URL or other hyperlink) and send the defined area (e.g., by email with the link embedded therein) to another user that when activated provides the selected area and its content in a new dynamically created pop-up window, an expandable pop-up window, or a browser window. Alternatively, the tool may be provided by a browser, a plug-in or extension to a browser, a button, or as a widget to define the area of the webpage. An initial, dynamically created pop-up window's size and content viewport is configured to coincide with the area of the webpage that was defined by a user using the computer tool. The user defined area can then be manipulated and shared with other users via a communications service, such as email or messaging, or published on the web for sharing with a user population at large, such as on a user home page or various social networking websites. Various implementations, embodiments, configurations, and variations are described in greater detail below.

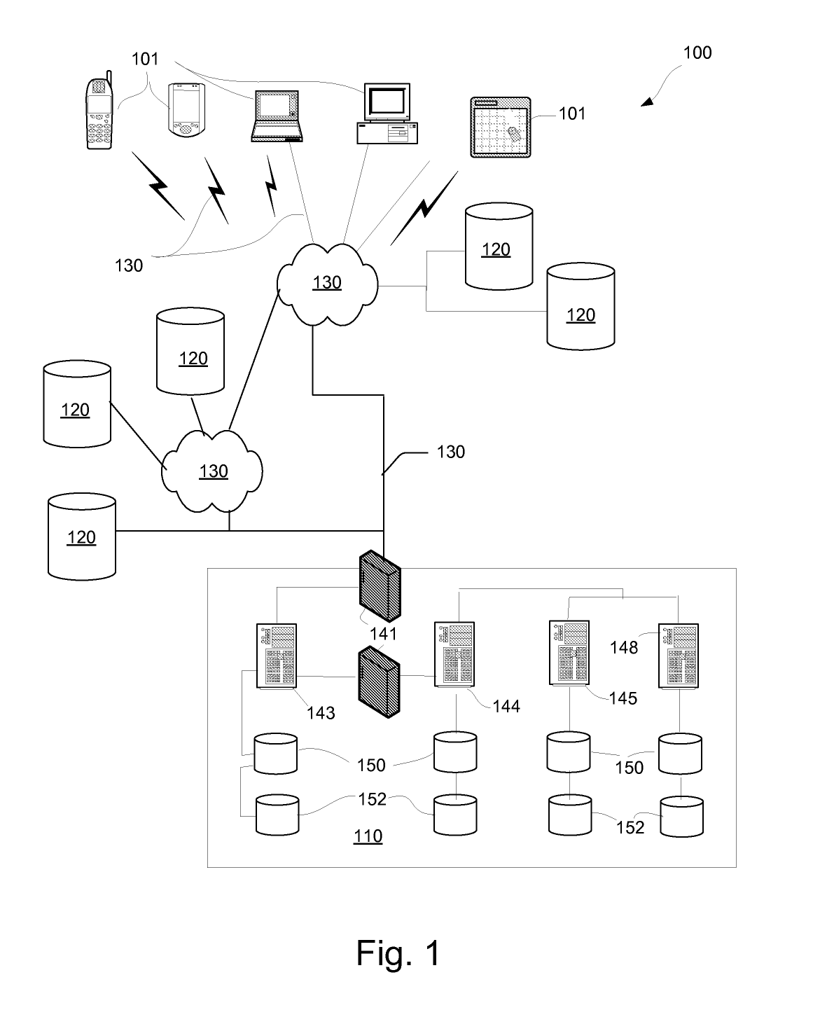

The computer tool is implemented by a computer device of a communications system. FIG. 1 shows one block diagram of an example of communications system 100. The communications system 100 includes one or more computer devices 101, one or more content provider systems 110, such as service provider systems, servers and server systems, Internet Service Providers, and websites, and various communication paths 130. As the communications system 100 is device and source agnostic, the computer tool is designed to work with any web-accessible user device, as explained in further detail below.

A computer device or computer system 101, referred to herein and throughout as a user device, may be any type of electronic device that presents, plays, or renders content, such as a web page accessed from the Internet or World Wide Web for a user. Typically, a computer device includes one or more processing devices as described below. For example, the user device may be a consumer electronics device, a mobile phone, a smart phone, a personal data assistant, a digital tablet/pad computer, a hand held/mobile computer, a personal computer, a notebook computer, a work station, a vehicle computer, a game system, a set-top-box, or any other device that can implement a user interface and/or browser to communicate with, access, and present content from the Internet or World Wide Web to a user.

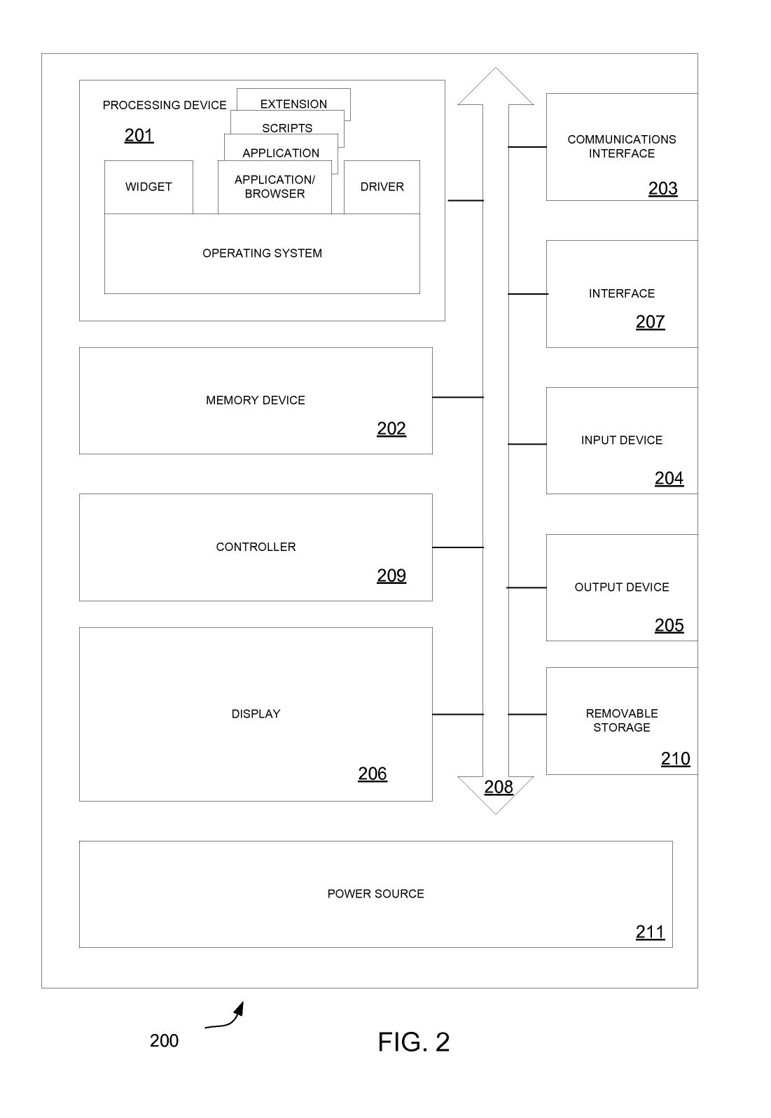

One example of a user device is shown in FIG. 2; however, it will be appreciated that this device is only exemplary and that any number of, types of, or configurations of different components and software may be incorporated into or omitted from the computer device. For example, the user device may include a number of components including one or more of the following: one or more processing devices 201, one or more storage devices 202, and one or more communications interfaces 203. A user device also may include additional elements, such as one or more input devices 204 (e.g., a display, a keyboard, a key pad, a mouse, a pointer device, a trackball, a joystick, a touch screen, microphone, etc.), one or more output devices 205 (e.g., speakers), a display 206, one or more interfaces 207, communications buses 208, controllers 209, removable storage devices 210, and at least one power source 211. Additional elements not shown may include components of a digital camera, an optical reader (e.g., a bar code scanner or an infrared scanner), an RFID reader, and antennas/transmitters and/or transceiver. A user device also may include one or more associated peripheral devices (not shown), such as, for example, a display, a memory, a printer, an input device, an output device, and speakers. As is appreciated by those skilled in the art, any of these components (other than at least one processing device) may be included or omitted to create different configurations or types of user devices, for example, to perform specific or specialized needs or tasks, generalized needs or multiuse tasks, or for various performance criteria, such as, mobility, speed, cost, efficiency, power consumption, ease of use, among others.

The processing device 201 may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS including applications that communicate with content provider systems and present content received from the content provider systems to the user. The processing device also may access, store, manipulate, process, and create data in response to execution of the applications. For purpose of simplicity, the description of a processing device is used as singular; however, one skilled in the art will appreciated that a processing device may include multiple processing elements or device and multiple types of processing elements or devices. For example, a processing device may include multiple processors or a processor and a controller. In addition, different processing configurations are possible, such as serial processers, parallel processors, a quad processor, a main processor and a display processor or caching processor, among others. As used herein, a processing device configured to implement a function A includes a processor programmed to run specific software. In addition, a processing device configured to implement a function A, a function B, and a function C may include configurations, such as, for example, a processor configured to implement both functions A, B, and C, a first processor configured to implement function A, and a second processor configured to implement functions B and C, a first processor to implement function A, a second processor configured to implement function B, and a third processor configured to implement function C, a first processor configured to implement function A, and a second processor configured to implement functions B and C, a first processor configured to implement functions A, B, C, and a second processor configured to implement functions A, B, and C, and so on.

The software applications may include a computer program, a piece of code, an instruction, or some combination thereof, for independently or collectively instructing or configuring the processing device to operate as desired. Examples of software applications include: an operating system, drivers to control and/or operate various components of the user device (e.g., display, communications interface, input/output devices, etc.). In addition a user interface application may be provided, such as a browser, a mini browser, a mobile device browser, a widget, or other programs that interact with the content provider systems to provide or present content and a user interface or conduit for presenting the content, among other features including browser based tools, plug-in, and extension applications, such as Java, Acrobat Reader, QuickTime, or Windows Media Player, and a Flash Player (e.g., Adobe or Macromedia Flash). The applications may be resident in the processing device, loaded from a storage device, or accessed from a remote location or a storage device, as described in greater detail below. Once the applications, such as a browser, are loaded in or executed by the processing device, the processing device becomes a specific machine or apparatus configured to perform a function, such as to provide a user interface to render, present, provide, and interact with content from a content provider system. That is to say a user device with a processing device programmed in a certain way is physically different machine than that of a user device without that program as its memory elements are differently arranged and/or configured.

The software, applications, content, and data may be embodied permanently or temporarily in any type of machine, component, physical or virtual equipment, computer storage medium or device, or in a propagated signal wave capable of providing instructions or data to or being interpreted by the processing device. In particular, the software, applications, content, or data may be stored by one or more computer storage devices 202, 210 including volatile and non-volatile memories that store digital data (e.g., a read only memory (ROM), a random access memory (RAM), a flash memory, a floppy disk, a hard disk, a compact disk, a tape, a DROM, a flip-flop, a register, a buffer, an SRAM, DRAM, PROM, EPROM, OPTROM, EEPROM, NOVRAM, or RAMBUS), such that if the storage device is read or accessed by the processing device, the specified steps, processes, and/or instructions are performed and/or data is accessed, processed, and/or stored. The computer storage device may include an I/O interface, such that data and applications may be loaded and stored in or accessed or read from the computer storage device allowing the applications, programming, and data to be used, updated, deleted, changed, augmented, or otherwise manipulated. The computer storage device may be removable, such as, for example, a disk drive, a card, a stick, or a disk that is inserted in or removed from the user device.

The communications interface 203 may be used to exchange data and content with the content provider system using various communications paths. The communications interface may be implemented as part of the processing device or separately to allow the processing device to communicate or send and receive data using the communications paths. The communications interface may include two or more types of interfaces, including interfaces for different types of hardware and/or software to interact with different types of communications media and protocols and to translate information/data into a format that may be used by the processing device. Similarly, the interface may translate information/data received from the processing device to a format that may be transmitted to the service provider system via a communications path.

The communications paths 130 may be configured to send and receive signals (e.g., electrical, acoustic, electromagnetic, or optical) that convey or carry data representing various types of analog and/or digital data including programming, software, media, and content, among others, for presentation to a user. For example, the communications paths may be implemented using various communications media and one or more networks comprising one or more network devices (e.g., network interface cards, fiber media converter, servers, routers, switches, hubs, bridges, repeaters, blades, processors, and storage devices). The one or more networks may include a local area network (LAN), a wide area network (WAN), an Ethernet, a global area network (GAN), a cloud network, a plain old telephone service (POTS) network, a digital subscriber line (DSL) network, an integrated services digital network (ISDN), a synchronous optical network (SONNET)/SDH, Passive and Active Optical Networks (PON or AON), a packet switched network, V.92 telephone network modems, IRDA, USB, Firewire, EIA RS-232, EIA-422, EIA-423, RS-449, RS-485, ITU, T1 and other T-carrier links, and E1 and other E-carrier links, varieties of 802.11, GSM Um radio interface, Bluetooth, IEEE 802.11x Wi-Fi, TransferJet, Etherloop, ARINC 818 Avionics Digital Video Bus, G.hn/G.9960, or a combination of two or more of these networks to name a few.

In addition, the communications paths may include one or more wireless links (e.g., microwave, radio, and satellite) that transmit and receive electromagnetic signals, such as, for example, radio frequency, infrared, and microwave signals, to convey information/data signal using any one of a number of communications protocols, for example, communications links may include IMT-2000, such as 2G (GSM, GPRS, EDGE, EDGE Evolution, CSD, HSCSD), 2.5G, 2.75G, 3G (W-CDMA, HSPDA, HSUPA, UMTS-TDD, FOMA), 4G, and IEEE 802.11 standards, such as Wi-Fi or WLAN. In one example, a communications path may include the Internet or World Wide Web or components found therein.

Data and content may be exchanged between the content provider system and the user device through the communication interface and communication paths using any one of a number of communications protocols. In particular, data may be exchanged using a protocol used for communicating data across a packet-switched internetwork using, for example, the Internet Protocol Suite, also referred to as TCP/IP. The data and content may be delivered using datagrams (or packets) from the source host to the destination host solely based on their addresses. For this purpose the Internet Protocol defines addressing methods and structures for datagram encapsulation. Of course other protocols also may be used. Examples of an Internet protocol include Internet Protocol Version 4 (IPv4) and Internet Protocol Version 6 (IPv6).

The computer tool may be used to access, render, and/or present content, such as web pages and their associated web content that are provided by content provider systems. The content provider system 120 facilitates access to, organization of, and presentation of content to users in addition to providing many services. Examples of services provided by content provider systems include storefronts, news, blogs, entrainment, social media and networks, content sharing, among many others. The content provider system may store and manage content, such as web pages and websites in a location that is centralized and/or remote from the perspective of the user. The central location may be one physical location, such as a room, building, or campus providing the hardware components of the system. However, in reality the central location may be virtual or distributed where services are provided, content are accessed from, and data is stored over a number of distributed systems and/or locations. In other words, although the content provider systems are shown in FIG. 1 as being a single entity, other configurations wherein the applications, processing, services, content, and data are distributed both in terms of devices and geographical location are within the meaning of the content provider system. Additionally, the content provider system may use third parties to host the web page or website and may initiate services as needed on demand, for example, using cloud computing wherein the locations and structure providing the services changes size, and physical location, distribution, and even equipment dynamically over time.

The content provider system may include one or more communications devices, processing devices, memories/storage devices, communications interfaces, network devices, and communications paths (as described in detail above for computer devices 101) to store, process, manipulate, organize, consolidate, maintain, and present communications, content, and data for a user. Descriptions of communications devices, processing devices, storage devices, software, communications interfaces, network devices, and communications paths are all described above and are incorporated herein by reference and are not repeated in the interest of brevity.

The computer tool works may be configured to work in conjunction with a service provider system 110. The service provider system provides a mechanism to capture web content by allowing a user to identify and persistently store descriptive data for a user specified portion of a webpage. The service provider system also provides a mechanism to share the captured content with other users. The service provider system also provides a mechanism to gather analytics for capture operations and information regarding the sharing of captured content and provides a management tool to allow registered users to view the analytical data gathered from the capture operations including a reporting mechanism to view and analyzed the gathered analytics. In addition, the service provider system allows advertising to be served to users and others they share content with based on the actual content that was captured. In addition, users that share content may become advertising affiliates of the service provider system and receive credit or share in click through revenue generated from sharing the web content with others.

In one example, the service provider system 110 may include a one or more security devices 141 (e.g., firewalls), web servers 143, an application server 144, an SQL server, MySQL server, or another database system 145 and a mirror servers 148, and associated memory 150 and backup memory devices 152. The web server 143 may provide initial communication with client devices and provide services, such as a web page and/or portal configured to provide access to the services provided by the service provider system. Application server 144 may be configured to provide capture services, display services, email services, as explained in greater detail below. Server 145 may provide proxy services and associated memories 150 and 152 may provide caching of web content. Server 148 may provide database management services and analytic services and associated memories 150 and 152 may store descriptive metadata and analytical information. It is understood, however, that the example given in FIG. 1 is for illustrative purposes only, and that many different configurations, combinations of devices, and numbers of devices may be provided for any particular content provider system 110. However, one or more processing devices, such as the servers, are provided to provide the services and functionality described herein for the service provider system. For example, cloud architecture also may be used to implement a service provider system 110, as described below. In addition, although only one of each server (e.g., 143, 144, 145, and 148) and associate memories 150 and 152 are shown, it will be appreciated that in actual implementation other configurations of servers or combining of servers may be provided or banks of a number of these machines as necessary may be provided to handle the number of users, data, and traffic that a particular implementation of a service provider system 110 handles.

Although, one configuration is shown in FIG. 1, others may be used. For example, other types of hardware may be used, such as various types of computers (e.g., a PC or a Macintosh) featuring any of various processors (e.g., an Intel Core, Pentium, Celeron, Server or Workstation processors) running any of several operating systems (e.g., Windows, Mac OS X, Unix, or Linux). In addition, languages such as hypertext markup language (HTML), eXtensible Markup Language (XML), ASP, Ajax, Cascading Style Sheet (CSS), and various other protocols may be used.

In addition, service provider system may be configured to provide a location that is centralized and/or remote from the perspective of the user. The central location may be one physical location, such as a room, building, or campus providing the hardware components of the system. However, in reality the central location may be virtual or distributed where services are provided, content are accessed from, and data is stored over a number of distributed systems and/or geographic locations. In other words, although the content provider systems are shown in FIG. 1 as being a single entity, other configurations wherein the applications, processing, services, content, and data are distributed both in terms of devices and geographical location are within the meaning of the service provider system. Additionally, the service provider system may use third parties to host the web page or website and may initiate services as needed on demand, for example, using cloud computing wherein the locations and structure providing the services change size, and physical location, distribution, and even equipment dynamically over time.

In another example, the service provider system may be hosted utilizing an accelerated cloud infrastructure. A cloud processing network includes a virtualizer network of accelerators for virtual servers. The virtualizer utilizes a Storage Domain Servers (SDS), network switchers, and a Storage Area Network (SAN) to provide a variety of server capacity and functionality that is emulated and provided as a load-balanced resource. The network is connected to various servers and their corresponding data storage and databases of one or more content providers allowing easy access to many different servers having multiple operating systems (e.g., UNIX, Linux, Windows, Mac OS, and Backup). As a result, a variety of server operating systems and capacity may be provided to the end user of the user devices. The cloud processing network may be part of the service provider system 110 or hosted by a third party.

The accelerators provide virtualized servers (8+ cores, 32+GB RAM) with vast amounts of NAS storage. The accelerators are deployed within the cloud of a fast networking and routing fabric (e.g., Force 10), and efficient hardware load balancers (e.g., F5 Networks). Various applications, such as Apache, Nginx, MySQL, PHP, Ruby on Rails, and JAVA are preinstalled.

The Accelerators use full root access to provide control of setup and security configurations. The configuration provides accelerators that deliver massive scalability, both vertical and horizontal. For example, on the vertical scale the accelerators come in sizes ranging from ¼ GB of Ram up to 32 GB of RAM. On the horizontal scale, application-layer accelerators may be added that use hardware load balancing to support potentially hundreds of nodes.

The computer tool may be implemented in conjunction with a service provider system 110 using a feature or tool, such as a button or embedded program on a web page or website, or as a browser, a plug-in or extension to a browser, or as a widget (e.g., operating on a portable device, a mobile device, or a smart phone). In particular, the computer tool may provide functionality, such as allowing a user to perform one or more of the following: define an area or portion of a web page, manipulate the defined area and/or web content associated with the area of the webpage, and share the defined area and/or content associated with the area, in particular web content, such as content provided by a content provider system 120 on a web page or website.

A web page provides content or resources that are suitable for the World Wide Web or the Internet. Typically, a web page is accessed through a user interface, such as a graphical user interface. One example of a graphical user interface is a web browser running on a user device which renders the web content for presentation to a user. Examples of a web browser that provides a graphical user interface include Internet Explorer, Mozilla Firefox and Opera, or the web browser may be text-based, like Lynx. The web content that makes up a webpage is typically provided in some type of markup language, such as an HTML or a XHTML format and may provide navigation to other web pages via hypertext links. The web content includes a collection of markup tags. A document made up of the markup tags forms a webpage.

A web page may be retrieved from a local computing device or from a remote computing device, such as a web server. The web server or host may restrict access or publish the web page on a network, including the World Wide Web. A web page is requested by a client computing device and served from a web server using Hypertext Transfer Protocol (HTTP), for example, by a content provider system 110.

Web pages may consist of files of static text stored within a file system of a web server (e.g., a static web page), or the web page may be constructed by server-side software when the page is requested by a browser (e.g., a dynamic web page). Web browsers may provide additional tools, plug-in, or extensions, such as scripting languages to make web pages more responsive to user input once the web page is rendered or presented by the browser of client computing device.

Web pages typically include information, such a markup tags, that tell the browser how to render the web content for presentation to the user. For example, the information may include colors and fonts of text and backgrounds. In addition, the information also may contain links to images and other media that are to be rendered in the final presentation to a user by way of a rendering and/or layout engine running on a computing device of the user device. Typically, the information may include layout, typographic, and color-scheme information that is provided by CSS instructions. The information is provided as HTML forming the web page or may be provided by a separate file that is referenced to form the HTML of the web page.

Images typically are stored on the web server as separate files; however, HTTP also makes provisions to provide related files, such as images and style sheets requested by the browser as it processes the web page for rendering. For example, an HTTP 1.1 host web server maintains a connection with the client browser until all resources related to the web page have been requested and provided to the client browser. Web browsers usually render images along with the text and other material of the webpage that is presented to the user.

Client-side computer code or software, such as JavaScript or code implementing Ajax may be embedded in the HTML of a webpage or, like CSS style sheets, the code may be provided as separate linked downloads specified in the HTML. Scripts run on the client computing device, if the user allows them to, and can provide additional functionality for the user after the page has downloaded.

A web page includes content as an information set. The information set may include numerous types of information that is presented to a user. For example, the web page may include information that is able to be seen, heard, or otherwise interacted with by the end user. Information may include: textual information with diverse render variations and non-textual information. Non-textual information may include: static images on raster graphics (typically GIF, JPEG or PNG) or vector formats as SVG or Flash; animated images (typically Animated GIF and SVG but also may be Flash), Shockwave, or Java applet; audio, (typically MIDI or WAV formats or Java applets); and video (WMV (Windows), RM (Real Media), FLV (Flash Video), MPG, MOV (QuickTime)). The web page may include interactive information that is more complex that is glued to interface as provided by dynamic web pages.

Web page may provide for “on page” interaction, such as interactive text (e.g., DHTML); interactive illustrations (e.g., “click to play” image to games, typically using script orchestration, Flash, Java applets, SVG, or Shockwave); buttons (e.g., forms providing alternative interface, typically for use with script orchestration and DHTML) “between pages” interaction (e.g., hyperlinks: standard “change page” reactivity); forms providing more interaction with the server and server-side databases.

The web page also may include internal or hidden information, such as comments; metadata with semantic meta-information, charset information, Document Type Definition (DTD), diagramation and style information (e.g., information about rendered items, such as image size attributes, and visual specifications, such as CSS.

The webpage also may include dynamically adapted information elements that depend on the rendering browser or end-user location (e.g., through the use of IP address tracking and/or “cookie” information). Some information elements, such as a navigation bar may be uniform for all website pages. This information is supplied by technologies like web template systems.

A website typically includes a group or collection of web pages that are linked together, or have some other coherent method of navigation between the web pages. In one example, a website may be a number of web pages that are stored in a common directory of a web server. The website includes an index page, and depending on the web server settings, the index page may have many different names. In one example, the index page is index.html. When a browser visits a homepage for the website, or any URL pointing to a directory rather than a specific file, the web server serves the index page to the requesting browser. If no index page is defined in the configuration, or no such file exists on the server, either an error or directory listing is served to the browser.

Typically, a user establishes a connection or link between the content provider system and a user device to interact with a content provider system and access content provided by the content provider system, such as a web page. The user accesses the content using the user device running an application allowing the user device to communicate with the content provider system. In one example, the application may be implemented as a browser running on the processing device. The browser may include any application that communicates with a web server primarily using hypertext transfer protocols (HTTP) (e.g., HTTP/1.1) along with various extensions, plug-ins, and tools to fetch, present, manipulate, and interact with content and/or provide access to services provided by the content provider system. HTTP allows the browser to submit information to servers in addition to fetching content from them. Content may be located by the browser using a URL as an address. Many browsers also support a variety of other URL types and their corresponding protocols, such as Gopher (a hierarchical hyperlinking protocol), file transfer protocol (FTP), real-time streaming protocol (RTSP), and an SSL encrypted version of HTTP (HTTPS). Content may be provided in HTML that is identified using a MIME content type. The browser may support a variety of formats in addition to HTML, such as the JPEG, PNG, and GIF image formats, and can be extended to support additional formats through the use of extensions, plug-in and/or scripts. The combination of HTTP content type and URL protocol specification allows images, animations, video, sound, and streaming media to be embedded in the content. Examples of various plug-ins and tools include Java, Acrobat Reader, QuickTime, or Windows Media Player, and a Flash Player (e.g., Adobe or Macromedia Flash).

The user interface or browser provides electronic content generated by the applications, servers, and databases of the content provider and service provider systems. Once the user device establishes a link with the system, the user device and content provider system exchange data. Data may be transmitted from the content provider or service provider system to the browser in a markup language used by a client application, browser resident, or computer tool running on the user device and its operating system to render the page for presentation by a display device. Data also is transmitted from the user device to the system to provide indications of user interaction with the user interface (e.g., accessing a hyperlink to another web page or providing a credit card number for payment). The data sent to the user device may be in any markup language that may be interpreted by the client application, browser, or tool running on the user device, such as HTML, the JavaScript programming language, CSS and/or XML.

In one example, data may be transferred between the content provider and the user device using an HTML and/or XML format to render the webpage (i.e., present the webpage) from markup tags provided by the web content provider system. The user interface or browser may include one or more areas, portions, boxes, windows, scroll/slider bars, tools, menus, buttons, and tabs and combinations of these to present the webpage and allow the user interact with and manipulate the webpage. The functionality of the user interface may be accessed or activated through use of one or more user inputs of the user device. For example, items and content on the screen may be selected and manipulated using one or more screen position indicators or visual effects (e.g., a pointer, a cursor, a highlighting, a transparency, a color, an animation, or an effect) controlled by one or more user input devices (e.g., a key, a keyboard/pad, a touch screen/pad, a mouse, a joystick, a track ball, and a stylus) as is common in graphical user interfaces (e.g., a pointer controlled by a mouse to click and double-click to activate, select, and drag items within a window, browser, or desktop environment).

In most cases, items may be selected, clicked, or tapped to designate, activate, or provide some functionality associated with the items. The following description makes reference to mouse clicking, such as right mouse clicking or left mouse clicking. For consistency this terminology is used throughout the following examples; however, one skilled in the art will appreciate that this is only one example of implementing a user selection and input within a browser, an interface, or a computer tool. For example, one or more keys may be selected to control or manipulate a selection from a keypad or keyboard; or a joy stick or trackball may be used instead of mouse to input a user selection. In addition, other methods may be used with different interfaces, such as tapping with one or more fingers or stylus on a touch screen. In addition, different combinations of inputs may be arranged as desired (e.g., single selection or double selection) to instruct the computer to active different functionalities or act in a desired manner.

Many modern webpages often require more screen space for all the content that is associated with the web page than is available for a particular display resolution associate with any particular user device. Most conventional browsers provide an interface to control or manipulate the information that is presented for a particular display resolution. For example, some conventional browsers place scrollbars (e.g., a bar at the side and/or bottom of the screen) that allow the user to position the window to see and access all the content associated with the web page. However, conventional browsers are limited in the presentation of content. For example, a conventional browser generally provides a rectangular window which displays a portion of the web page to a user. A user interface may be used to manipulate or move the window relative to the content of the rendered web page. While a user may generally maximize or adjust the size of the window that presents the content within the confines of a particular display resolution associated with the user device, the window may still not display all of the content associated with the web page. In addition, modern web pages provide such a large amount of content and variety of content, that the user may only be interested in a particular portion of the web page that has the desired content. While conventional browsers allow users to bookmark a page to easily return to a desired page at a future time, every time the user accesses the web page, the user must still navigate the window back to the desired position within the webpage to present the desired content. In addition, when trying to share content with another user, the user may cut and paste a URL to the web page containing the content the user wishes to share and place the URL into an email. However, this does not immediately indicate to the recipient the specific content the user intends to share. Other services provide means of bookmarking and sharing content that is bookmarked; however, not all content on a web page may be bookmarked.

The novel capture tools, systems, and processes described herein permit a user to specify, select and/or define portions or areas of web content from a web page for capture and manipulation. In particular, the capture tool is configured to define a selected area of a webpage for capture by a user. The captured content may be displayed on the desktop, user interface, and other types of screens and/or displays. Once the content is captured, the captured content may be organized, manipulated and shared. In addition, the capture tools, systems, and processes provide a mechanism to identify and persistently store data (e.g., metadata associated with the capture operations) that is descriptive of the capture area selected by a user. For example, a database stores descriptive data for the user-defined capture area that allows the capture area of the webpage to be recreated or rendered by a browser or user interface. In addition, when the capture area is rendered or presented by an interface, such as a browser, the functionality associated with the web content provided by the interface also is provided. In addition, the user defined capture area is able to render or present partial objects or elements that fall within the capture area allowing a user to capture with precision the intended or desired area of the webpage. In addition, servers may cache source web pages, where possible and permitted, to allow for efficient retrieval of the captured content. The capture tools, systems, and processes also provide a mechanism to share the captured content with other users which is accomplished by retrieving the data describing captured content and creating a message allowing the recipient to access or interact with the captured web content as it was captured by the original user who selected the content for capture. The capture tools, systems, and processes also provide a mechanism to translate the shared message, retrieve the descriptive data for the captured area and open an interface, such as a browser showing a targeted view of the captured area.

The capture tools, systems, and processes also provide a mechanism to gather analytics, such as descriptive data for selection operations and information regarding the sharing of selected content. In addition, a user management tool provides a mechanism to allow registered users, such a webmaster to view the analytical data gathered from the capture operations including a reporting mechanism to view and analyzed the gathered analytics. The gathered analytical information and/or metadata may be used to target advertisements to those who capture and/or or view the capture areas. In addition, users who share capture areas may become affiliates of the service provider and earn credit or shares of click-through revenue associated with sharing captured content.

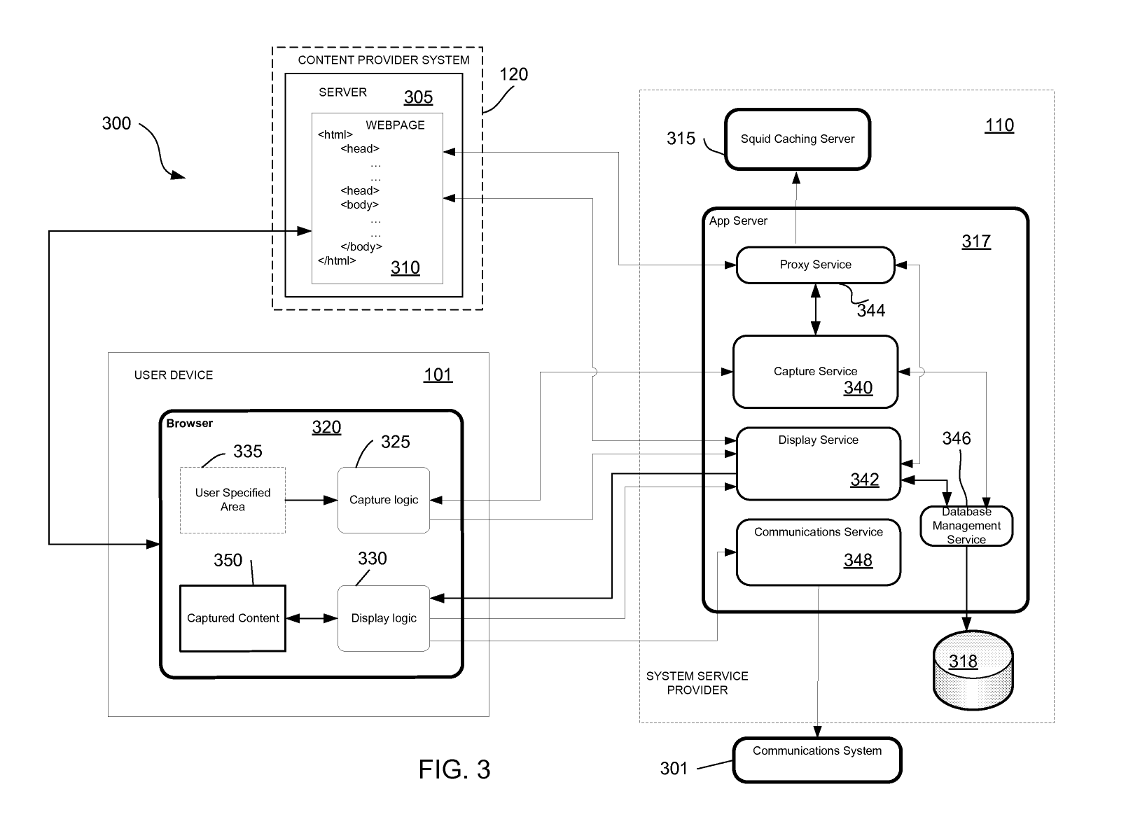

FIG. 3 further illustrates one example of a system diagram 300 for an implementation of a capture tool, system, and related processes. As shown in FIG. 3, the system includes a content provider system 120, a system service provider 110, a user device 101, and a communications system 301. It should be noted that FIG. 3 is provided to illustrate various elements of the systems and their interrelationships and flow of data and signals; however, any number of user devices, processing devices; content providers, as explained above, for example, with regard to FIGS. 1 and 2, may be used and the configuration, number, and types of elements in FIG. 3 should not be considered limiting.

The content provider system 120 includes one or more processing devices, such as a server 305 associated with a storage device configured to provide web content, such as a web page 310.

A service provider system 110 includes one or more processing devices and one or more storage devices. For example, the service provider system may include a first processing device 315, such as a caching server, a second processing device 317, such as an application server, and a storage device 318, such as a database.

The user device 101 includes one or more processing devices (and associated storage device) configured to provide a user interface 320, such as a browser that accesses the webpage provided by the content provider system.

The communication system may be any type of communications system capable of transmitting digital or analog messages to a user device. In this example, the communications system may be an electronic mail server.

The capture tool may be implemented as one or more of a browser capture function, a browser extension or plug-in function, or an embedded webpage capture function, such as a button, that operates in conjunction with the service provider system. In the example shown in FIG. 3, a browser accesses a webpage for presentation to a user via the interface of the user device. The user may manipulate the webpage in a manner typical of using the web browser. The capture tool implements capture logic 325 and display logic 330 within the user interface, such as a browser. The logic is software executed by at least one processing device of the user device to perform the functions described herein. The capture logic is configured to allow a user to specify, indicate, and/or select an area 335 of a webpage rendered by the browser and capture the web content associated with the specified area. The captured web content has the functionality associated with the captured web content and can include partial objects or elements of the captured web page. The display logic is configured to allow a user to access the captured web content associated with the captured area, manipulate the captured web content, and share the captured web content with other users. The capture logic and display logic may be implemented, for example, using JavaScript to provide a client capture and a client display process. In an implementation using the browser or extension/plug-in the JavaScript is specific to the type of browser (e.g., a Chrome API for the Google Chrome Browser) and is injected into the rendered webpage by the browser or extension/plug-in. In an implementation having an embedded webpage capture function, the JavaScript is browser agnostic and is embedded into the webpage by the webmaster of the content provider system. In the embedded implementation, the capture function is configured to provide capture only of the web content of the webpage or website that the embedded capture function resides on; whereas the browser or extension/plug-in may be used with any webpage that is capable of being rendered by the browser. Both of these implementations are described in further detail below.

The application server 317 provides a capture service 340, a display service 342, a proxy service 344, a databases management service 346, and a communications service 348 that works in conjunction with the client side capture and display logic of the user device. The capture service is configured to receive requests to capture portions of a webpage and process the requests to persistently store data associated with captured areas in a relational database. In addition, a database management service controls creation, maintenance, and access to capture data. In one example, the relational database may be implemented using an SQL server and related storage device. The server capture service also is configured to work with a proxy service. The proxy service directs caching of webpages by a caching server when caching of a webpage is allowed by the content provider system. In this case, a caching server, such as a Squid caching server or Varnish caching server, accesses the webpage from the content provider system and caches a copy of the webpage provided by the content provider system. Alternatively, the webpage may be cached on a storage device associated with the client device; however, the cached page is then only accessible by the specific client device with access to the cached storage associated with the client device. When a call for captured content is made by a user device, the proxy service is used to determine if the content is cached and to serve the cached content.

The server display service is configured to receive requests to present the captured web content by the client display logic of a user device. The request to present the captured web content may be made by the client capture logic as part of the capture process or from the client display logic as part of a display function, such as accessing a bookmark, activating a desktop widget, accessing a shortcut/icon/favicon linked to a specific identification or URL associated with the captured web content, or accessing content shared via an electronic communication. The display service is configured to process the request by determining an identification (ID) associated with the request, retrieving associated data from the relational database and a source page from the web page or proxy service, and create data configured to present the captured web content 350 associated with the ID by the client display logic.

The communications service is configured to receive and process requests to share the captured web content with other users. The communications service is configured to extract an ID from the request, determine associated data from the database, generate a message and send the message to the specified user. In one example, the user is specified with an email address, and the service provides a URL associated with the captured data in an email that is sent to a communications service, such as an email server which forwards the email to the specified address. In addition, if an HTML enabled email service is provided, then the interface window for presenting the captured web content may be inserted into the body of the email.

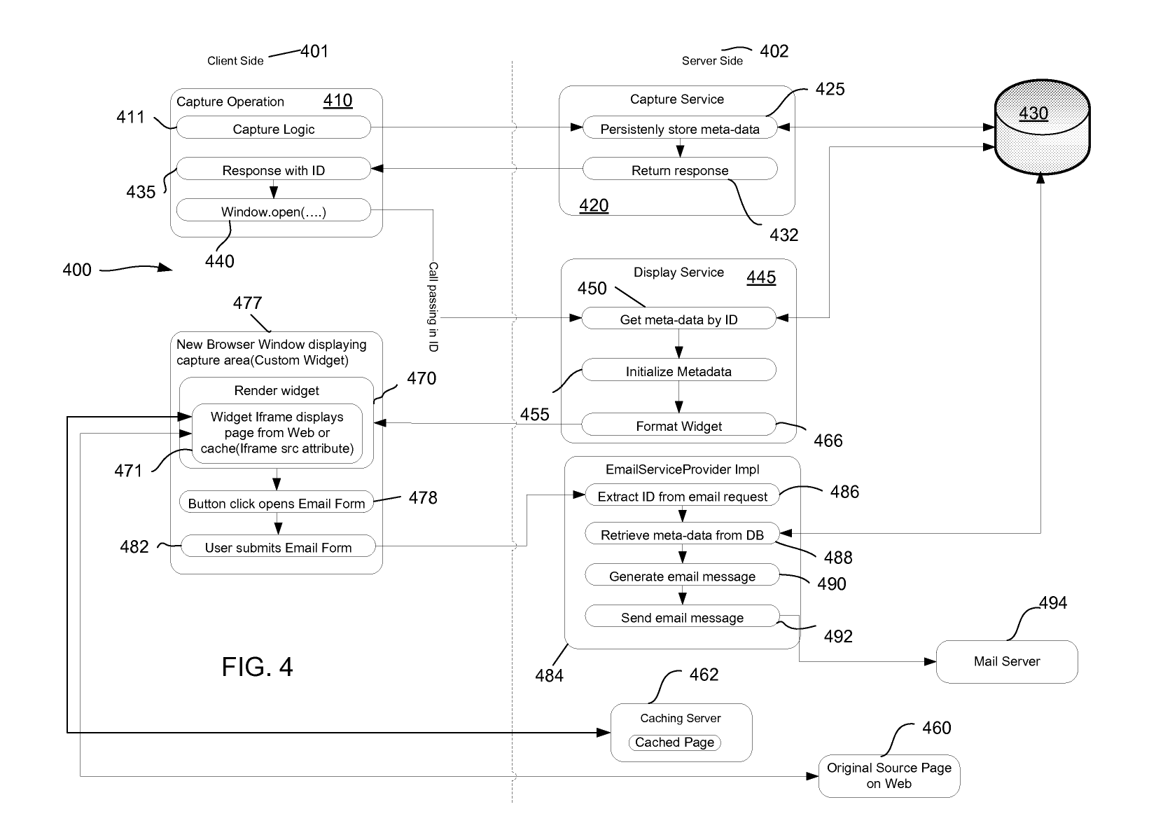

FIG. 4 shows one example 400 of a high level flow chart. As shown in FIG. 4, operations and services are illustrated with respect to client side operations (e.g., the capture operation and display operation) 401 executed by the client user device and the server side services (e.g., the capture service, display service, and communications service) 402 executed by the service provider system or content provider system. The user may begin a capture operation 410 using a capture tool accessed by the user interface associated with the browser or through capture logic embedded in a webpage that is accessed by the browser (although if embedded in the webpage, the capture logic may only be used to capture content on that webpage or from that content provider system) 411. The capture tool may be accessed using a user input device. The user input device activates the capture logic to begin the capture operation. The user then selects whether to capture live or cached content.

The caching proxy service is configured to programmatically cache source pages on the caching server. When a user selects the option of capturing cached content, a GET request for the URL currently rendered by the client browser is initiated and the webpage associated with the URL is stored in the caching server. The cached content is then served back to the user, allowing the user to capture content from the cached page. As a result, the user is able to capture web content as it appeared on a webpage as of a fixed point in time. This is especially useful in capturing content from dynamic webpages that change over time and allows the capture tool to perform archiving among its many other uses.

In essence, the capture operation becomes a two-step process when capturing cached content. The first step involves actually caching the page and serving that as the source page, while the second step is the actual capture operation. The capture operation is functionally identical to a capturing live content, the only difference being that the source page for the capture is being served from the service provider system via the caching proxy.

The functional components of the Caching Proxy service are server side. The service consists of the ProxyServlet class, the ProxyAdapter class, and an implementation of the ProxyFacade interface. The ProxyServlet class is responsible for: receiving the request to cache the current page URL; preparing the domain URL data for transport to the relational database where the domain and URL persist; retrieving a proxy configuration from the application context; delegating a call to cache the page to the proxy server to the ProxyAdapter class; writing out the resulting cached content to the browser. The ProxyAdapter class is responsible for: creating and pre-pending a generic HTML base tag to the cached page; delegating call to cache page to the proxy server to the ProxyFacade implementation. The ProxyFacade implementation is responsible for: using the current page URL to create java.net.URL instance; opening a connection to the caching server using a java.net.Proxy instance and requesting the page using the URL instance which returns the cached content if the page is currently cached, or issues a GET request to the original URL to cache the page; and reading the cached content into a string and returning the string.

Once the user selects the content to be captured, the capture tool provides an indication within the webpage as presented by the user device. The indication may be manipulated within the presented webpage, for example, using a user input device. The indication identifies an area of the webpage as presented by the user device that the user desires to capture (i.e., the capture area). The indication may take one of many forms. For example, the indication may be a visual indication to identify an area of the webpage as presented by the user device. The visual indication may include one or more of highlighting the area, visually altering the area, visually contrasting the capture area with the rest of the presented page, such as with shading, shadowing, transparency over the remainder of the page or the visual indication may be a border that surrounds the capture area, such as a line or marching ants. The capture area also may be a geometric or non-geometric shape. The user may draw the capture area using a user input device or the user interface may provide a predetermined shape for capture of the area, which may then be manipulated to alter both its size and position with relation to the presented web content and thereby specify the capture area. For example, a predetermined window may be sized appropriately according to a corresponding user device type, such a smart phone, tablet, or Ultra Mobile PC to aid user's selection and capture. Such a feature is especially useful in environments with small displays or limited user inputs (e.g., touch screen or small key pad associated with mobile and smart phones).

In addition, the user may adjust the webpage relative to the indication using, for example, a grab or pan feature in which a pointer controlled by a user input device selects a point on the web page and moves the web page in conjunction with the selected point and relative to the fixed position of the predetermined area indication thereby in changing the content presented within the predetermined area to select or specify a desired capture area. In one example, selecting the capture area includes using a user input device to identify a contiguous boundary of pixels. In this case, the web content to be captured corresponds to web content associated with pixels rendered within the contiguous boundary. The capture tool also may indicate whether the content to be captured is live content or cached content. Once the desired area of the web content is indicated by the user, the client side capture logic gathers and prepares data that is descriptive of the desired capture area for submission to the server-side capture service.

In one example, using the Google Chrome browser, a chrome extension module utilizes the Google Chrome application program interface (API) to create an interface that allows the user to select a rectangular area of a web page, collect descriptive data about the selected area, and transmit this metadata to a server side capture process. For this extension, a browser action initiates the capture operation. For example, a browser action typically utilizes a popup interface accessed via an icon on the chrome browser toolbar. The popup user interface provides options to the user, such as (e.g., select live content, select cached content, options (such as using a tab or popup widget to present captured content) or to cancel the capture operation.

In this example, while the popup UI is the “window” for the extension, the actual functionality of the extension resides in a structure called a background page. The background page is an html page that is not rendered; rather it provides a mechanism by which the extension can temporarily inject functionality into a page being rendered by the browser. The background page also is the route by which the extension injects custom JavaScript into the currently rendered page. The embedded button functionality is essentially the same as the functionality of the Chrome extension; however, the JavaScript code that implements the capture UI is not dynamically injected into the target page; but, rather a standard reference to the script is added (e.g., via a <script> tag) to the web page by the content provider system. Access to the script, as well as HTML snippets containing a custom button to initiate a capture operation also are provided by the content provider system.

As mentioned above, the functionality is essentially the same for the button as for the extension. According to button configuration, the button uses standard JavaScript by which the capture request is submitted while the extension uses Chrome Extension API calls to perform an Ajax post of the capture request. In addition, specific JavaScript code is added to handle cross-browser differences, since the button code is accessible by all browsers (i.e., the button is browser agnostic).

The capture logic may be implemented using a scripting language, such as JavaScript that is included in the webpage provided by the content provider (e.g., an embedded button) or that is injected into the webpage by the client device. However, any computer language, code, or instructions that allow the processing device to determine or create the appropriate metadata for describing the capture area of a document or a webpage rendered by a browser may be used. In one example, the capture service loads a data structure that represents the current rendered page and loads fields for the data stream with items of descriptive metadata describing the location of the web content within the rendered webpage for capture. The capture tool provides a mechanism to submit the capture request with metadata of a capture operation that describes the source page and web content of the captured area within the source page to the capture service. The capture logic is configured to visually identify the desired area of the webpage for capture. In one example, the capture logic provides a capture interface that creates and formats overlaying <div> elements that allow the user to visually identify, indicate, and/or isolate the area of the webpage for capture.

For example, to create a capture user interface, the capture logic performs the following steps. First, a floating layer (e.g., a <div> element with a higher HTML z-index style attribute value than the base page) is created that has the same dimensions as the visible area of a browser viewport of a user device presenting the webpage. The floating layer essentially masks the viewport of the browser and creates a work area of the user interface to provide a mechanism that allows the capture logic to identify the area specified by user input for capture. Additionally, several other floating elements (e.g., <div> elements) are used to identify the capture area and optionally create a semi-transparent mask over the remainder of the view area of the webpage to identify, indicate, and/or isolate the desired capture area. The capture logic provides the following functionality to perform the capture operation: a process to submit or cancel the capture operation; several processes to move or adjust the size of the capture area and scroll the capture area (i.e., the floating layer scrolls with the base page); and a process to gather and format the capture metadata for submission to the service provider system.

The client capture logic submits the captured metadata describing the capture area to the application server of the service provider system 411. The capture metadata is received by the server capture service 420. The capture service is configured to process the request to persistently store the capture metadata 425 in a relational database 430. The metadata is assigned a unique ID. In addition, the capture logic determines if the captured content is live or cached. If the content is cached, the caching proxy logic causes the caching server to retrieve the source webpage for storage by the caching server. The capture service returns a response with ID to the capture logic of the browser of the client user device 432. The client side capture logic is configured to receive the response with ID 435 and to open a window (e.g., a pop-up, a viewport, a restricted window, a widget) of the browser and calls the display service passing the ID associated with the metadata stored in the relational database to the application server to request the data to present the captured content 440.

In one example, the server-side component of the capture service uses a subclass of Java Servlet to process an incoming capture request and prepare metadata to be sent to the relational database of the application. The capture service includes: determining the type of capture being requested; preparing capture data transfer objects used by the relational database; performing appropriate delegate calls to relational database; receiving and forwarding the capture operation identifier to the caller; and performing a GET request via a Proxy Service to cache the source page if source page allows for caching of content.

The display service 445 retrieves the metadata associated with the ID 450 from the database 430. The display service also initializes the metadata storing the metadata in a data structure 455. The display service formats the metadata to translate the metadata into data configured to present the captured web content in an interface window of the client deice, such as, markup tags or well formed HTML configured to present the portion of the webpage described by the metadata 466.

The display logic also may be activated from a widget interface, or a bookmark that calls the server display logic with the request for captured data by providing the ID associated with the captured content.

In one example, the server side display process uses two subclasses of JavaxServlet, specifically DisplayServlet class and the BounceServlet class, to accept incoming requests to display captured data. The DisplayServlet is a common service call used whenever a capture display request is made to the service provider system and is used in several contexts, including display after initial capture and separate requests to view captured data after the fact. The BounceServlet class is used to prepare an intermediate step prior to calling the DisplayServlet as described above for the bounce.jsp.

The CaptureDisplayServlet class is configured to: receive a client request containing the capture operation identifier; perform a delegate call to retrieve capture metadata; process/modify the capture metadata for redisplay of content including calculating values used for styling and offset for the client side capture process; populate an instance of the DisplayBean with appropriate values and add to request scope; forward the request to the display.jsp for display.

The BounceServlet class is configured to: receive client request containing the capture operation identifier, determine the width and height of a new display window; pad the width and height values to accommodate browser differences; populate an instance of the DisplayBean with appropriate values and add to request scope; and forward the request to the bounce.jsp.

The client user device renders an interface window 470 by presenting a new browser window displaying the captured area via a custom widget 477. The retrieved capture metadata is used to determine the captured area relative to the source page (either live or cached) and to display the captured web content corresponding to the area within a window or viewport of the user interface (e.g. widget or a tab in a browser window). The browser uses a source URL provided from the display service to retrieve a source page from the cache or web. If the captured content is live, the display service retrieves the source page associated with the source URL provided with the data or markup tags received from the content provider system 460. If the captured content is cached, the display service retrieves the cached source page associated with the source URL provided with the data or markup tags received from the caching server 462.

In one example, to display the captured area, the position of anchor coordinates (e.g., a pixel of the top-left corner of the capture area) relative to the start of the webpage (e.g., the top left corner of the source page) is determined. The position is used to dynamically style an iframe to place the desired content associated with the capture area into the viewport defined by the wrapper div element of the custom widget. In addition, the window or viewport may be sized to have the same or substantially the same dimensions as the dimensions of the capture area which also is determined from the metadata. The HTML required to accomplish this is created by server-side components, for example, Java Standard Tag Library (JSTL) custom tags and Java Server Pages (JSP). Components such as these tags, when used in the context of an HTML template such as a JSP, provide a mechanism to access values contained in data structures. This data is then used to dynamically set HTML element attribute values or content in the template, which is then translated into well-formed HTML by a templating engine (a Servlet container in the case of JSPs) that is provided to and then rendered by the browser.

The display service for the application uses a JSP, display.jsp that is responsible for managing the display of captured content. The display.jsp uses a request-scoped Java Bean populated with capture metadata by the display service. The Bean data is then accessed by JSTL tags in the display.jsp and used to populate attributes of the HTML in the page, dynamically styling the page to display the captured content. When this step is complete, the JSP is translated into HTML by the Servlet container and sent to browser.

The dynamic styling mechanism for the page that isolates the captured content uses a set of nested <div> elements wrapping a styled <iframe>. The metadata from the capture operation is used to display the captured content. The following elements are listed from the innermost elements to the outermost elements. The <iframe> source attribute is set to the URL for the original or cached source page. The <iframe> width and height style settings are dynamically set to the respective width and height of the original document, padded by an amount to ensure the <iframe> does not display scroll bars. The <iframe> is wrapped in a <div> element (e.g., a “wrapper” div) that is dynamically styled to “shift” the top and left coordinates to isolate the area of the page that was captured. The amount of the shift is called the offset for each axis. The X axis offset is relative to the horizontal coordinate and left-hand scroll position of the browser at the time of the original capture operation. The Y axis offset is relative to the vertical coordinate and top scroll position at the time of the original capture operation. These offsets are negative values and are used to shift the window or viewport to a position that starts at the top left of the original, selected capture area. The formula used to calculate the offset for an axis is: Offset=0−(coordinate+scroll position). For example, if the original capture top-left coordinates is 100 pixels from the top of the browser viewport and 100 pixels to the right of the left side of the browser viewport, and the scroll position is top=100 pixels, left=0 pixels, then the X axis offset is −100 pixels (0−(100+0=−100) and the Y axis offset is −200 pixels (0−(100+100)=−200).

The wrapper <div> element is dynamically styled to the dimensions (e.g., the width and height) of the original, selected capture area to hide any overflow and restrict the viewport to present only the capture area. In the example given above, the wrapper div would be styled to be 100 pixels wide by 100 pixels high. The wrapper <div> itself may be wrapped in another <div> element (a “container” div) which also uses the capture height and width to provide padding and alignment. The container <div> may be wrapped in another <div> element that contains both the container and a <div> containing application buttons.

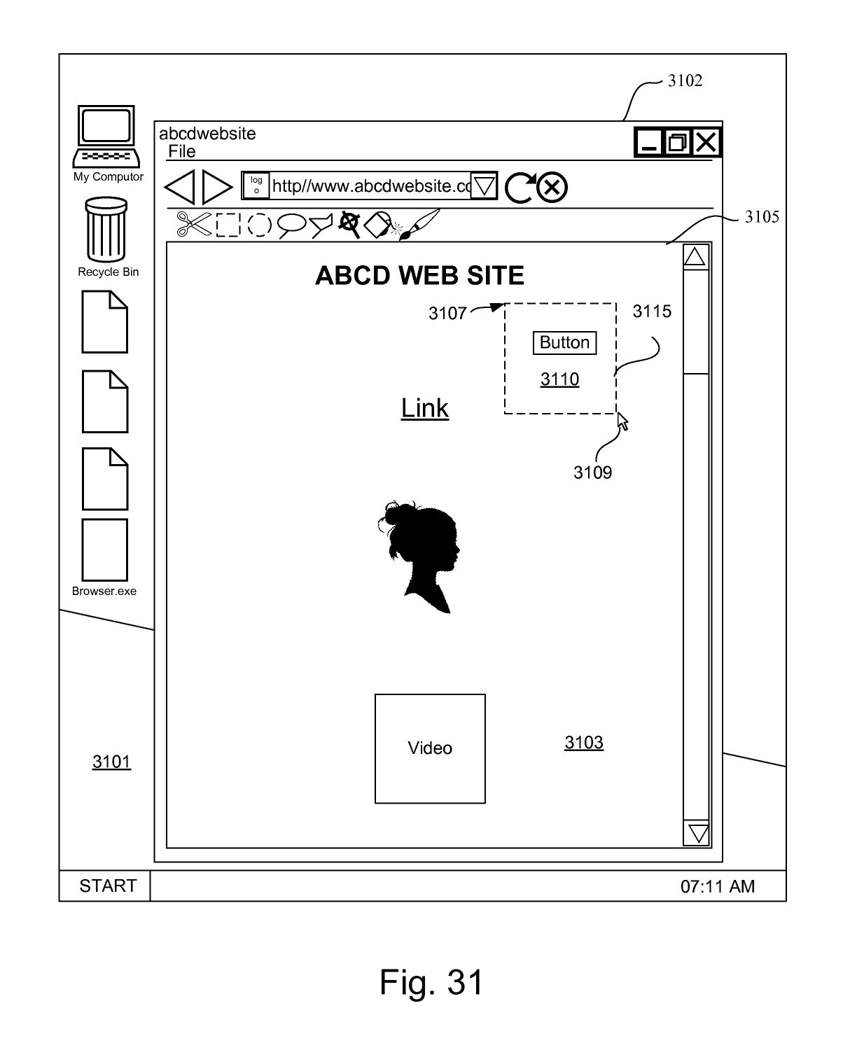

As a result, the webpage is displayed in its own browser window with most of the browser chrome stripped away. The window is just large enough to display the captured content and the application input buttons without the need to render any scroll bars. A beveled border around the captured area is styling on the wrapper div. The captured web content rendered within the browser window includes the functionality associated with the web content. Alternatively all the chrome may be stripped away and the captured content may appear in a floating or borderless window with user input appended thereto or associated therewith, such as a favicon, toolbar, or drop down menu (e.g., as shown in FIGS. 31-38).

A bounce.jsp provides an intermediate step to open a display UI when accessed from a URL (e.g., when a bookmarked URL is access or from a URL embedded in a message or electronic communication). The server side code prepares a request scope bean containing an identifier for a capture operation (i.e., the capture ID) as well as a dimension for the pop-up window to be opened when the page loads. The target URL of the pop-up window displays a populated display.jsp as described above.

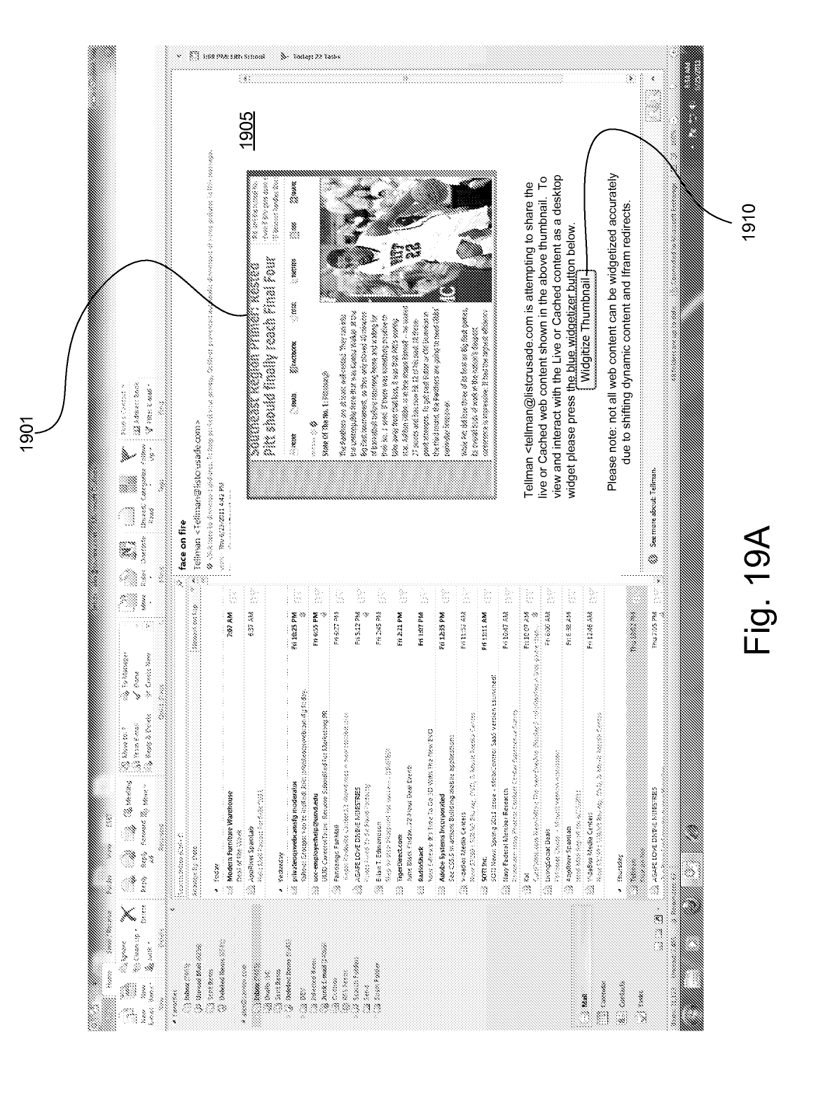

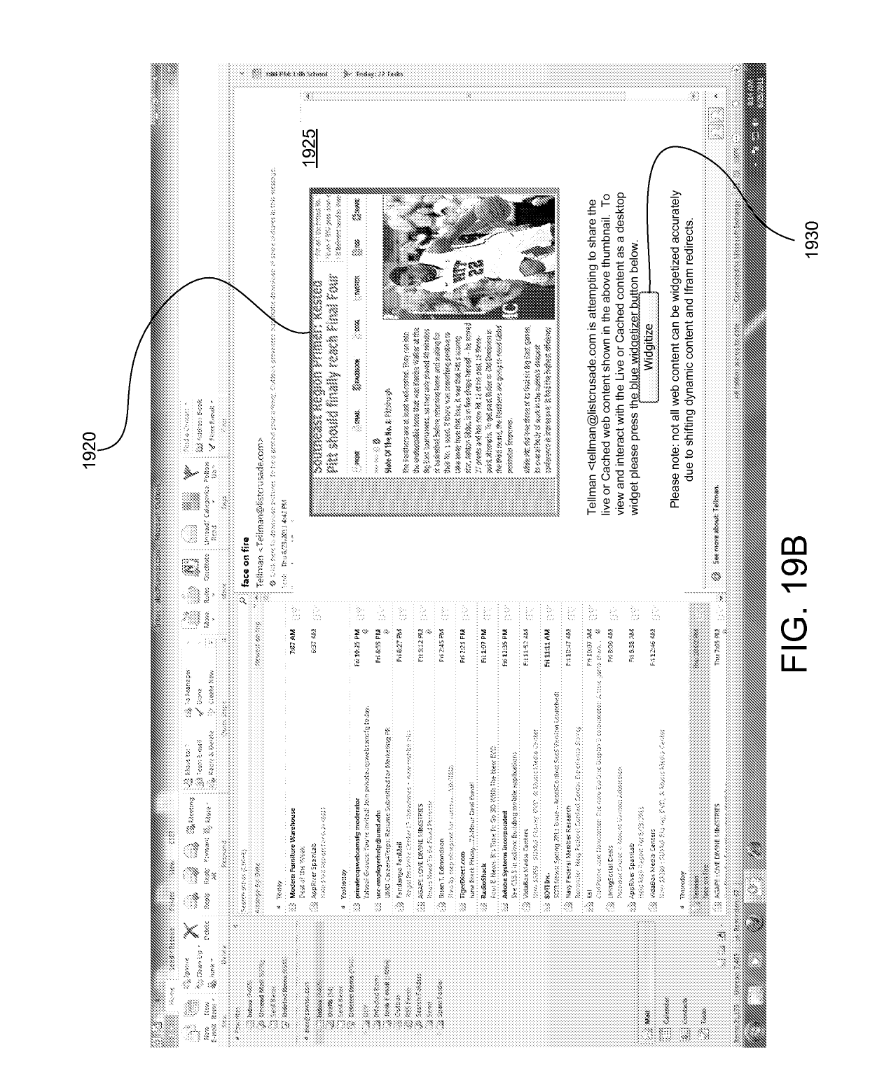

From the interface, the user may access a user input to create a message or other electronic communication to share the captured content with other users via their client user devices. In one example, a button of the interface is configured to display a popup form 478. The form includes one or more fields. In particular, a field is configured to receive one or more email addresses. The client side display logic submits the completed form to the server side email service 484. The email service extracts an ID associated with the form 486, retrieves metadata associated with the ID from the database 488, generates an email message including a link to the captured area or a custom widget viewport presenting the content 490 and sends an email message to any user specified by the received form 492 via a mail server 494. A user receiving the message may select or otherwise activate the link to have a user interface of an associated client device render the captured content in an interface window using the above-described processes. In another example, an image, such as a thumbnail of the capture area may be included with the email and access to the captured area may be provided by a call to the service provider system with ID to activate the display service and thus present the captured content. In yet another example, if the email supports HTML, the interface window may be rendered directly in the email (as shown in FIG. 19B). If the email does not support HTML, a link activating a browser may be alternatively supplied to access the captured content.

In one example, a client-side interface for the email service consists of a modal dialog implemented in JavaScript. This dialog wraps an HTML form and provides the following input fields: recipient email address; sender email address; message subject; message text. The form provides validation to ensure the email addresses are submitted and in the proper format. The subject and message fields are optional and are populated with default values when these fields are null. The Email service consists of the EmailServlet class. This class is responsible for: handling and formatting input from the email form and populating data transfer objects that are used to access the relational database; handling any errors encountered during the email operation and providing meaningful feedback to users.

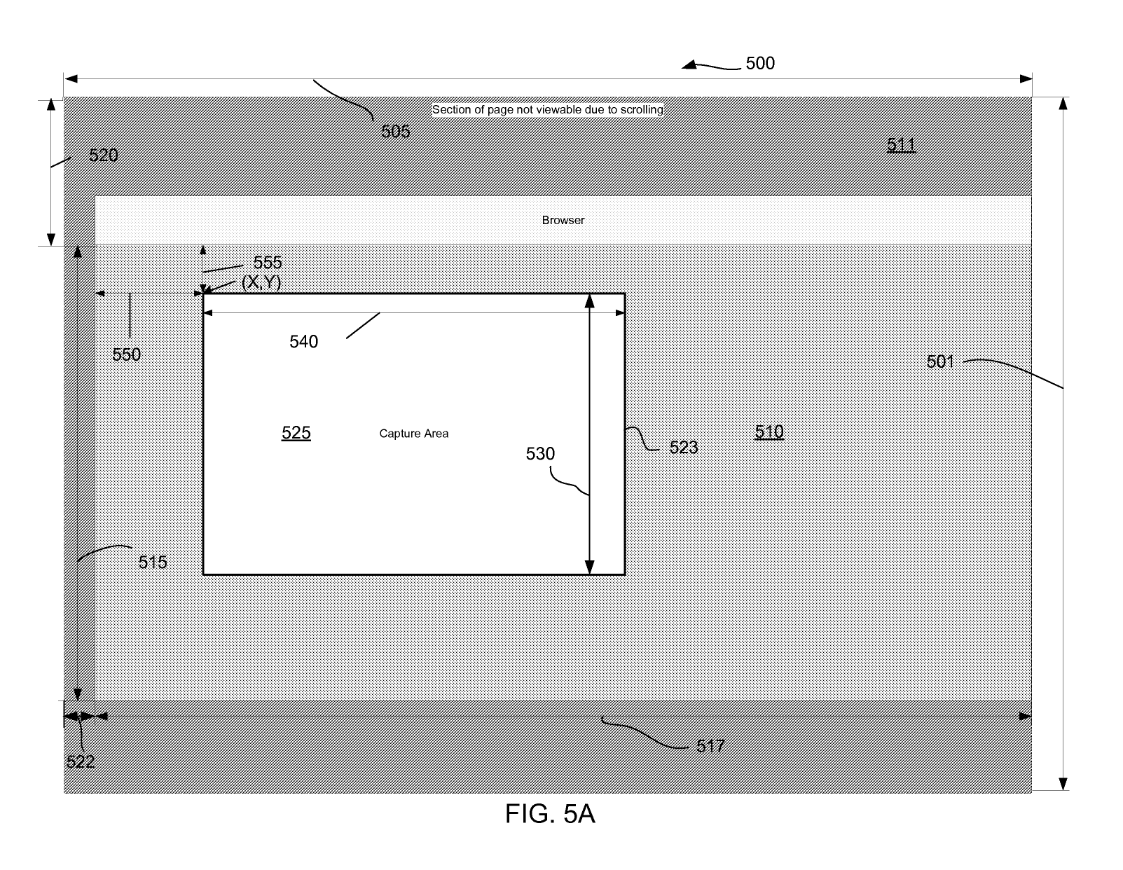

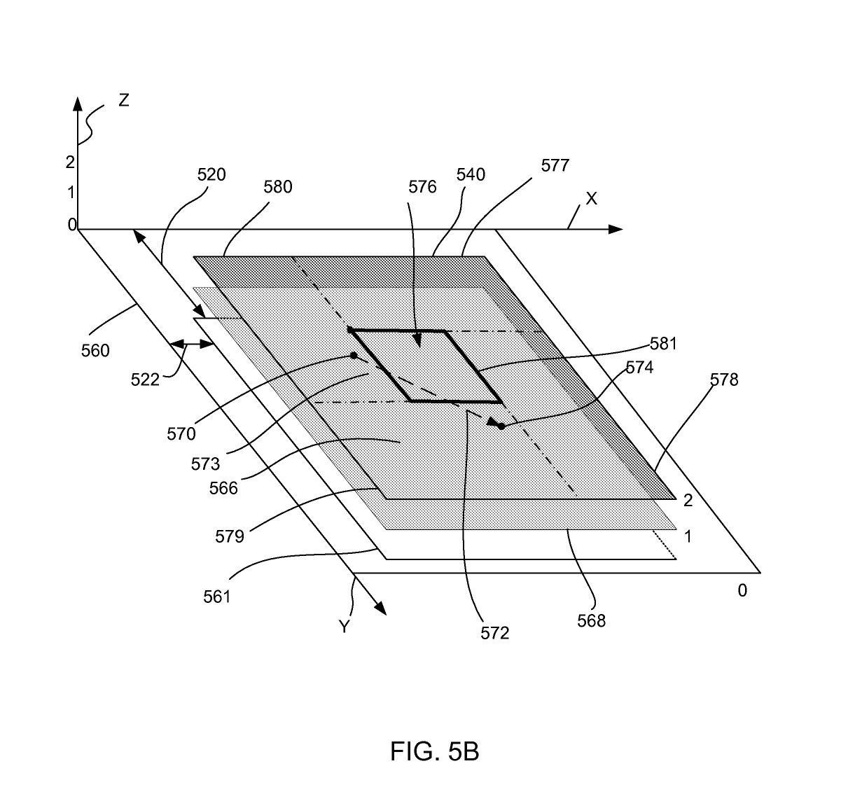

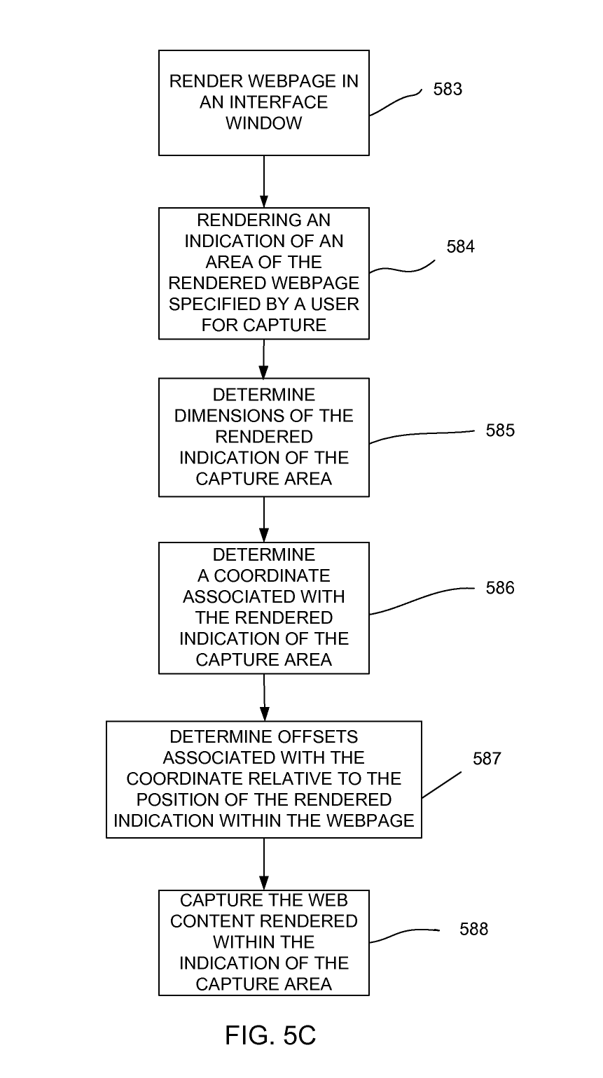

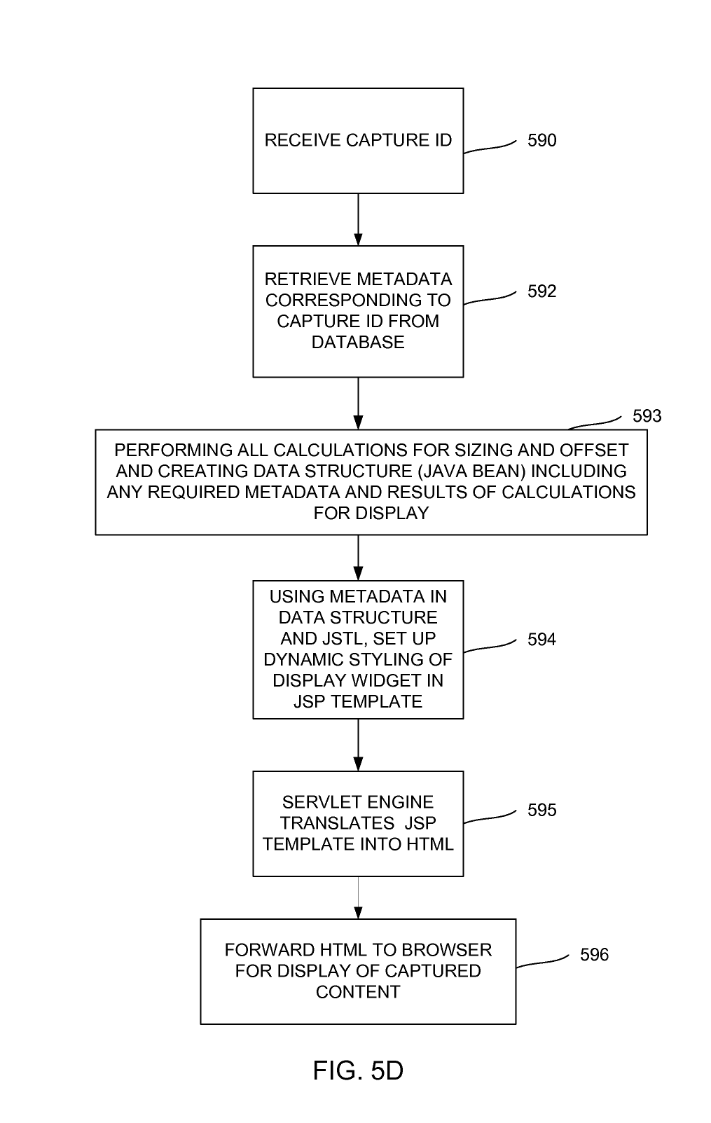

FIG. 5A is an illustration of one example 500 of generation of metadata from a capture area relative to the source page. The capture data includes metadata that embodies the webpage, the capture area and associated web content within the webpage, and the browser rendering the webpage. As shown in FIG. 5A, a webpage includes a document height 501 and a document width 505. If the height and width of a webpage is greater than the resolution of the browser only a portion of the webpage 510 may be presented or rendered in the browser window or viewport leaving a portion of the webpage not viewable without scrolling 511. In addition, the browser area that is rendered has a visible height 515 and a visible width 517. The position of the browser window within a page may be determined from a scroll top position 520 and a scroll left position 522. As described above, the user input device of a user device is used to form an indication, such as a contiguous boundary 523 around the capture area. In one example, this contiguous boundary may be a string of pixels bounding the capture area. The capture area 525 within the presented portion of the webpage 510 has a capture height 530 and a capture width 540. In the example shown in FIG. 5A, the capture logic of the client side capture logic gathers the following metadata: the URL of webpage, X coordinate 550 of upper left corner of the capture area, the Y coordinate 555 of upper left corner of capture area, the width of capture area, the height of capture area, the width of the browser viewport, height of the browser viewport, the total width of the document, the total height of the document, the current scroll position of top of the browser viewport, the current scroll position of left edge of the browser viewport, and the page title. The capture metadata is processed to form a URL_CAPTURE record that is stored in the relational database. The heights, widths, and positions may be measured in units of pixels.

As described above, the metadata may be used to position an interface window to present the captured web content. The metadata may be used to “shift” the top and left coordinates of the window to position the window relative to the webpage to isolate the area of the webpage that was captured. The amount of the shift is called the offset for each axis. The X axis offset is relative to a horizontal X coordinate and the left-hand scroll position of the browser at the time of the original capture operation. The Y axis offset is relative to a vertical Y coordinate and the top scroll position at the time of the original capture operation. These offsets are negative values in pixels that are used to shift the window or viewport to a position that starts at the top left of the original capture area. In this example, the formula used to calculate the offset for an axis is: Offset=0−(coordinate+scroll position). For example, if the original capture top-left coordinates is 100 pixels from the top of the browser viewport and 100 pixels to the right of the left side of the browser viewport, and the scroll position is top=100 pixels, left=0px, then the X axis offset is −100 pixels (0−(100+0=−100) and the Y axis offset is −200 pixels (0−(100+100)=−200).

Of course, the capture metadata shown in FIG. 5A is only one example of the metadata that may be captured. For example, different coordinates and dimensions representing the capture window may be taken, such as a different corner or different positions used in conjunction with the dimensions of other shaped viewports (e.g., a geometric shape) or a drawn capture area (e.g., a freeform shape).

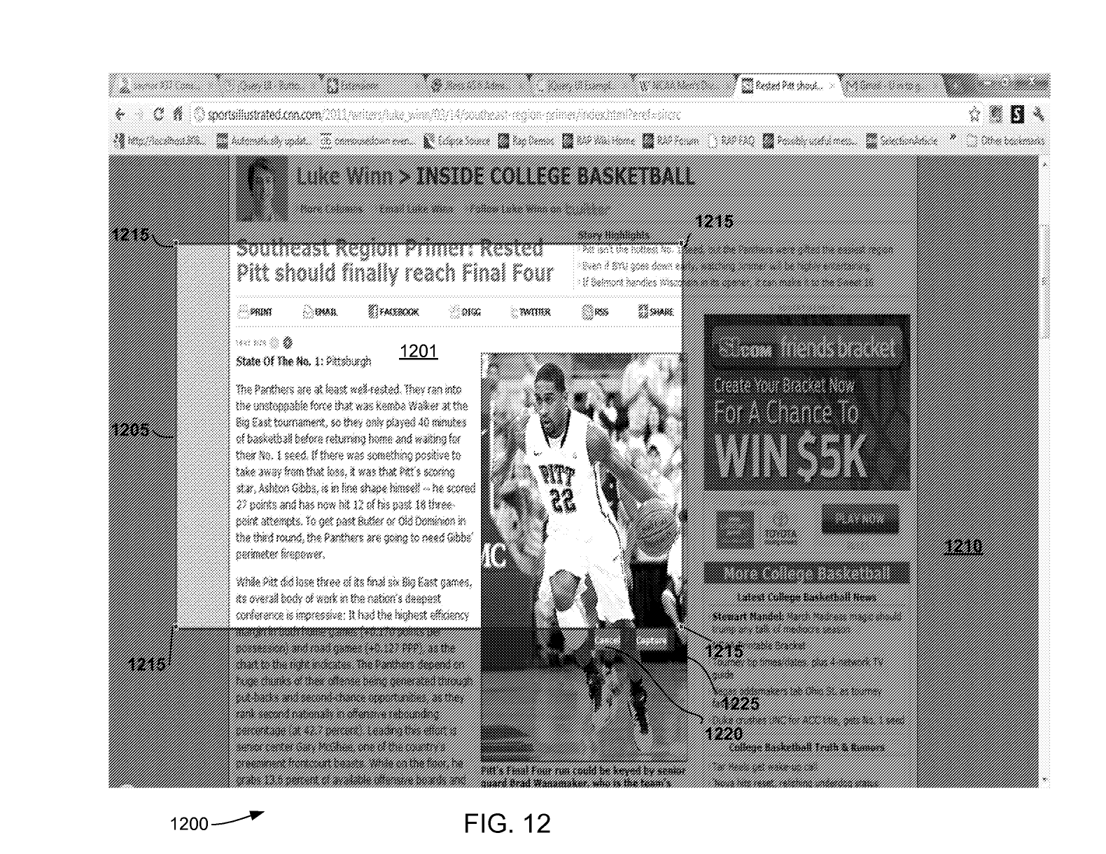

FIG. 5B shows an illustration of the capture operation in three dimensions according to an X, Y, and Z axes. As shown in FIG. 5B, three layers (Z=0, 1, and 2, respectively) are provided in the X-Y planes that when viewed from above along the Z axis provide metadata of FIG. 5 and the rendered view of FIG. 12. The coordinates of the X axis and Y axis may be measured in units of pixels. The Z axis represents the layer's position based on the standard HTML z-index style attribute.

A first layer (z-index=0) represents a web page 560. A portion 561 of the webpage is presented in an interface window. In this example, the resolution of the interface window is too small to display the entire web page. As a result, the interface window has a top scroll position 520 and a left scroll position 522. The top scroll position is the distance from the top of the webpage in pixels to the top of the interface window. The left scroll position is the distance in pixels from the left edge of the web page to the left side of the interface window. The portion of the webpage includes an area of interest to a viewer of the web page or target area 566 for capture.

A second layer (z-index=1) represents a layer masking the interface window that tracks events indicating user interaction between a user and the webpage. The second layer may be implemented using a <div> element 568 sized to mask the interface window that presents the portion 561 of the webpage. A <div> element is a container for other tags. Div elements are block elements and work behind the scenes grouping other markup tags together. In this example, the <div> element is used to track events that represent a user input, interaction with, or manipulation of the webpage associated with a user input device and the presentation of the webpage.

In order to capture the area of interest, the user defines, specifies, or selects the capture area by using a user input device. In one example, the <div> element 568 tracks three events used to help determine the capture area. For example, a first event (e.g., a mouse down input) indicates the coordinates of an initial position 570 of an indication rendered on the webpage as the starting point to define the capture area. A second event (e.g., a cursor or mouse move input with mouse down) indicates movement 572 of the user input relative to the presented webpage. As the second event occurs the <div> element is used to continually calculate a boundary 573 determined by the anchor point and a current position associated with the move. A third event (e.g., a mouse up input after mouse down move) indicates a second coordinate 574 used in conjunction with the coordinates to define a final boundary of the rectangle the selected capture area.

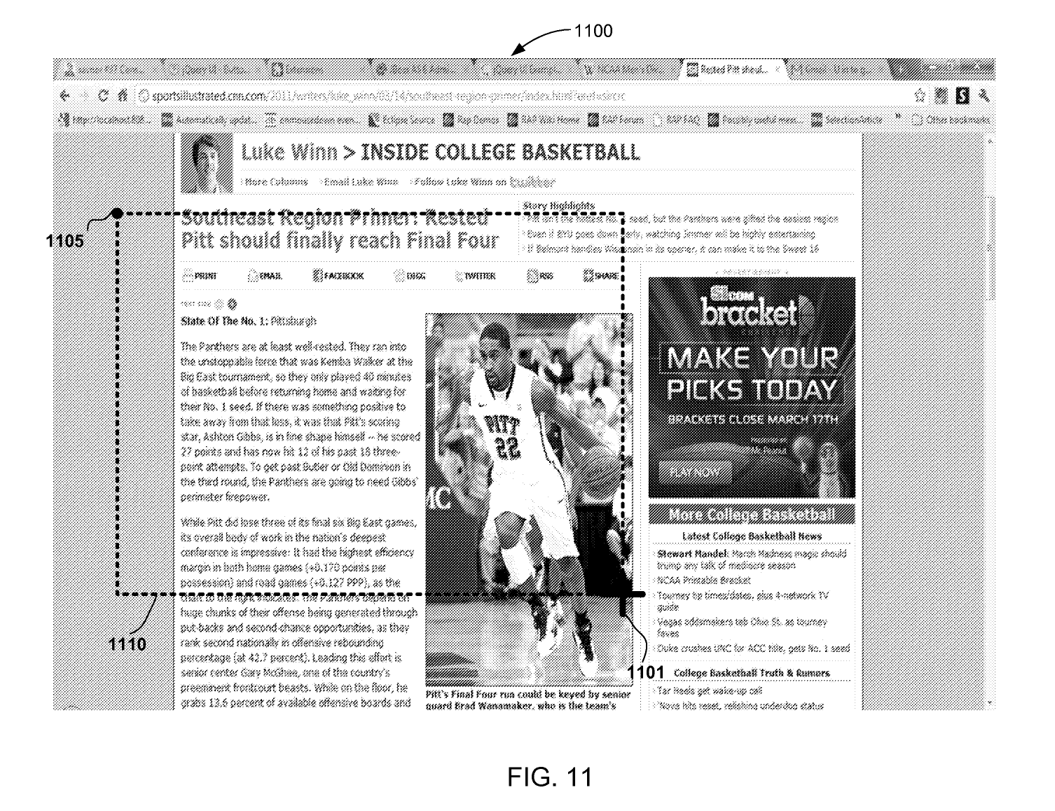

A third layer (z-index=2) represents a layer also masking the interface window that shows a representation of the capture area and the boundary of the capture area. The third layer may be implemented using five <div> elements. A capture <div> element 576 represents the targeted capture area and the capture area. Four remaining <div> elements 577, 578, 579, 580 are laid out clockwise around the capture <div> element. The <div> elements are dynamically sized according to the events of the second layer. The capture <div> element may be styled to show an indication of the capture area, such as a border 581 of the area of the capture <div> element. During the second event the border may be styled to indicate the current position of the border of the capture area (e.g., marching ants as shown in FIG. 11). Once the third event occurs the border may be styled to indicate the border of the capture area (e.g., a solid color line). In addition, once the third event occurs, the other <div> elements 577, 578, 579, 580 may be assigned an attribute or style to visually contrast the remainder of the webpage from the capture area (e.g., transparent shading as shown in FIG. 12). The capture area may be determined using the dimensions of the capture area <div> element in addition to the top scroll and left scroll dimensions in conjunction with the anchor point coordinates. The dimensions of the capture <div> element are used to size a viewport or interface window that presents the captured web content. The top scroll and left scroll dimensions in conjunction with the anchor point coordinates determine an offset (e.g., and x pixel offset and a y pixel offset) to establish an anchor coordinate to shift the viewport or interface window relative to the webpage and position the viewport or interface window to present the capture area.

FIG. 5C is an example of a method of capturing web content of a webpage provided by a web content provider system and rendered by a user device. First, a webpage is rendered in an interface window of the user device (583). An indication of an area of the rendered webpage specified by a user input device for capture is rendered in the interface window (584). For example, a rectangle may be drawn or otherwise positioned on the rendered webpage to indicated and select the desired portion of the webpage for capture. The dimensions of the rendered indication of the capture area are determined by a processing device (585). These dimensions may be measured in pixels and determined as explained above. Coordinates associated with the rendered indication of the capture area also are determined by the processing device (586). For example, the coordinates of a pixel may be determined corresponding to the upper left hand corner of the rectangle. Offsets associated with the coordinates relative to the position of the rendered indication within the webpage are determined by the processing device (587). For example, X and Y offsets may be determined as described above. The web content rendered within the indication of the capture area may be captured by persistently storing an identifier of webpage, the determined dimensions, and the determined offsets in a storage device in addition to other data (588).

FIG. 5D is an example of a method of presenting captured web content rendered by a user device described above. First, a capture id is received as a request to display the captured content (590). Metadata corresponding to capture id is retrieved from a database of the service provider system (592). For example, the metadata such as that described above with regard to FIGS. 5A and 5B. A data structure is created (593). In one example, the data structure may be a Java Bean. The data structure is used to store any required metadata for display of the captured content. The service provider system performs all calculations for sizing and offset and stores the results and any required metadata in the data structure. Dynamic styling of display widget set up in jsp template using the data stored in the data structure and jstl (594). A servlet engine translates jsp template into well formed html including markup tags to display the capture area in an interface window of a client device (595). The html including markup tags are forwarded to a browser for display of captured content in an interface window (596).

Although the preceding examples have, for the most part, been described in terms of forming markup tags on the server side that are transmitted to the browser of the client device, alternatively the metadata or a processed version of the metadata may be provided to the browser and the code, tags, or HTML used to render the window presenting the captured web content based on the location of the selected capture area may be created by the client side processing device.

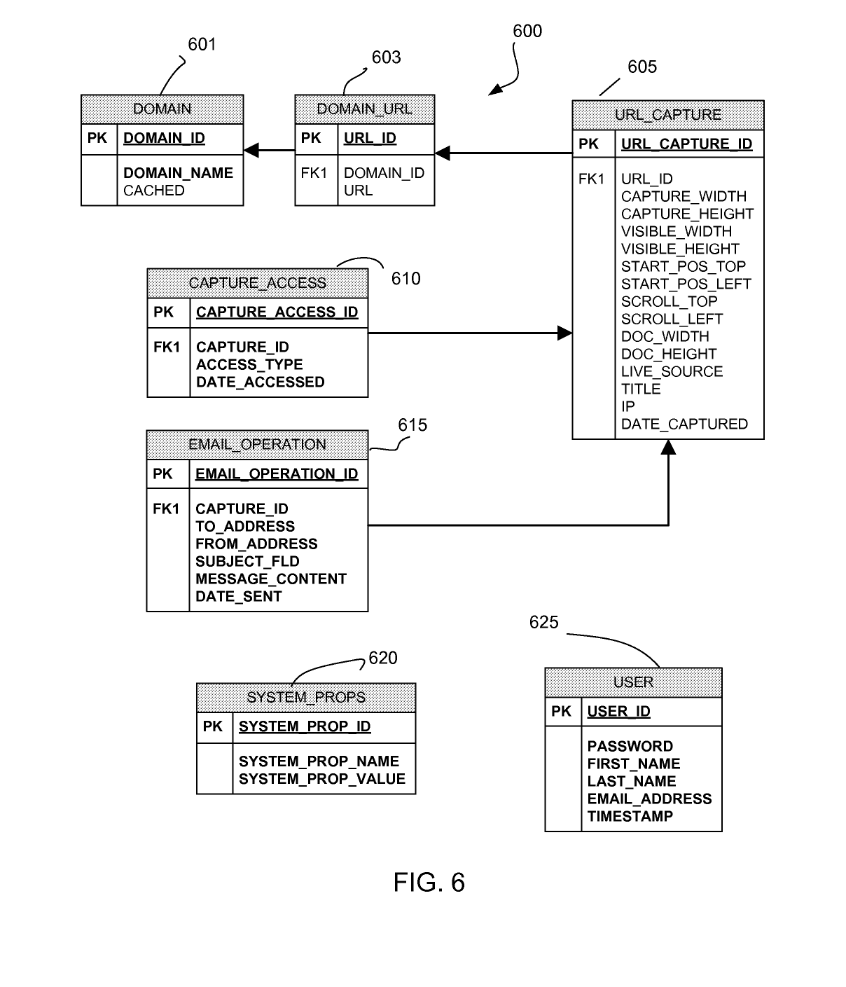

FIG. 6 is an exemplary database structure 600 for an implementation of the database management service and relational database of the service provider system. The relational database provides a hierarchical structure to store descriptive metadata regarding the capture operation. The descriptive metadata is used to determine or specify the capture area in relation to an associated source page (either live or cached). In one example, the data structure includes at least three entities or records: DOMAIN 601; DOMAIN_URL 603; and URL_CAPTURE 605. Each record includes a primary key (PK) and a foreign key (FK) keys that enforce referential integrity in the database. At the top of the hierarchy is the DOMAIN entity representing a source domain of the captured content. The DOMAIN entity is related to the DOMAIN_URL entity in a one-to-many relationship. The DOMAIN entity includes a DOMAIN_ID and DOMAIN_NAME cached. The DOMAIN_URL entity identifies the source URL of capture content. It is a child entity of the DOMAIN table and has the DOMAIN_ID as a foreign key. The DOMAIN_URL entity includes a URL_ID and the DOMAIN_ID URL. The URL_CAPTURE entity includes all metadata describing a capture operation. For example, the URL_CAPTURE entity includes the URL_CAPTURE_ID, the associated URL_ID, CAPTURE WIDTH, CAPTURE HEIGHT, VISIBLE WIDTH VISIBLE HEIGHT, START_POS_TOP, START_POS_LEFT, SCROLL_TOP, SCROLL_LEFT, DOC_WIDTH, DOC_HEIGHT, LIVE_SOURCE, TITLE, IP, DATE_CAPTURED. The URL_CAPTURE entity is a child entity of the DOMAIN_URL and is related by URL_ID. The CAPTURE_ACCESS entity 610 describes an operation that accesses data. The ACCESS_TYPE field defines whether the access was for a view operation or an email operation. The EMAIL_OPERATION entity 615 stores data associated with emailing captured content and includes elements, such as EMAIL_OPERATION_ID, CAPTURE_ID, TO_ADRESS, FROM_ADRESS, SUBJECT_FLD, MESSAGE_CONTENT, and DATE_SENT. The CAPTURE_ID field on each of these tables is a foreign key referencing the URL CAPTURE table. SYSTEM_PROPS entity 620 includes key-value pairs describing properties used by the application. This is a stand-alone entity and may include elements, such as SYSTEM_PROP_ID, SYSTEM_PROP_NAME, and SYSTEM_PROP_VALUE. USER entity 625 includes user data for secure access to the application and includes elements, such as USER_ID PASSWORD, FIRST_NAME, LAST_NAME, EMAIL_ADDRESS, and TIMESTAMP. Of course, the data structures described above with regard to FIG. 6 are only example, and other forms and data may be store, such as different dimensions, descriptors, links, images, context, keywords, to name a few.

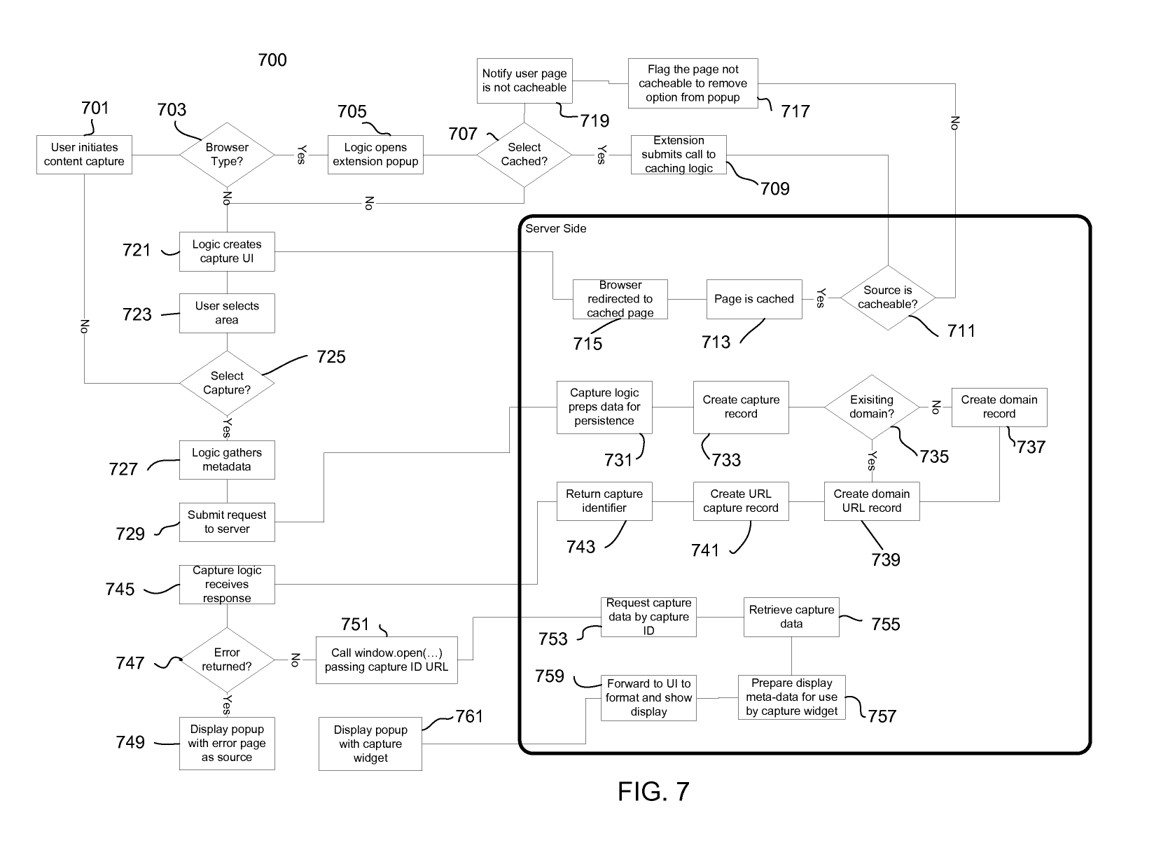

FIG. 7 is an example 700 of a process for implementation of a computer capture tool and capture process. The user initiates content capture process using the browser of the user device (701). The capture process determines whether the capture is made using the browser or a browser extension/plugin or if the capture logic is embedded within the webpage (703). If the capture process is made by the browser or browser extension/Plug-in, the browser opens a popup user interface that allows the user to select whether the content to be captured is live or cached (705). The user makes a selection of whether the user wants to select live or cached content (707). If user selects cached content, the browser submits a call to the caching logic of the capture service (709). The caching logic determines whether content is cacheable (711). If content is cacheable, the source web page is cached (713) and the browser of the user device is redirected to the cached page (715). If the page is not cacheable, the cache option is removed (717) and user is informed page is not cacheable (719) and only live content may be captured.

If the page has embedded logic, the page is not cacheable, or browser is redirected to a cached page, the capture logic creates a capture interface via the browser of the user device (721). The user indicates an area of the webpage to be captured using the capture interface (723). After the area to be capture is indicated, the user selects whether to capture the area or cancel the operation (725). If the capture operation is cancelled, the logic removes the indication from the browser and awaits the initiation of a new capture operation. If the user indicates to capture the selected area, the metadata associated with the captured area is determined by the capture logic (727). The capture logic then submits a request with the captured metadata to the service provider system (729).

The service provider system receives the request and the capture service preps the metadata for persistence (731). For example, the system service provider preps the metadata by converting the values submitted from character strings to numbers, extracting the domain from the URL, and setting appropriate flags to indicate live versus cached data. The system creates a capture record for the metadata (733). The system determines whether there is an existing record for the domain name associated with the capture request in the relational database (735). If the domain name does not exist, a DOMAIN record for the metadata is created for the relational database for the domain name of the source page associated with the capture request (737). Once the DOMAIN record is created or if the DOMAIN record already exists, a corresponding DOMAIN_URL is created (739). Next, the URL_CAPTURE record is created and populated with the metadata sent with the capture request identifying the capture area (741). Once the capture record is created, an identifier is returned to the display logic (743).

The display logic receives the identifier (745) and determines whether any error has occurred (747), such as an improper character in the URL or some unexpected encoding in the title that can occur with data transmission, or some other occurrence due to the asynchronous interactions between capture and display. If an error occurs, a popup window is opened with an error page as the source (749); otherwise, a popup window is opened and a request for the capture data as the source page is generated passing the display service URL containing the capture ID, for example, http://savnor.com/savnorWeb/display?captureId=100&access=true, to the service provider system (751). The request is received by the service provider system, and the corresponding Capture ID (created during capture operation) is determined (753). The capture metadata corresponding to the capture ID is retrieved from the relational database (755). The metadata is prepared for display (757), which is the reverse of the capture prepping, such as the numbers are converted back to strings, padding values may be set, and the window size is calculated. For example, all value calculations are performed including horizontal and vertical offset/scrolling values used to isolate the captured content and all styling attributes requiring padding. In addition, the popup window size values are calculated based on widget size values calculated in the above step. All numeric values are converted back into strings because most of the dynamic styling attributes on the client side use string arguments with a unit designation (e.g., pixels). All values are set in a user interface specific value object for use by the client-side display logic. In one example, the prepared metadata is forwarded to the user interface to format and provide the display. The popup is displayed with the capture widget rendered by the client user device (761).

As described above, the overall architecture of the application can be divided into three distinct functional areas: processes for capturing content, processes for displaying captured content, and processes for processing metadata in support of the applications. In one implementation, the capture and display processes are decoupled; that is, the processes operate independently of each other and in most cases communicate asynchronously with the system service provider.

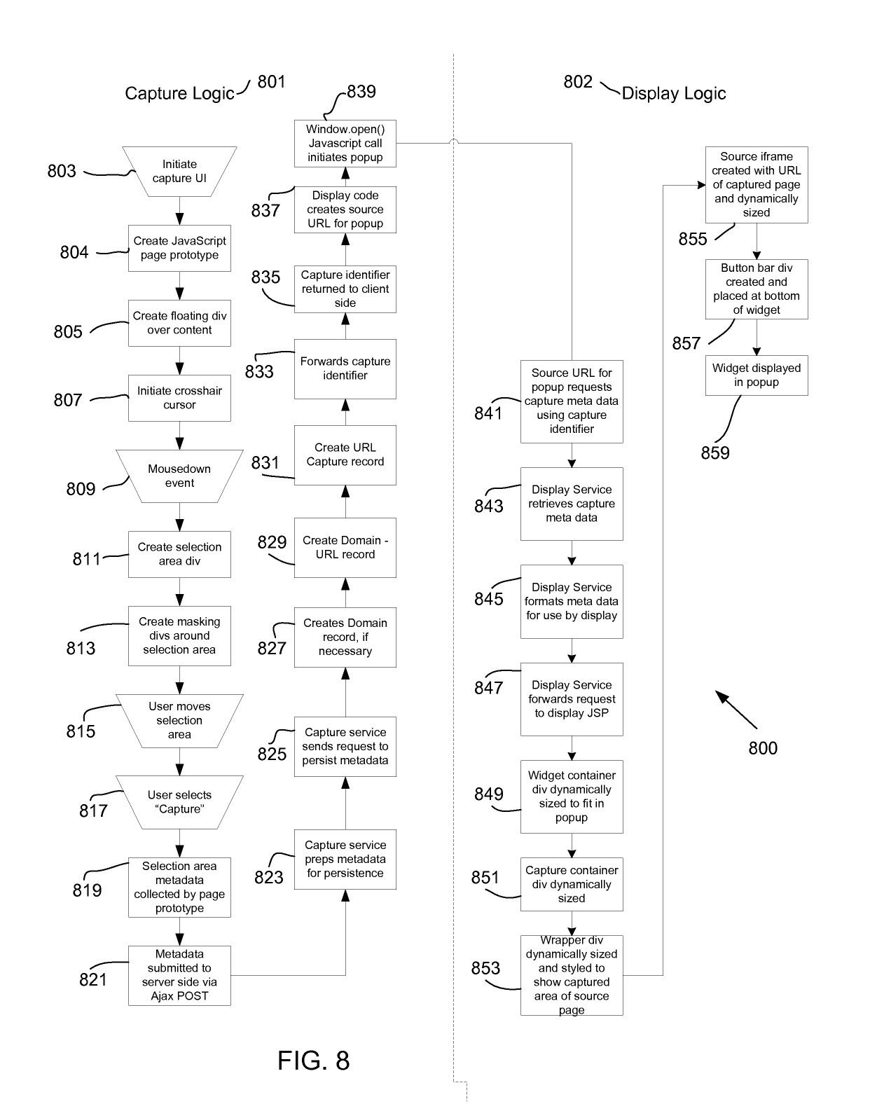

FIG. 8 is an example 800 of a flow chart for capture logic (801) and display logic (802). Invoking the capture logic initiates the capture interface (803). Next, a JavaScript page prototype is created (804) and a floating <div> is presented over the webpage for the capture process (805). A crosshair cursor is initiated and presented within the capture interface (807). The capture logic of the capture interface executed by the client user device awaits detection of a user input, such as a mousedown event and mouserelease event indicating that the user has selected an area to capture (809). In response, the capture interface creates a selection area <div> (811) and also creates masking Divs around the selection area (813). The capture interface processes any user movement of selection area, for example, adjusting the position and/or size of the capture area (815). Once the user selects an area to capture (817), the capture logic of the client user device processes the selection area to determined metadata associated with the page prototype (819). The page prototype is a data structure (e.g., an object) used to collect the metadata in one place and to facilitate formatting of the capture message for an Ajax post. Once the metadata is determined, the client user device submits the metadata to a server of the service provider system via an Ajax post (821).

The capture service preps the metadata for persistence to save the metadata in the relational database (823). The capture service makes a request to the database management service to persist the metadata (825). The database management service determines whether a DOMAIN record for the request exists and if not creates one (827). The database management service then creates a DOMAIN_URL record for the request (829). The database management service creates a URL_CAPTURE record for the metadata (831). The database management service returns a capture ID to the capture service for the metadata (833). The server of the service system provider returns the capture ID to the user interface of the client user device (835).

The user interface of the client user device creates a source URL for a popup window (837). A window open ( ) command JavaScript call initiates the popup window (839). The client user device sends a display( ) request to the service provider system for the source URL corresponding to the capture metadata using the returned capture ID (841). The service provider system display process makes a retrieve( ) request for the capture metadata associated with the capture ID from database management service (843). The display logic formats the metadata for use for display (845). The service provider display process forwards the request to display Java Server Pages (JSP) (847). JSP is responsible for managing the display of captured content. A widget container <div> is dynamically sized to fit in the popup window (849). A capture container <div> is dynamically sized for proper placement and padding of a wrapper <div> (851). The wrapper <div> is dynamically sized and styled to show the captured area of source page (853). A source iframe is created with URL of captured page and dynamically sized (855). A button bar <div> is then created and placed at the bottom of the widget (857). In one example, an advertisement also may be provided by creating an advertisement <div> to present the advertisement outside of and/or in relation to the viewport and the widget is displayed in the popup (859).

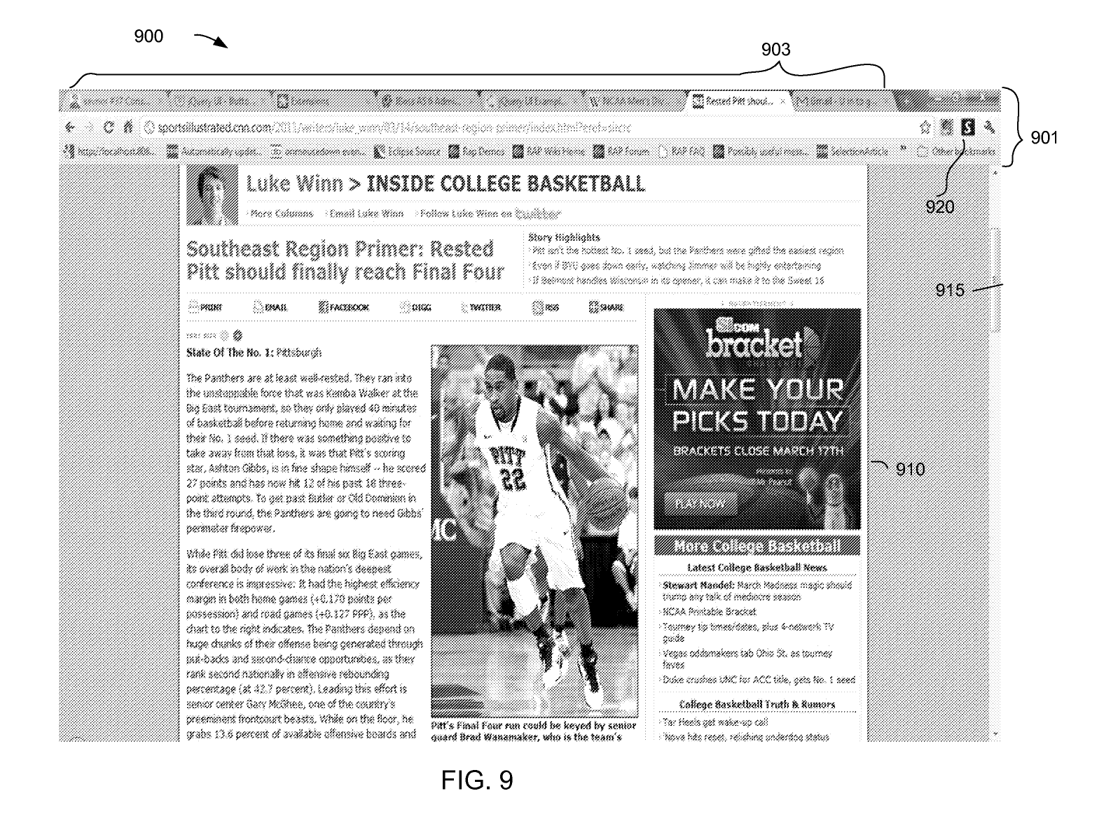

FIGS. 9, 10, 11, 12, 13, 14, 15, 16, and 17 shows examples of screen shots illustrating web content and the use of a browser with capture tool and the capture process. FIG. 9 illustrates a screen shot 900 of the Chrome browser with capture tool extension open to a sports webpage. The Chrome Extension module utilizes the Google Chrome API to create an interface that allows the user to select rectangular areas of a web page, collect descriptive data about the selected area, and transmit this metadata to a server side process of the service provider system. The browser renders a user interface with several tool bars 901 and tabs 903. The browser renders a portion of the sports webpage in a window 910 including a scroll bar 915 configured to allow the use to access portions of the web page that are not rendered in the window. A button 920 with a capture icon is provided on one of the tools bars which may be selected by the user to begin the capture process.

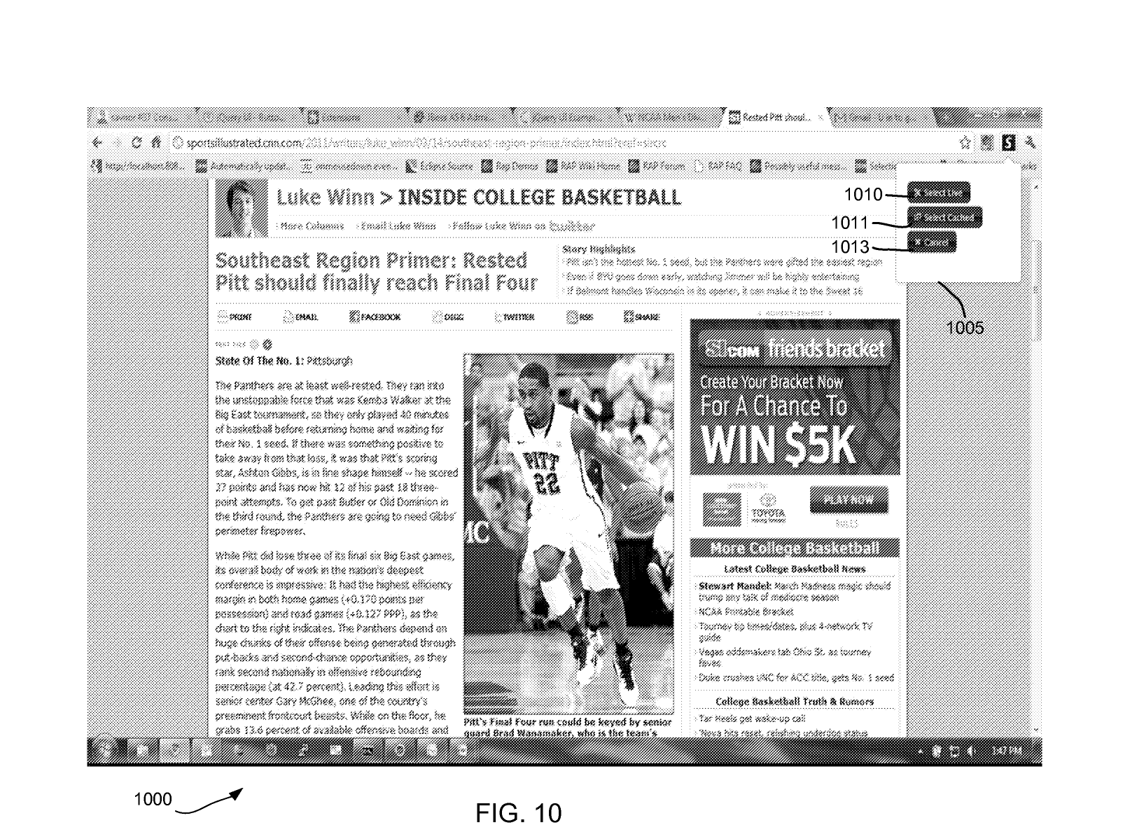

FIG. 10 illustrates a screen shot 1000 after a user has selected the capture icon to begin the capture process. Using the extension, a browser action is used to initiate the capture operation. A browser action typically utilizes a popup interface accessed via an icon on the Chrome browser toolbar. An example of the pop interface 1005 is shown in FIG. 10. The popup interface provides the options to the user to select “Select Live data,” 1010 “Select Archived Data,” (i.e., cached page) 1011 or to “cancel” 1013 the capture operation. Of course other ways of providing these options to the user may be used, such as providing a drop-down menu, presenting the options themselves in the tool as individual buttons or icons.

While the popup interface is the “window” for the extension, the actual functionality of the extension resides in a structure called a background page. A background page is an html page that is not rendered; rather it provides a mechanism by which the extension temporarily injects functionality into a web page being rendered by the browser. The background page is the “server” to the popup interfaces “client.” The background page is also the route by which the extension injects custom JavaScript into the currently rendered web page.

FIG. 11 illustrates a screen shot 1100 after the user has made a selection from the popup interface. Once the user selects the live content option or cached content option a “crosshairs” pointer 1101 is rendered on the display of the web page. Although crosshairs are shown, other types of pointers may be used. The user manipulates the pointer with a user input device of the user device to select a desired capture area as part of the capture process. In this example, a user places the crosshairs at a point and performs a select drag operation. The select drag operation “anchors” an initial point 1105 or pixel of webpage as a corner of the outer boundary of the capture area to the location of the crosshairs at the moment the select drag operation begins. As the user moves the pointer from the anchor point, the outline of a box or rectangle 1110, such as with marching ants, is rendered on the display of webpage with a corner of the box anchored to the initial pixel. The dimensions of the box may be manipulated by movement of the cursor on the display of the webpage. As mentioned, one corner of the box is anchored to the initial point (or pixel) where the select drag operation began. The diagonally opposite corner of the box may be manipulated by movement of the cursor using the user input device to change the dimensions of the box. When the user releases the drag, the outer dimensions of the box outline the selected capture area and the upper left corner is identified as the anchor coordinates. Of course other ways may be used to select the capture area. For example, the user may draw a line to enclose the selected area or predetermined shapes may be rendered and then manipulated by the user, as explained above.

FIG. 12 illustrates an example of a screen shot 1200 of the capture area after completion of the select drag operation. The capture area 1201 is outlined with a line 1205. In addition, other visual indications of the selected capture area may be provided to aid the user. For example, the area 1210 outside the selected capture area may be shadowed to highlight the selected capture area. Little boxes in the center of each line or corners of the box 1215 may be selected by the user using a cursor to further manipulate the outer boundary and adjust the selected capture area. For example, selecting a box with the cursor allows the user to move the box using a select drag operation to move the box and relocated one or more of the lines forming outer boundary of the selected area. In addition, the selection of any other portion of the outline may be selected to move the box around the webpage without changing the dimensions of the selected box. As an alternative to the select drag operation, selection from the pop interface may cause a predetermined shape to appear, such as the box shown in FIG. 12, which may be manipulated by the user input device as described above in this paragraph to select the capture area. Use of a predetermined shape may be useful, for example, in mobile environments where user input devices are limited in functionality or difficult to easily control or manipulate. In addition, a user input (e.g., holding down the Ctrl key on a keyboard) allows the user to select multiple areas. In another example, a user input may be made on a touch screen of the user device by tapping on or more fingers on a desired point and dragging a single finger or two fingers in unison to indicate the capture area or resizing a predetermined shape.

In addition, one or more user input buttons may be rendered on the outline of the selected capture area. As shown in FIG. 12, two user input buttons, “cancel” 1220 and “capture” 1225 are provided. The user may select the cancel button to cancel the capture operation causing the rendered webpage to revert to the state shown in FIG. 9. The user may select the capture input button to capture the selected capture area causing the capture interface to be rendered.

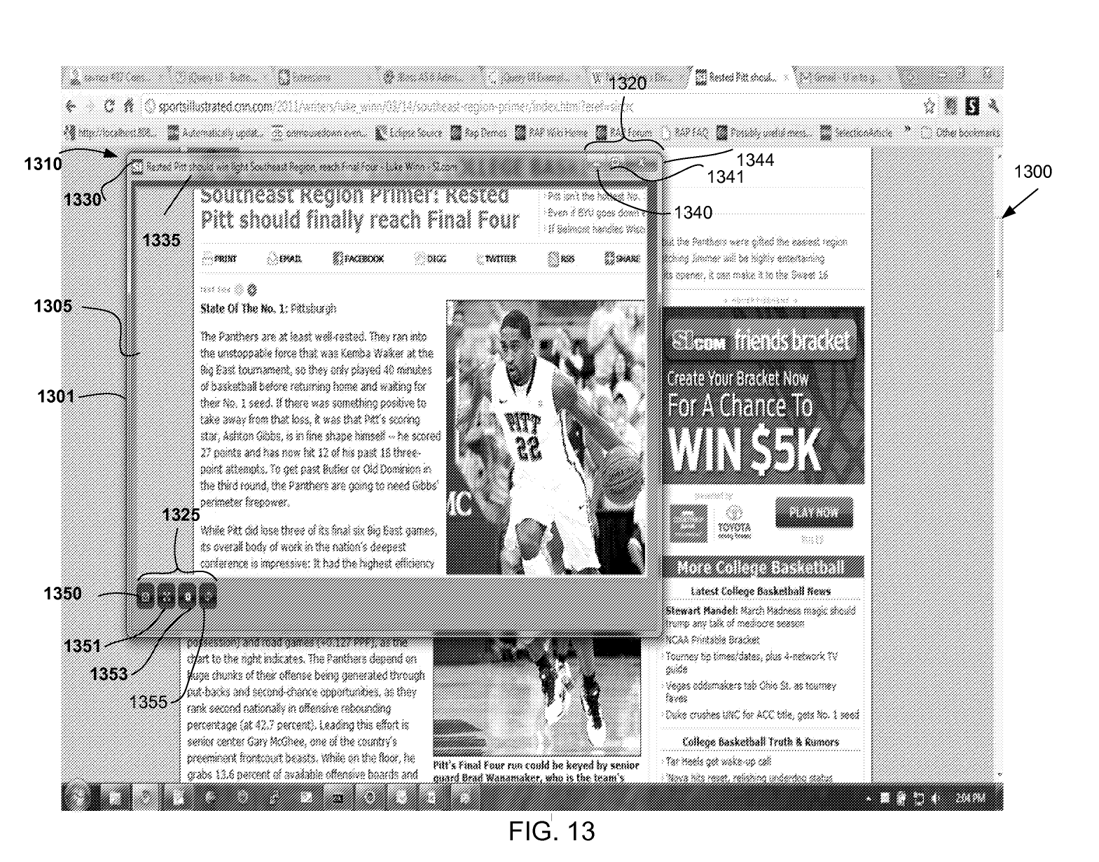

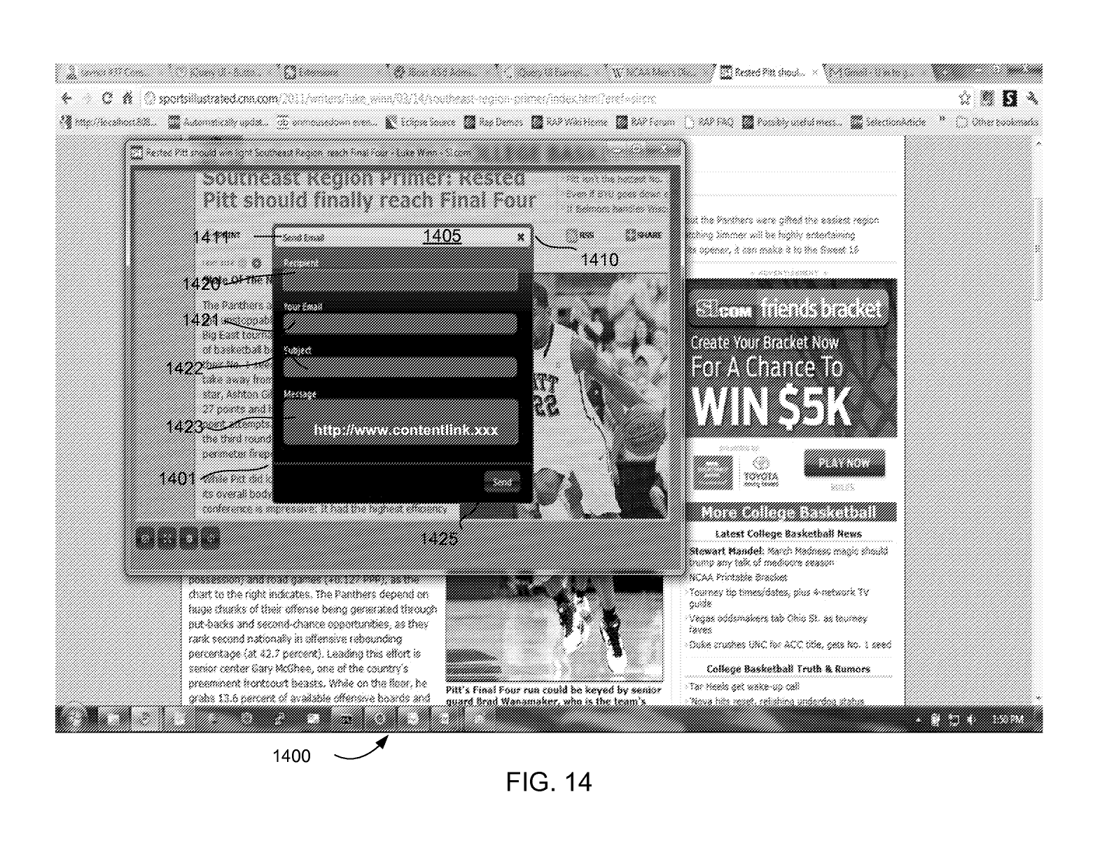

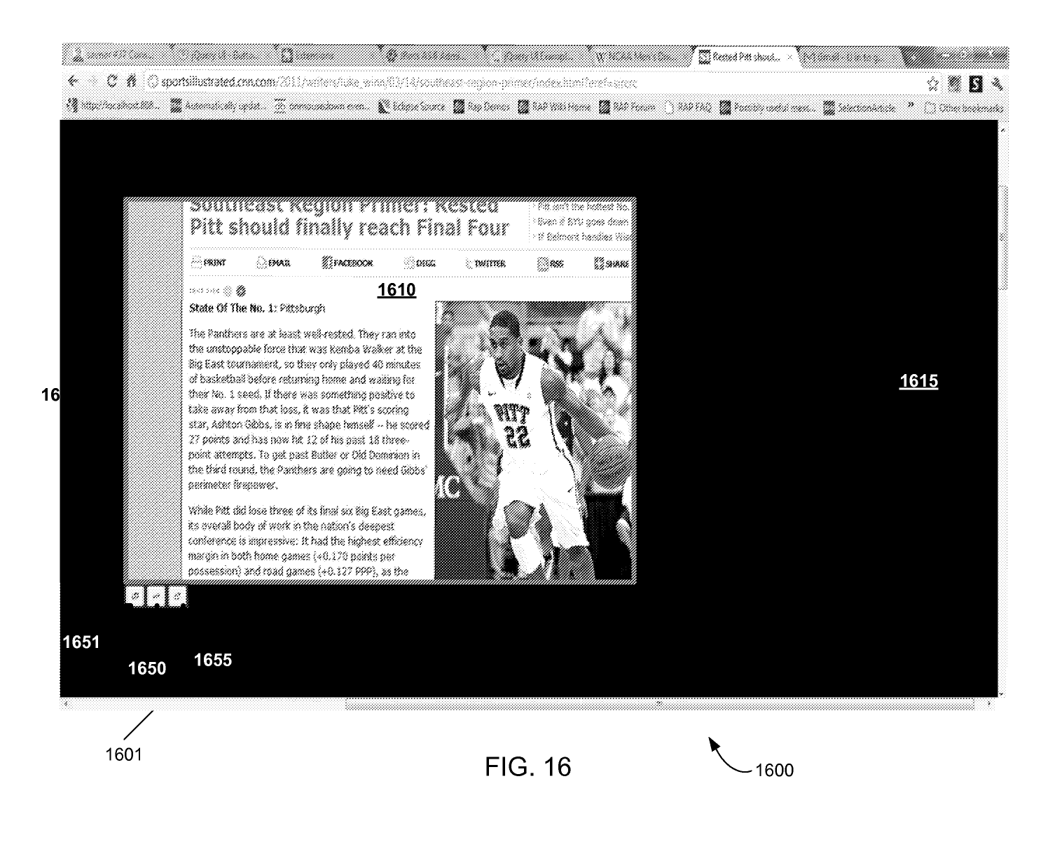

FIG. 13 illustrates an example of a screen shot 1300 of a capture interface 1301. As shown in the example of FIG. 13, the capture interface may be a pop-up interface. The pop interface includes an interface window 1305 configured to present the captured content associated with the location of the capture area. The popup interface may include a title bar 1310, interface input buttons 1320, and capture interface buttons 1325. The title bar displays a favicon 1330 and descriptor 1335 associated with the webpage to which the captured area belongs. The interface input buttons include a minimize button 1340, a maximize button 1341, a close button 1344. Selection of the minimize button causes the popup interface to disappear and a corresponding tab to display on the taskbar of the desktop. Selection of the tab from the taskbar causes the interface window to be displayed. Selection of the close button causes the popup interface to close. The selected capture area may then be re-accessed by selection of a corresponding URL bookmarked from the browser menu, selection of a corresponding desktop shortcut corresponding to the URL of the capture area, or from selection of a widget or a favicon, icon, button or desktop shortcut. The capture interface buttons include a share button 1350, an expand button 1351, a view info 1353, and a refresh button 1355. Selection of the share button causes a share interface window to appear, as shown in FIG. 14. Selection of the expand button causes a full browser window to appear displaying the capture area and surrounding area shown in FIG. 16. Selection of the refresh button causes the captured area to be refreshed.

FIG. 14 illustrates an example of a screen shot 1400 of a share interface 1401. As shown in FIG. 14, the share interface is an email share interface. The email share interface includes a popup window including a title bar 1405, a window input button 1410, and one or more fields for entry of information from a user input device. The title bar includes a description 1411 of the interface. The window input button is a close button, selection of which causes the share interface to close. The one or more fields include a recipient field 1420, a your email field 1421, a subject field 1422, and a message field 1423. The recipient field is configured to receive one or more email addresses of a user with which the user wishes to share the captured area. The user may use a user input device to enter an email address in the field. In addition, the field may automatically populate with one or more email address from a user's contact list or from emails previously entered into the field. A field is also configured to receive the user's email address that is sending the captured content. This field may be automatically populated with the user's email address or the user may select from one of several email addresses to enter. A subject field is configured to receive a user entry for a subject of the email corresponding to the email with the link to the captured area. The message field of the email interface is provided for the user to insert a message to accompany the link to the captured area. The message area may be populated with a link that to the captured area that is included in the email sent to the recipient. The share interface also includes a send button 1425. When a user selects the send button, the share server of the service provider system creates an electronic message and sends a message containing a link to the captured area and any accompanying message to the specified recipient. In this case, the service creates and sends an email with the link to the captured area.

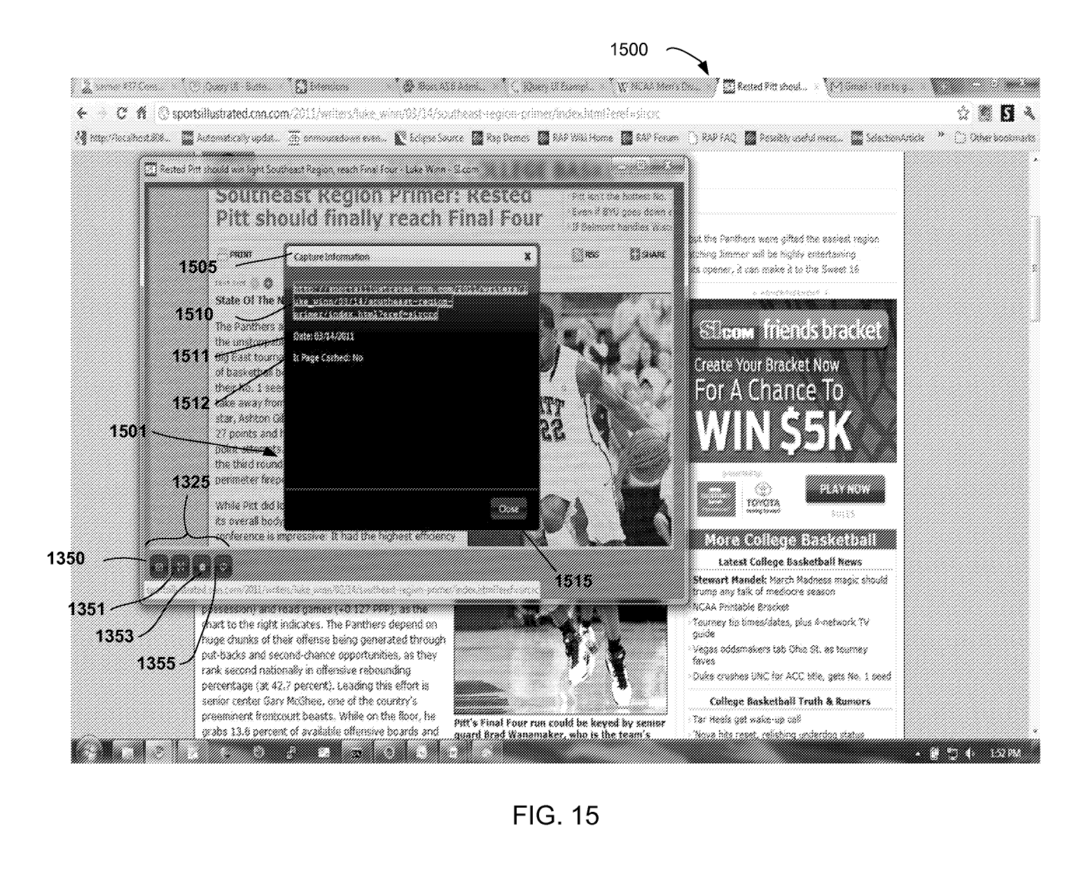

FIG. 15 illustrates an example of a screen shot 1500 of a capture information interface 1501. The capture information is configured to provide information about the captured area. In the example shown in FIG. 15 the capture information includes a popup window including a title bar 1505 descriptor identifying the window type. The window includes a descriptor of the captured content 1510, such as the URL corresponding to the captured area, a date of capture 1511, and whether the content is live or cached 1512. In addition, a user input button is provided 1515. In this case, a close button is provided configured to close the confirmation interface. Alternatively, the capture information provided in the capture interface may be presented on the chrome of the capture interface, for example, adjacent to the input buttons 1351, 1353, and 1355.

FIG. 16 illustrates an example of a screen shot 1600 of the display window of a maximized capture interface. In maximized mode, the capture interface expands to show a full browser window 1601 that includes the capture area 1610 outlined by a boarder 1611. The remainder of the web page 1615 from which the captured content was selected is presented with an overlay configured to be visually distinct from the capture area. For example, the overlay may be configured to produce a shadowed area surrounding the captured content to draw attention to the captured area and provide a context by allowing the user to see the remainder of the webpage. In addition, three input buttons are provided in conjunction with the capture area. The buttons include a widgetize button 1651, a toggle mask button 1650, and an original source button 1655. Selection of the widgetize button causes a popup interface window to appear, as shown in FIG. 13. Selection of the toggle mask button causes shading or visual distinctiveness of the remainder 1615 to be turned on and off. Selection of the original source button causes a browser to present the original source page of the source URL presented by the IFRAME of FIG. 16. If the content presented in the IFRAME is live, the source URL is that of the original webpage from which the content was captured. If the content is cached, the source URL is that of the service provider system cached page of the original webpage.

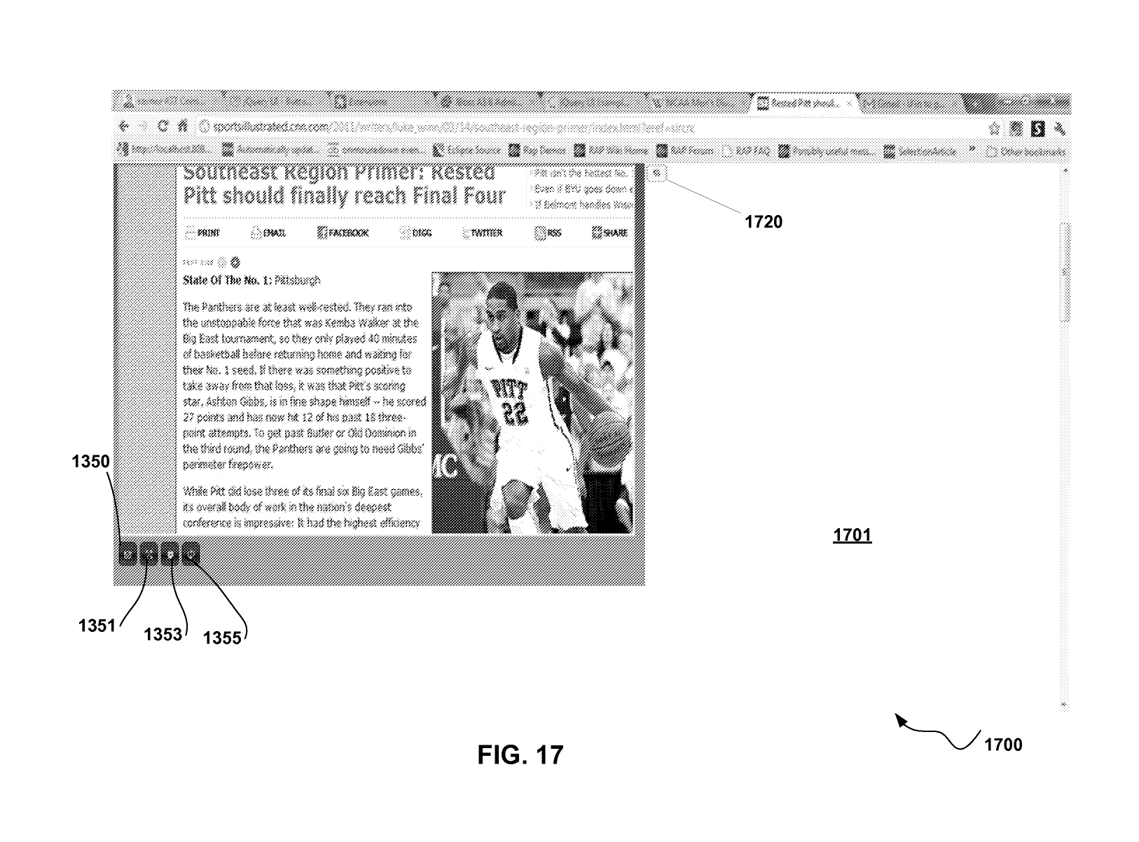

FIG. 17 illustrates an example of a screen shot 1700 of the capture interface open in the tab 1701 of a browser window. The capture interface includes all of the elements described above in conjunction with FIG. 13. In addition, the interface is provided with a widgetize button 1720. Selection of the widgetize button causes the capture interface popup window shown in FIG. 13 to open and display in addition to the capture interface open in tab 7101 of the browser window. Using a tab of the browser, as shown in FIG. 17, may simplify processing in certain situations. For example, using a tab instead of a pop up window eliminates the use of a bounce page or requesting that a user to confirm the service provider as a trusted source in order to activate the popup window. This can be useful, for example, in providing a link to access the capture area in an email as to simply a transaction with a new user who may not be familiar with the service provider or have pre-established settings for the service provider.

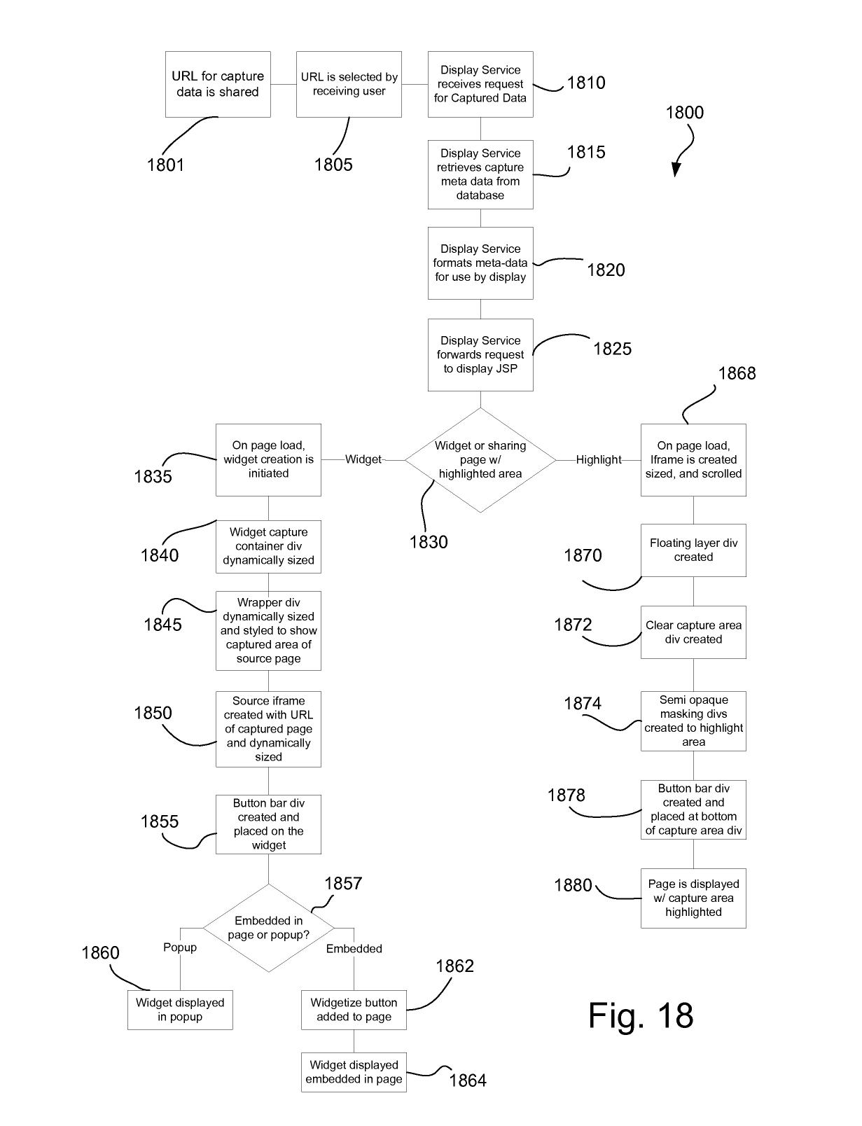

As indicated above, the captured content may be shared with other users by a number of different services. For example, a URL or Capture ID associated with the captured content may be sent by an electronic communications service, such as instant messaging, texting, email, other electronic communications service. FIG. 18 is an example 1800 of a flow chart for sharing captured content. The URL or capture ID for the capture content is shared with another user by use of an electronic communications system (e.g., by email, SMS, text, or other message service associated with a user address or ID) (1801). The URL or ID is received and selected by the receiving user using a communications interface of user device (1805). The display service of the service provider system receives a request for captured content from the user interface of the user device via the URL or capture ID (1810). The display service retrieves the capture metadata associated with the captured content from the database management service (1815). The display service formats metadata for display by the interface of the user device (1820). The display service forwards the request to display JSP (1825). The display service determines whether the request for captured content is being presented as a widget or a content sharing page, for example, with a highlighted area (1830).

If the captured content is displayed via a widget, during the page load of the user interface of the user device, a widget creation is initiated (1835). A widget capture container <div> is dynamically sized (1840). A wrapper <div> is dynamically sized and styled to show the captured area of the source page (1845). A source Iframe is created using the URL of the captured page and the Iframe is dynamically sized (1850). A button bar <div> is created and placed on the widget (1855). The display service determines whether the captured content is embedded in a page or a popup (1857). If a popup is used, the widget presenting the captured content is displayed in the popup window (1860) (e.g., as shown in FIG. 13). However, if the captured content is displayed in a page, a widgetize button is added to the page allowing the user to create a popup window or capture interface (1862). The widget and widgetize button embedded in the page is presented in a tab using an Iframe (1864) (e.g., as shown in FIG. 17).

If the captured content is displayed via a highlight in a page, on a page load the Iframe is created, sized, and scrolled (1868). A floating layer <div> is created (1870). In addition, a clear capture area <div> is created (1872). A number of semi opaque masking <divs> are created to highlight or emphasize the capture area by providing a contrast surrounding the captured area (1874). A button bar <div> is created and placed on the capture area <div> (1878). The page is then displayed with the capture area highlighted 1880) (e.g., as shown in FIG. 16).

Since content of many websites is dynamic in nature, at times the captured content may not be presented within a user interface with a 100% accuracy. For example, the captured content may be live content that changes over time. In another example, dynamic advertisement placement within the page may cause shifting of the content rendered relative to the capture window designated by the user at the time of capture. As a result, the service provider system may include a function, such as a pan tool, to make adjustments to the captured content via the display interface in order to help the user better isolate or manipulate the captured content. This function is provided using a dynamic JavaScript that allows scrolling adjustments to the capture content. The JavaScript allows the user to make adjustments to the scroll position of content wrapped in a container, such as an HTML <div> element. Since the capture content is nested in such a container, this method can be used to adjust the capture display. The dynamic JavaScript takes advantage of the jQuery scrollview library and custom cursor to implement a “hand panning” tool, similar to other panning implementations familiar to web user, for example, the panning ability in Googlemaps, wherein in a user may position a pointer and “grab” the content displayed (e.g., a mouse click and hold operation) and shift/pan the displayed content relative to the user interface window (e.g., a mouse drag with the click and hold).

In another example, when a user shares the captured content, the system creates an image of the captured content. The image may be created using any one of a number off the shelf image software or screen capture techniques. The image may then be inserted into, attached, or appended to an electronic communication when the user shares the captured content. In addition, image scaling may be provided as needed for the size of image, browser/device resolution, message size, type of communication, among other considerations. The image provided in the communication gives a user receiving the message an indication of the user selected captured content. This is useful in providing a context to the user receiving the captured content, for example, in situations, such as those mentioned above where shifting of dynamic content causes the content rendered for the user receiving the communication to shift or change from the originally captured content. As a result, when the capture interface renders the captured content, the user receiving the content may easily identify and/or position the interface based on the image included with the communication, for example, using the pan tool described above, to account for any shift and thereby still view and interact with the captured content as intended by the user who shared the captured the content.

FIG. 19A shows an example of a message for sharing captured content with image. As mentioned above, when a message, such as an email is sent to share captured content, an image or thumbnail of the captured content as it was selected by the user capturing content is created for insertion into the message. The image/thumbnail 1901 is inserted into the electronic communication 1905 along with a widgetize input (e.g., a button) 1910. Selection of the widgetize input causes a popup window of the captured area (e.g., the capture interface shown in FIG. 13) to be presented.

FIG. 19B shows an example of a message for sharing captured content with an embedded interface window. As mentioned above, when a message enabled for HTML, such as an HTML email is sent to share captured content, an interface window 1920 (e.g., an iframe) configured to present the captured content is embedded into the message 1925. A widgetize input (e.g., a button) 1930 also may be provided. Selection of the widgetize input causes a browser to launch and present a popup interface of the captured area (e.g., the capture interface shown in FIG. 13) to be presented.

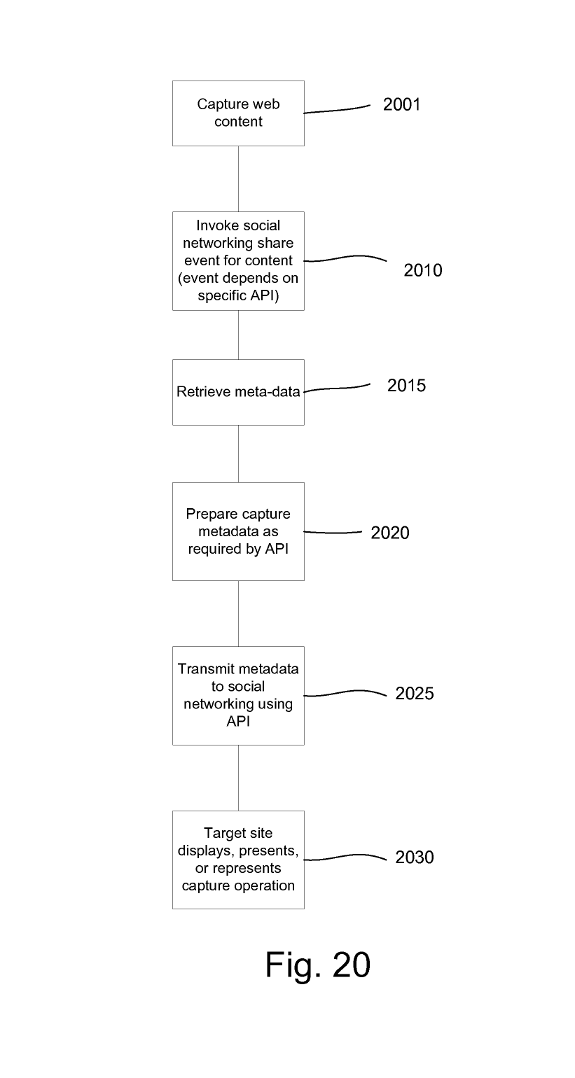

In another example, the service provider system also allows captured content to be shared via social networking service provider websites, such as Facebook, Twitter, among others and personal start webpages (e.g., a personalized dashboard, personalized homepage, home page, custom home page) provided by services like IGoogle, Netvibes, and Protopage. In this situation, the actual sharing of the content depends on the published APIs of the various social networking sites; however, at a minimum the service provider system provides for the sharing of a URL (with appropriate shortening capabilities) and, where applicable, some type of widget, such as those provided in Netvibes or IGoogle, and/or a thumbnail image of the captured content. FIG. 20 shows one example of sharing content via a social networking website. As shown in FIG. 20, a user captures web content via a capture operation as described above (2001). The user then invokes a social networking share event for content, such as, for example directing the service provider system to share content by specifying the content and a social networking website or personal start page (2010). This share event depends on a specific API of the social networking website or personal start page. The service provider system retrieves the metadata associated with the specified captured content (2015). The service provider system prepares and/or formats the capture metadata as required by the particular API (2020). The prepared meta-data is transmitted to social networking website using the social networking site's or personal start page's API (2025). The social networking site or personal start page displays, presents, or otherwise represents the captured content on a webpage (2030).

In one example, the page may be associated with a user's account. Public and private versions of pages displaying, presenting, or otherwise representing the captured content are provided via a browser accessing the social networking site. In this manner, a user may post captured content to the social networking site to share the captured content with others. In one example the content presented may be thumbnails or images of the captured content, which when selected present the captured content to the user in a browser, a popup interface, or an Iframe, as described above. In another example, social networking website displays the actual captured live or cached content. In another example, the social networking website displays the actual capture as a miniaturized version of the captured content.

The service provider system also allows the user to manipulate captured data. In one example, the user may associate separate captured content in a logical sequence, which is referred to as “linking,” meaning a user can link through captured content in some order determined by the user.

If an iframe is used to display captured content, typically the content displayed in the iframe is served by an external domain. As a result, cross-domain security restrictions may limit the access to the document object management (DOM) of the source pages of capture operations. Consequently, the ability to intercept specific user interface events (e.g., mouse click events) on the source page in the iframe may be similarly restricted. While the iframe does allow selection of such controls, the service provider system may not have access to contextual information about the event. Therefore, the service provider system provides a Web-based interface and mechanism to allow a user to associate captured content as the user desires. For example, the user may create associations between capture operations via a user interface, such as, for example, a dashboard or workspace provided in conjunction with the service provider system, as described below.

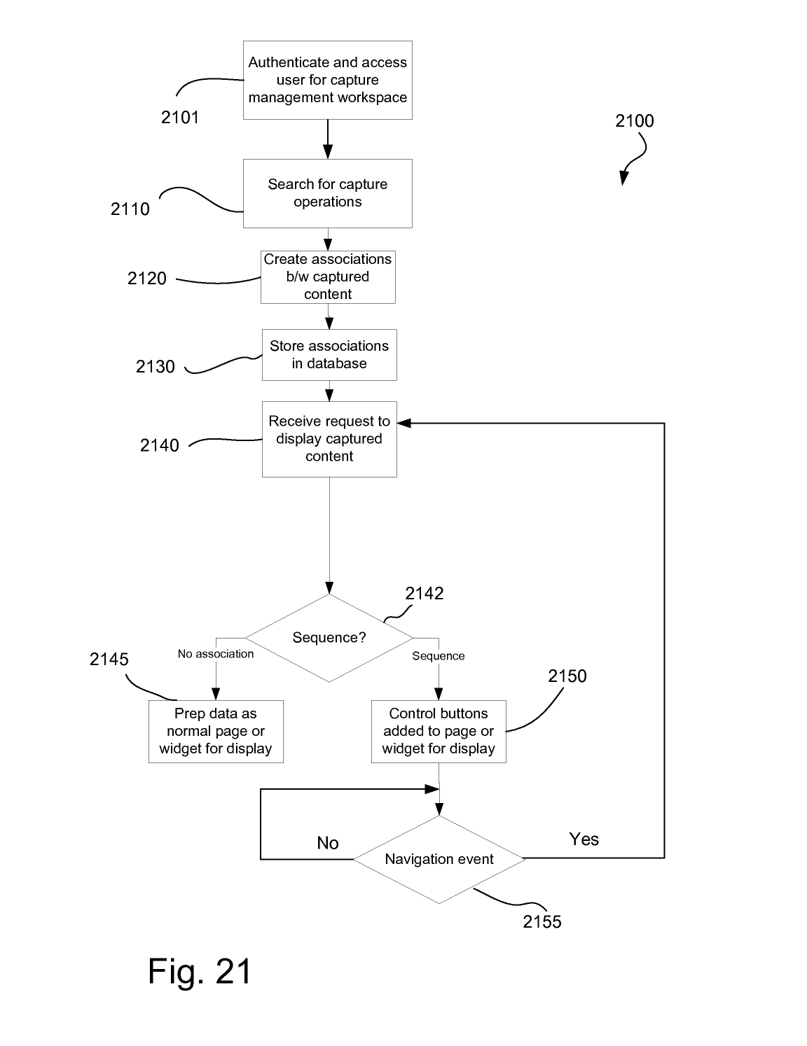

FIG. 21 shows an example 2100 of a method for associating content. A user is authenticated with the service provider system and accesses a capture management workspace (2101). The system searches for captured content associated with the user (2110). For example, a capture session may be associated with one or more capture operations and/or a user account may be associated with one or more of the user's captured content. The system creates associations between the captured content based on received user input (2120). For example, the user may use a user input of the user device to create a link between capture areas. In one example, a visual, drag and drop interface similar to flowcharting software allows the user to drag a link between one or more capture operations associated with captured content to create the associations. The associations are stored by the service provider system database management service (2130). For example, the database management system creates a record in a database table that associates the capture operations of the captured content. The links are accessed by the display logic of the user interface to provide links that can be followed by the user.

The system receives a request for display of captured content (2140). The system determines whether there is a sequence associated with the captured content (2142). If not, the system provides the user interface with the capture widget or highlight (2145) as described above (e.g., in FIGS. 7, 8, and 18). If there is a sequence associated with the captured content, in addition to the elements described above, the system provides a display page or widget with the appropriate controls (e.g., previous and/or next controls) for the captured content relative the captured content's position in the sequence that allows the user to navigate the sequence (2150). If the system, receives a navigation indication, it determines the appropriated capture content in the sequence (2155). The system then provides the display page or the widget with the appropriate controls (e.g., previous and/or next controls) for the captured content relative the captured content's position in the sequence that allow the user to navigate the sequence (2140).

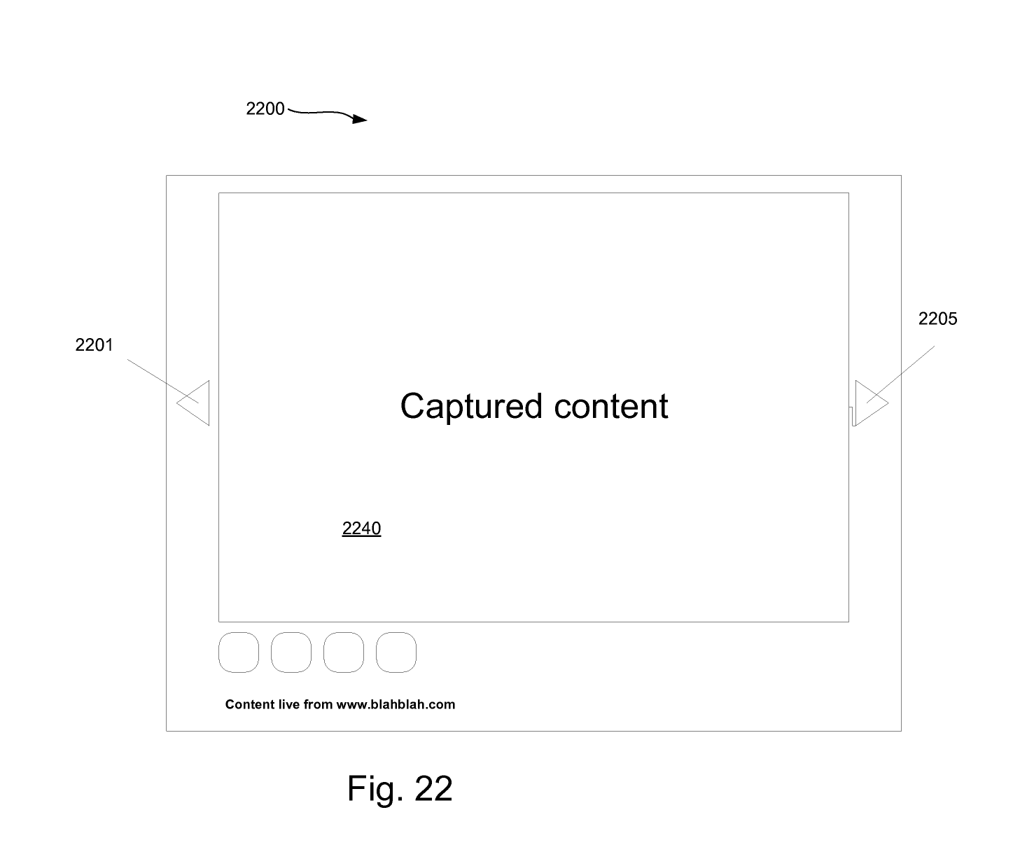

FIG. 22 shows an example 2200 of a capture display widget. The capture display widget includes linking navigation controls including a previous capture operation control 2201 and a next capture operation control 2205. In one example, the display user interface widget provides a navigation tool for associated linking operations to navigate a sequence of captured content. For example, a “Previous” control 2201 (e.g., a link, an arrow, or equivalent) allows the user to navigate to an associated capture operation that precedes the current captured content displayed by the user interface in a series of capture operations. Similarly, a “Next” control 2205 allows the user to navigate to an associated capture operation that follows the current capture content displayed by the user interface in a series.

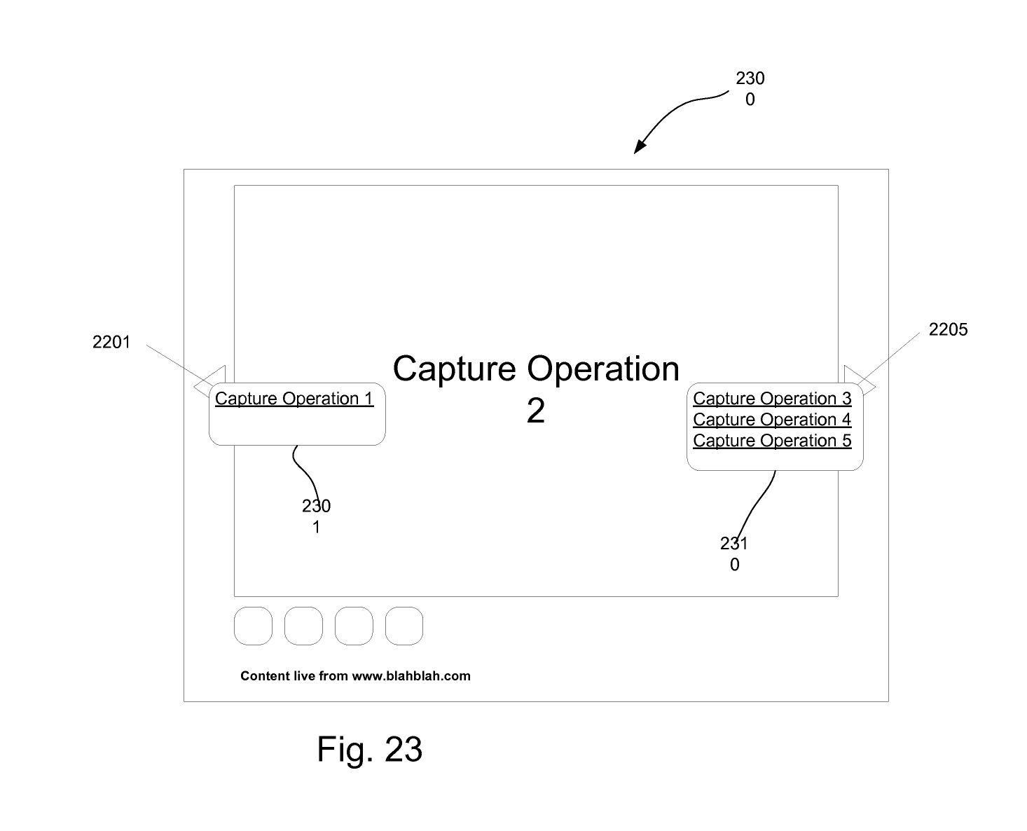

FIG. 23 shows an example 2300 of a capture display widget showing linking navigation lists. In the case of multiple associations between captured content, when the user selects the capture operation control 2201, 2205, a dialog box opens with a list of links 2301, 2310. Any link may be selected by the user to directly navigate to a desired capture operation associated with the link.

The association user interface also consists of an authentication mechanism to identify a user, a search interface for locating specific capture operations, a listing of capture operations associated with the user, and a workspace component that allows the user to associate capture operations.

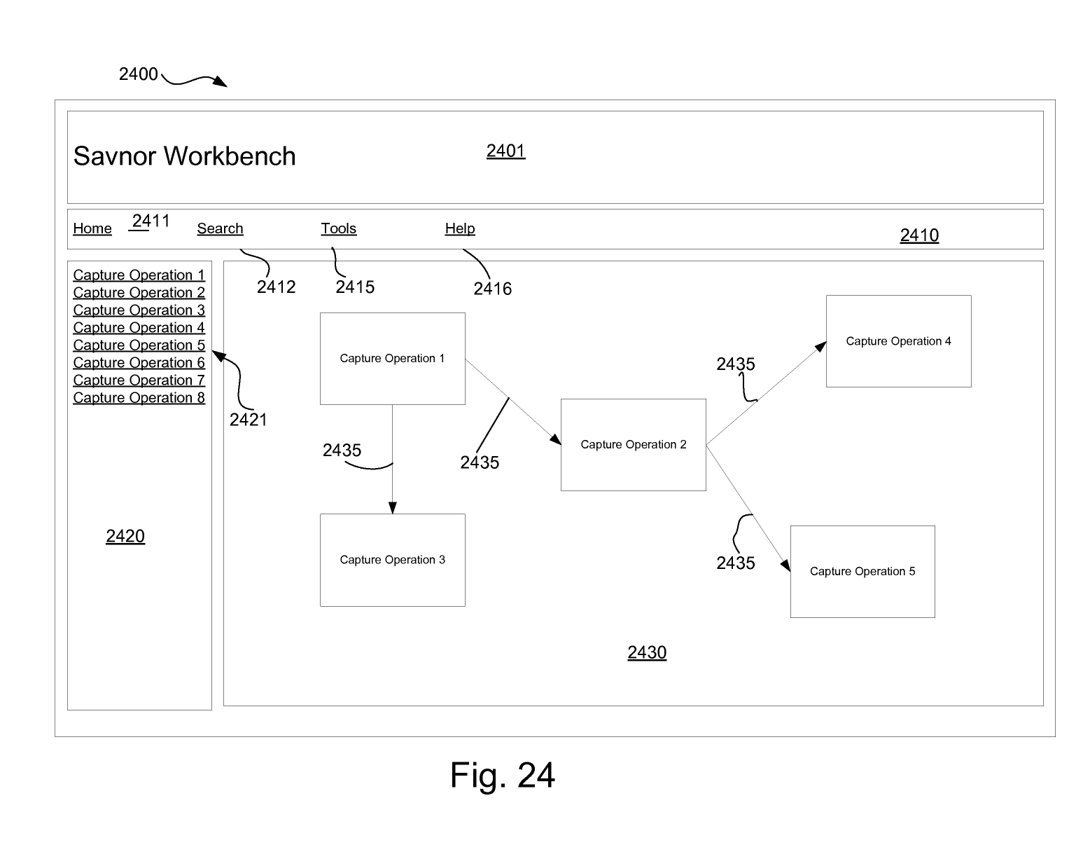

FIG. 24 shows an example 2400 of an association user interface including a workbench main workspace 2401. The workbench may be provided as part of a personal webpage or an interface by the service system provider website that allows a user to interact with associated capture operations. The work bench includes a tool bar 2410 with inputs for a home page 2411, a search mechanism 2412, tools 2415, and help information 2416. The workbench also includes a capture operation area 2420 including a listing 2421 of capture operations associated with the user. This area may include folders and/or a sorting mechanism to provide better access to large collections of captured content. The workbench also includes a workspace 2430 that allows the user to manipulate capture operations. In the example 2400, a capture operation 1 is associated with capture operations 2 and 3. The capture operation 2 also is associated with capture operations 4 and 5. One sequence of capture operations is operation 1, 2, 4, for example. A capture set includes 1, 2, 3, 4, and 5. Links 2435 are provided to indicate the relationships between capture operations shown in the work space.

When the user selects a capture set, widgets are displayed in the workspace that represent the capture operations. Once in the workspace, the user may associate capture operations. For example, a user may drag an operation from the capture operation listing into the workspace. The user may associate the capture operation with one or more other capture operations in the workspace. For example, the user may select two capture operations and drag a directional link from the tools to associate the capture operations. The workspace may submit the request to the database management system to associate the capture operations in which individual capture identifiers are sent as parameters, as well as a parameter that identifies which capture ID is the parent. This request is handled by a servlet of the service provider system that provides the association data to the database management system. The database management system creates a record in a database table that associates the capture operations. Using the user input association, the database management system classifies an operation as the parent and an associated operation as the child, thus establishing the directional association of the linking operations.

When a capture operation is selected for redisplay, the association data is collected as part of the display data used to create the display widget. The association records also are used to populate the navigation lists for the display widgets. When a linking navigation control is selected (the user is attempting to navigate to an associated capture operation), a request is submitted to the display servlet.

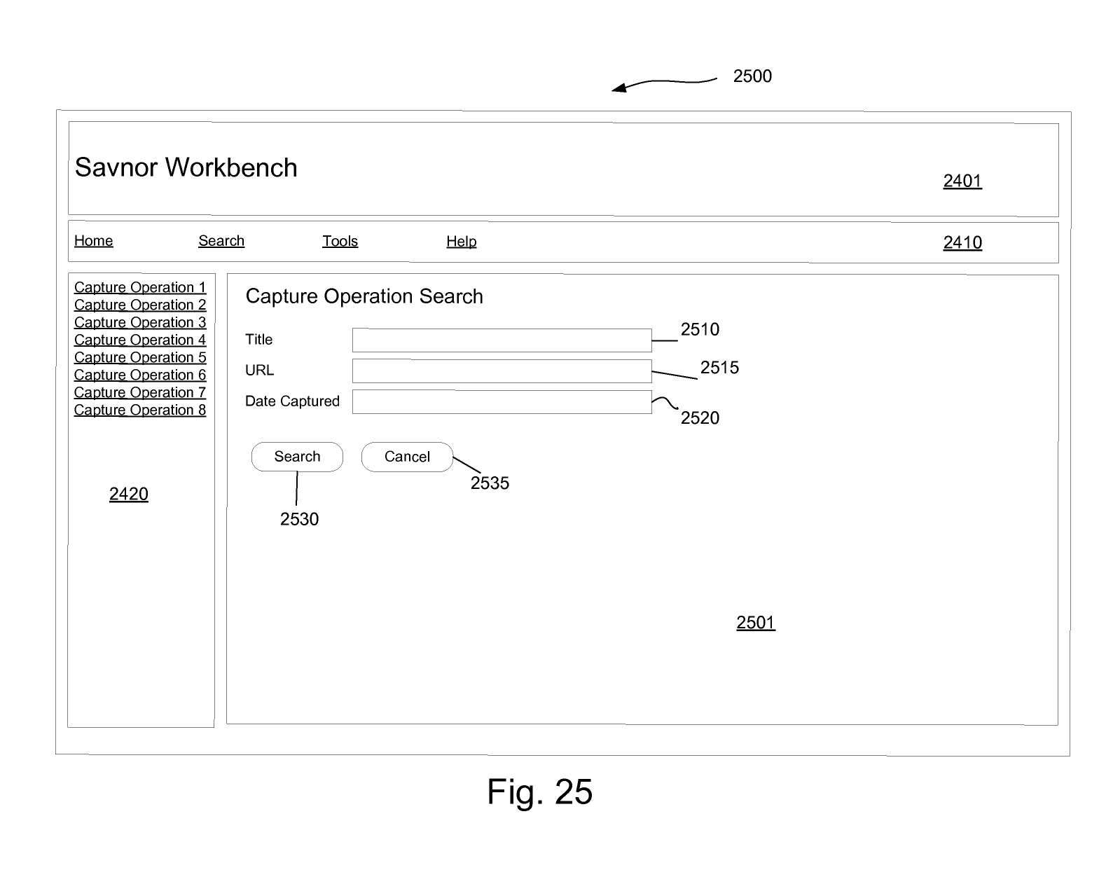

FIG. 25 shows an example 2500 of the workbench open to a search interface 2501. The search interface provides input fields to search for a specific capture operation. The fields may include a title 2510; a URL 2515, and a date captured 2520, of which one or more may be specified to search for a capture operation. In addition, a search 2530 and a cancel 2535 inputs are provided.

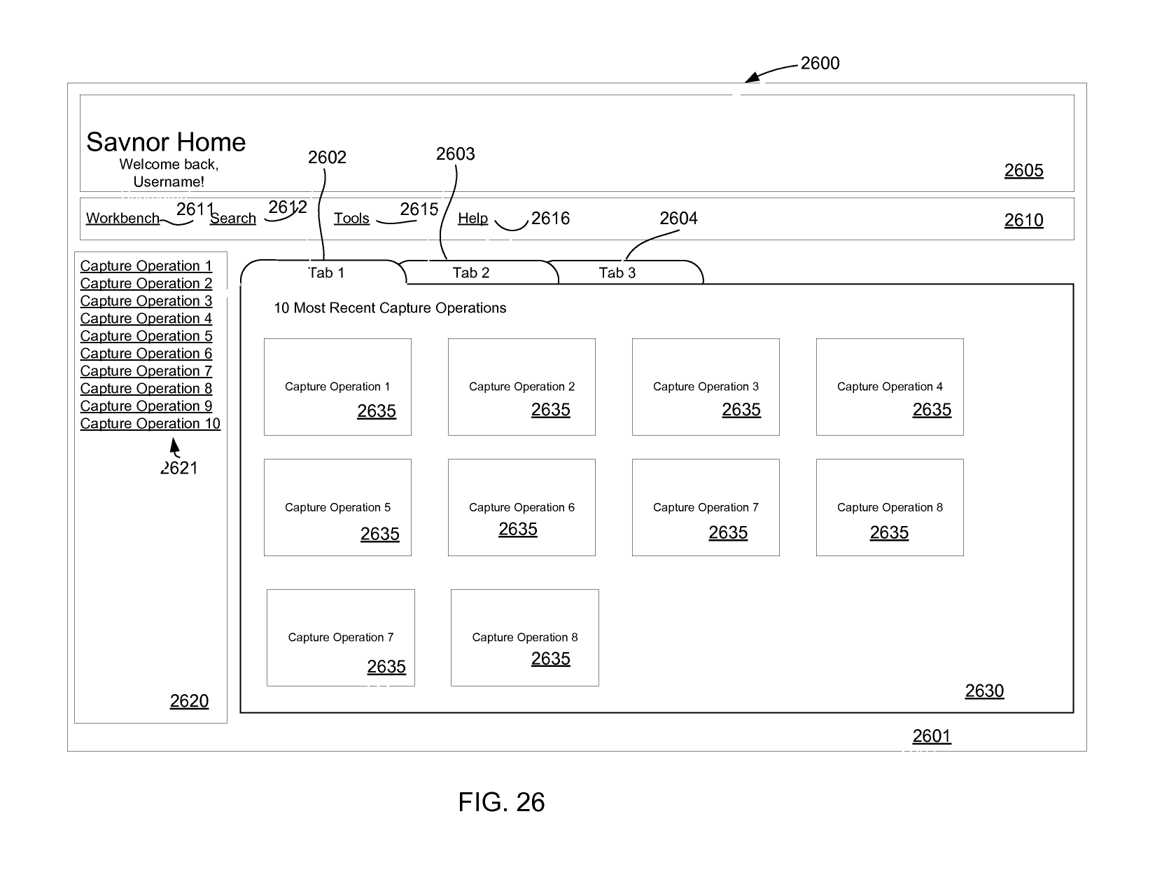

FIG. 26 shows an example of 2600 of a user start page or personal home page. When a user logs into or otherwise accesses the service provider system, a user home page or interface 2601 may be presented by a user device. The user interface allows a user to interact with associated capture operations (e.g., live or cached viewports/widgets), such as move them around and or drag and drop captured items into user defined tabs (e.g., 2602, 2603, and 2604). The user interface includes a title bar 2605 and a tool bar 2610 with inputs for a workbench page 2611, a search mechanism 2612, tools 2615, and help information 2616. The user interface also includes a capture operation area 2620 including a listing 2621 of capture operations associated with the user. This area may include folders and/or some type of sorting mechanism to provide better access to large collections of captured content. In addition, this area may provide a list of capture operations that the user selects to by display as a home page when accessing the service provider system, or present a default list or one of several user specified lists, such as the ten most recent capture operations. The user interface also includes a collection space 2630 showing one or more capture areas 2435. As a result, the user may have a customized home page that automatically displays capture areas selected by the user to organize and otherwise provide easy access to the user's captured content. Additionally, the service provider can transmit targeted ads based on a group of capture operations that are organized in to individual tabs.

Additionally, the service provider system provides a publish feature. The publish feature allows users who generate user defined views of web pages and/or workbench tabs to published the captured content or the tabs containing one or more items of captured content to the world wide web. To facilitate sharing of published content, the service provider system gathers indexing data used by a spider bot for the captured content, as part of the capture operation. The indexing data may then be used by search engines. In one example, the service provider system provides a crawl application. The application crawls the source page of a capture operation as part of the capture operation to gather data, such as, a webpage's metatags indicating that a certain subject matter has been captured.

In addition to the metadata collected by the capture operation to describe the capture operation, the capture operation also invokes a process in the same manner as a spider bot to crawl the page and collect the meta-tag information of the page. The results of the crawl process are stored in the database and associated with the capture operation identifier. The metadata is retrieved and embedded in the enclosing page of the capture widget when a display request is invoked. Since the pertinent indexing data is part of the enclosing page, the enclosing capture widget HTML page is essentially a crawlable proxy for the captured content. As a result, search engines are able to include links to user defined views of web pages and/or workbench tabs in the search results. Alternately, the service provider system may provide users with a “particle based” web search engine.

Metadata for a context, such as, for example, keywords, topics accessed, a referring source, a browser URL, a browser type, an IP address of user, a user geographic location, a date, and a time may be stored by the service provider system. In addition, a graphical image of the captured content is stored. The graphical image is processed by an image recognition system, such as IQ Engines or Google Goggles. Context information, such as the text based results from the processing of the images by the image recognition system combined, either alone or with the metadata, such as keywords and <title> information derived from the web page associated with the captured area is processed to determine what content the user is sharing or looking at in the captured area.

As a result, the service provider system provides a powerful system for data mining and analytics. Therefore, the service provider system also provides a mechanism to gather analytics, such as descriptive metadata for selection operations and information regarding the sharing of selected content. In addition, a management tool provides a mechanism to allow registered users (e.g., publishers, webmasters, affiliates, administrators, etc.) to view the analytical data gathered from the capture operations including a reporting mechanism to view and analyzed the gathered analytics.

For example, the service provider system may provide webmasters an analytics page. The analytics page provides metadata and statistical information derived from the captured content and its associated metadata. For example, a page may show the number of time a page was subject to a capture operation. In a further example, a heat map may show a user, such as a webmaster, which portions of the webpage are captured. In addition, a heat map may provide an easily identifiable visual indication of which portions of the page are the most captured or are hot. The heat map provides functionality to map all areas of a webpage that have been captured for given interval of time and provide a mechanism to graphically display the captured areas as outline or overlays.

A user interface to provide a heat map for a given URL is included as part of the analytics services provided by service provider system to webmasters, administrators, publishers, and affiliates. An authorized user logs into the service provider system and navigates to the analytics/reporting interface to select “Heat Map Reports.” The user is presented with a search form with input fields to enter a URL and a given time interval.

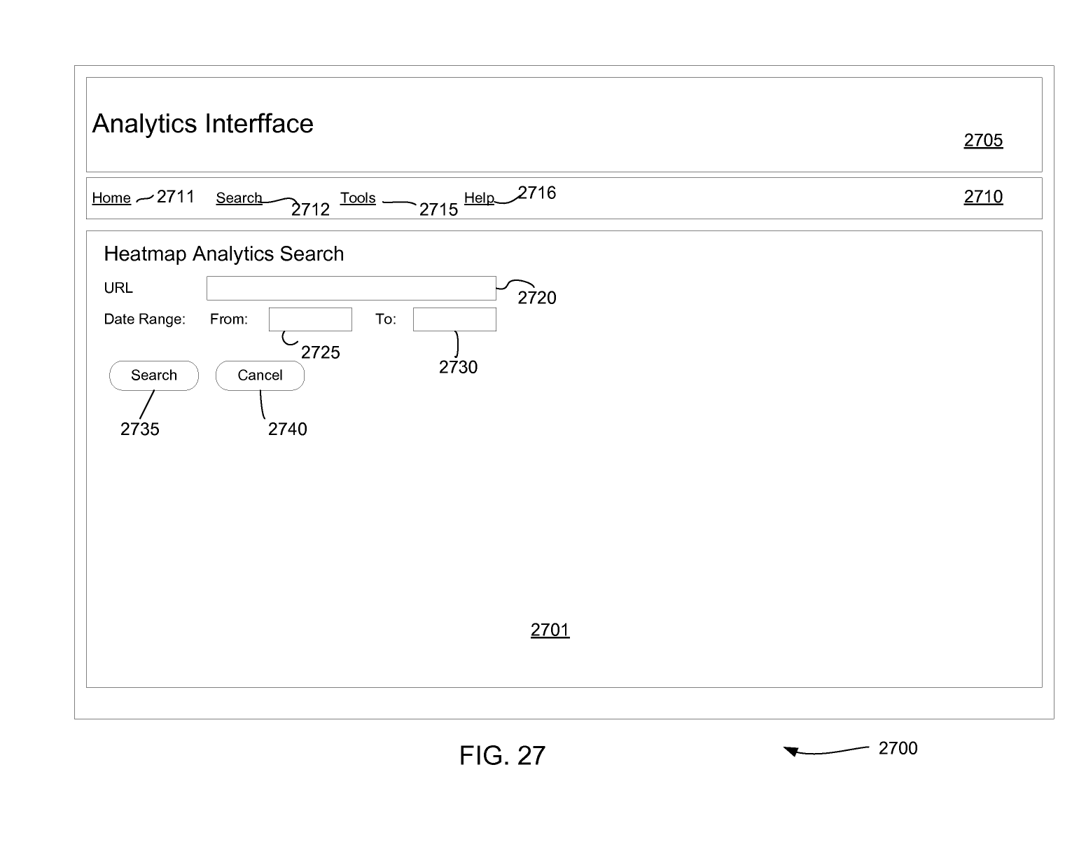

FIG. 27 shows an example of 2700 of a user heat map search page that is provided as part of the analytics heat map reports. When a web master, administrator, or other user logins into or otherwise accesses the analytics service of the service provider system, a heat map search interface 2701 may be accessed through the analytics service. The heat map search interface allows a user to select and/or build a heat map to analyze user interaction with a webpage. In particular, the heat map may be used to allow a user to see which portions of the web page are being captured using the capture operations. In addition, the heat map shows which portions of a webpage have been captured the most or are the “hottest” in terms of user interest. The heat map search interface includes a title bar 2705 and a tool bar 2710 with inputs for a home analytics bench page 2711, a search mechanism 2712, tools 2715, and help information 2716. The heat map search interface includes at least three input fields including a URL field 2720, a “from” date range field 2725, and a “to” date range field 2730. The user inputs a URL into the URL field for which a corresponding heat map is desired. The date range field are used to input a range of time for which the heat map is generated. In addition, two input buttons are provided including a search button 2735 and a cancel button 2740. The search button initiates the service to generate the desired heat map and the cancel button cancels any search that has already been started.

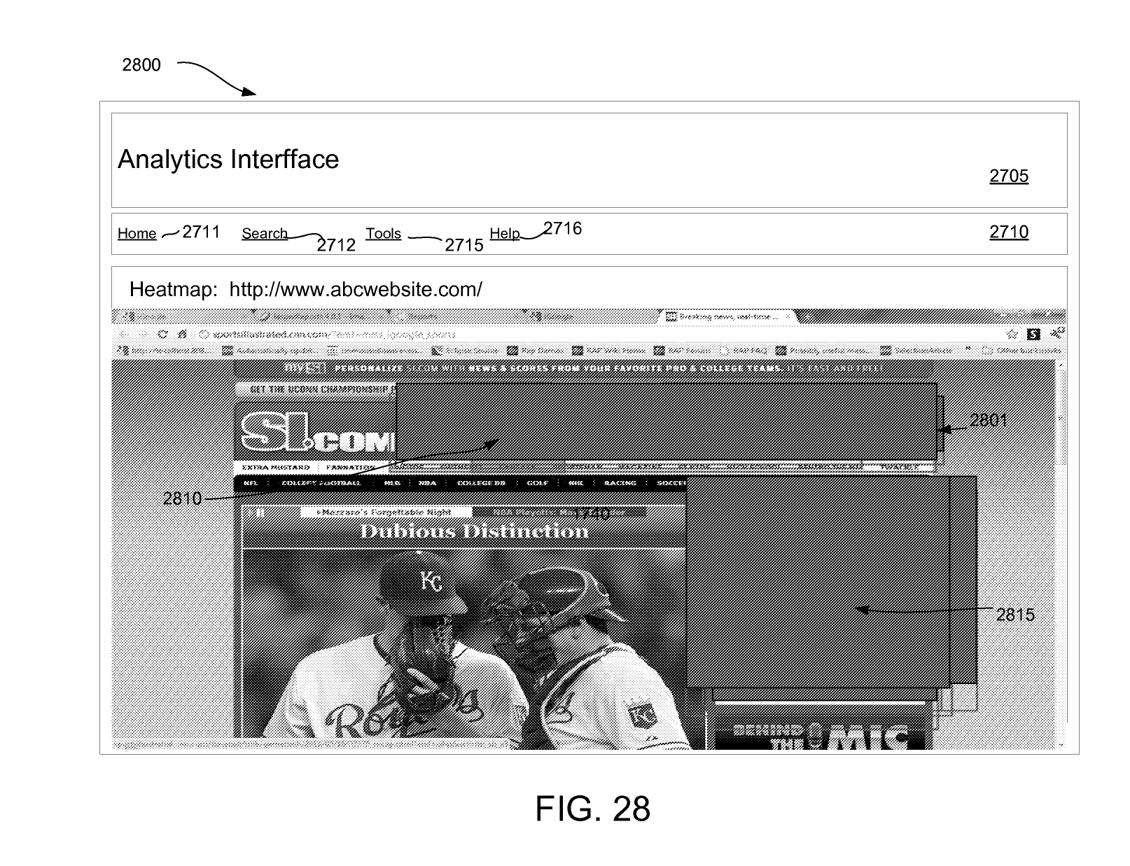

The user provides the inputs for the URL in the interface and submits the form to request a heat map report for a given URL for a given interval of time. For example, as shown in FIG. 28 the user enters “http://sportsillustrated.cnn.com/?eref=mrss_igoogle_sports” and a time interval (e.g. a “current date”). The request is submitted to the service provider system running an analytics application, such as a servlet. The application prepares a data transfer object (DTO) with the criteria and pass the DTO of the database management system via a delegate call.

The database management system queries the database using the criteria passed down from the application. For example, the query requests all URL capture records where the URL is equal to “http://sportsillustrated.cnn.com/?eref=mrss_igoogle_sports” and capture date equals current data. The query returns a result set that is used to create a collection of DTO objects containing URL capture metadata. This collection of DTOs is returned to the application to form the heat map for display to the user.

The analytics application receives the collection of capture metadata DTOs from the database management system. The collection is placed in a request attribute. The request is forwarded to the heat-mapping display interface.

FIG. 28 shows a screenshot of one example of a heat map for the web page http://sportsillustrated.cnn.com/?eref=mrss_igoogle_sports. Each outlined area shows an individual capture operation performed by a user of the system service provider on the web page. Each capture area is shown with an outline and corresponding visually distinct overlay, such as colored shading. Each overlapping capture area causes the visually distinct shading to grow deeper in color. As overlays stack up, hot spots of extreme user interest may be easily visually identified. As shown in this example, there are three specific “hot spots” 2801, 2810, 2815, in order from least to most hot

The heat-mapping display interface includes an iframe instance with the source attribute set to the URL for which the heat-mapping was requested. The interface uses JavaScript to iterate over the collection of capture metadata DTOs returned by the heat-mapping query. For each object in this collection, the following steps occur: creating a new transparent HTML <div> element; incrementing each <div> element with a higher html z-index style attribute, and creating a series of floating layers stacked on top of the iframe. On each newly-created <div>, a child <div> element is created using the capture metadata to define its boundaries. The <div> is created with a border which may be colored to help the user visually identify the area. After completion of this step, one additional floating layer is added to the page. This layer includes control elements, such as buttons, to allow the user to return to the analytics application. For example, buttons to toggle on/off the div elements (e.g., to better view the content of a hotspot) may be provided. After this final step, the page is loaded showing the embedded iframe, with the capture operations defined, as shown in the screenshot in FIG. 28. For example, note the semi-opaque selection squares seen on the screenshot 2800. This illustrates a possible “hot spot” 2810 on the page, which would exceed some threshold of captures, i.e., 25 or more captures of a specific area on a given day. In another example, for each capture area that overlays a previous capture area, the area may be slightly more opaque or slightly brighter in color. As overlays add up, the opaqueness or color intensity gives a clear visual indication to the user of the hot spots within the page.

Using a variance boundary (i.e. +/−20 pixels) to relate the upper-left starting coordinate of capture areas the system allows a user to narrow view of heat maps to a specific area of the page. As a result, clutter is reduced and the areas of the page are of most interest to the users of the application is clarified. Use of a similar variance boundary on all four points of the capture area provides normalization and smoothing of the heat mapping by averaging the size and position of statistically related capture areas allows for graphical improvements, such as color coding by statistical distribution.

Alternatively, an object may overlay the entire page obstructing the view and as the <div> elements are placed according to the capture operations, the transparency of the <div> elements may be increased. In this sense, hotspots burn through the opaqueness to clearly identify content of the hotspot. In yet another example, instead of varying the transparency of the <div> elements, a center pixel of each <div> element associated with a capture area may be determine and the pixel may be rendered to identify an area of the interest. The density of the rendered pixels then indicates the hotspots. Alternatively, the pixels may be color and/or transparency may be altered according to their density to aid visual identification of hotspots. For example, as the density of pixels indicating a capture area increases, the color of the pixels may gradually change for a cool color blue to a hot color red. Thus a very close grouping of pixels would be red indicating a hotspot.

There are several statistical analyses that can be performed on the capture metadata to refine and clarify what areas on a specific webpage are of most interest to users. The following are examples of possible analytics.

The analytics pages, including the heat maps, allow a webmaster to access and view the links that are being generated by the capture interface through use of the embedded web button, browser, or plugin/extension. As a result, a webmaster may view exactly what content is being viewed or shared and adjust his page by changing placement of content relative to other content to improve traffic to the site, length of stay (i.e., stickiness), and target advertising and placement of advertising.

A webmaster signing up for the analytics service can be given an option to allow or disallow the display of advertisements on a portion of the user interface presenting the capture viewport. In one example, a default mode may be set to use a third party advertising, such as Google AdSense, which transmits contextually based text-based advertising. In another example, the webmaster of a website may specify advertisements, such as advertisements that relate to the content that was captured or to other aspects of the webmaster's website. In yet another example, the service provider system may provide a service to webmaster to serve advertisement that relate to the captured content. A portion of the click through revenue/affiliate add revenue can be distributed to the merchant or webpage owner, the provider of the viewport functionality, and/or to any of the users sharing the content, as described in great detail below.

For example, a user may capture content that includes reference to or that is associated with a product or service, a third party advertising application, webmaster specified advertising, or and advertising service provided by the service provider. The user then shares the capture content. If a user then interacts with an advertisement, such as viewing, selecting, or purchasing a product or service associated with the shared captured content, the user who shared the content could earn credit, such as, for example, a fee, a commission, a portion of the sale, or other reward, such as incentives, coupons, discounts, free items or services, or related products or services. In another example, the system may track the number of times recipients of captured content selects the link associated with a product or service or otherwise interacts with the captured area and share in the “click through” revenue associated with the product, service, or capture area. In another example, the user may post captured content on a website, such as a personal webpage, a blog, or a community website, such as Facebook. Again, the user may earn a credit, such as fee or reward from purchases associated with the viewing of the captured content. In addition, a re-sender of shared content also could receive credit or compensation if sharing with subsequent individuals results in selection of (e.g., click through) or purchases of an online product or service associated with the shared captured content.

A user may signup to be an advertiser for the service provider system to receive compensation or credit, such as fees, rewards, or share click through revenues. As a result, individuals sharing web content gain a benefit, credit, or compensation for advertising and promoting products and services through the act of sharing. In other words, the user may participate or be rewarded based on “click-through” revenue or lead generation by self promoting products and services found on the web via a created widget.

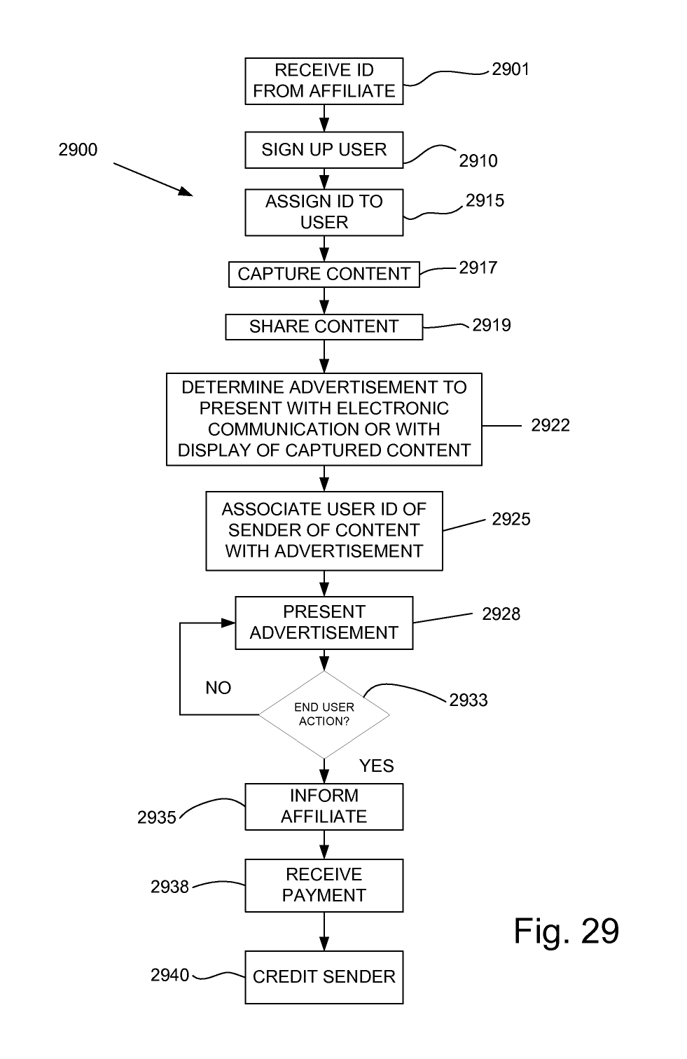

As mentioned above, the service provider system may establish relationships with one or more affiliate networks, advertisers, publishers, and/or directly with merchants themselves for sharing advertisement credits, revenues, and incentives with users that self promote products and service associated with advertisements of the affiliates thereby creating social affiliate marketing. FIG. 29 shows one example 2900 of a method for sharing advertisement revenue. The affiliate network, advertiser, or merchant provides the service provider system with an affiliate ID (2901). The affiliate ID allows the service provider system to associate certain end-user actions (e.g. a purchase, selection of content, a click, signing up or submission of contact information) made with the ID to the service provider system.

The service provider system signs up a user to participate in the affiliate program (2910). As users of the service provider system sign up to earn credit, such as revenue from sharing content using the service provider system content sharing tool, the service provider system assigns each user a unique affiliate ID (2915), (or sub ID) in effect creating its own affiliate network.

The user captures content (2917) as described above. The user shares the captured content with another user (2919) as described above using a communications system. The service provider system determines one or more advertisements to present with the electronic communication (e.g., in an email) or incorporated advertising presented in association with the content (e.g., alongside the display of the shared captured content) itself (2922). The advertisements may be text-based like Google AdSense, image based, video based, or some other format and may be based on the context of the shared content. The context of the shared content is derived by the service provider system from the metadata of the web page from which the content was captured or the web content itself. Examples of such metadata used for contextual determination includes, but is not limited to: URLs; META keywords; page titles; page headers; textual content of the page; and anchor tags of images. In addition, a graphical image of the captured content may be stored by the system. The graphical image is processed by an image recognition system, such as IQ Engines or Google Goggles. Information, such as the text based results from the processing of the images by the image recognition system can also be used as metadata for targeting advertisement. As a result, the targeted advertisements are more relevant to the content being shared. The advertisements may include one or more of or combinations of two or more of products, services, coupons, promotions, offers, trials, incentives, discounts, store credit, cash back, free products or services, product or service information, hyperlinks, animation, image, sounds, speech, graphics, special effects, among others.

Each determined advertisement is associated with the affiliate ID of the user sharing the content (2925). The service provider system monitors the receiving users for specific user actions (2933), such as a click of or purchasing a related product or service. Upon a user taking a specified action on the advertisement, the affiliate network, advertiser, or merchant is informed of the action which triggers a credit to the affiliate's account. Once the balance of the affiliate's account reaches a certain minimum threshold, a payment is triggered. The credit or payment from the merchant or affiliate network is received by the service provider system or is credited towards the service provider system account. This may be done by transaction or by a periodic reporting of actions. The service provider system in turn credits its own user affiliate accounts (or sub accounts) (2940). In one example, the credit or payout may be distributed according to a percentage wherein the credit is shared between the content sender and service provider system (e.g., 80% to content sender; and 20% to service provider system).

The system service provider also may track sharing of information between users and sell this information to the products and services industry. In addition, capturing and/or sharing of information may be used to target advertisements. Based on the determined content of the captured area, the service provider system may target advertising to both the user who captured the content and anyone the user shares the captured content with. For example, a user captures an area of webpage describing Colombian coffee and shares the captured content with a friend. The service provider system identifies the captured content, and presents an advertisement for the sale of Colombian coffee to both individuals on a portion of the user interface presenting the capture interface.

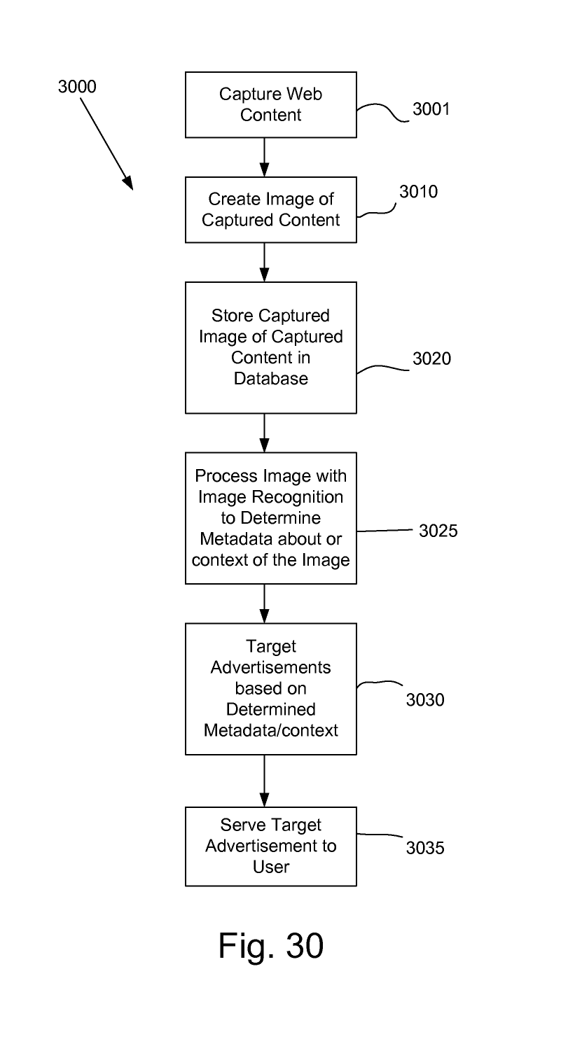

FIG. 30 shows an example 3000 of a process for targeting advertisements using the captured content stored in the database management system. Various users capture web content which is stored by the database management system of the system service provider (3001). The database management system creates images of each of the captured content operations (3010). The database management system stores the images of the captured content in a database associated with the captured content (3020). The database management system performs image analysis or queries an image recognition system, such as IQ Engines or Google Goggles to process the image of the captured content to create or determine metadata associated with the images (3025). For example, keywords describing or associated with the images may be determined. The service provider system may then target advertisements based on the determined metadata (3030) to serve advertisements to a user (3035).

As described above, the system service provider provides two modes of capture content: live and cached. However, given the dynamic nature of many websites, capturing of live content can be ephemeral. For example, if the headline from a news website is captured, subsequent viewing of the captured area the next day would likely provide a different headline. However, capturing of cached content preserves the content as it appeared at a moment in time. Capturing of cached content may be used in various ways. Cached content may be used to create historical archives and for research. As a result, the service provider system may charge a user fee to capture and store cached web content. The fee may be a onetime fee, a subscription, a periodic fee, a volume fee, among others. Fees may vary for the amount of time the content is cached. In addition, the user may be given options to cache content for different periods of time. A predetermined default period of time may be offered for free with a fee charged for any extension of the default period. Content also may have an expiration date. A different fee may be charged for use of live content or the service may be provided without a charge.

In yet another implementation, the capture tool may be used as a folding browser with a “chromeless” or floating window interface or a window without any border, for example, that is shown in FIGS. 31-38. FIGS. 31-38 show a desktop environment for a personal computer 3101. For example, as shown in FIG. 31, after executing the folding browser 3102 a webpage www.abcdwebsite.com 3103 is presented in a browser window 3105. A portion or user defined area 3110 of the webpage may be selected for capture using a user input device, as described in detail above. For example, a user may indicate a position 3107 in the rendered webpage with a mouse down and hold event and drag a mouse controlled cursor 3109 diagonally to visually indicate the user desired area 3110 for capture, by way of a dotted line 3115 of a marquee tool.

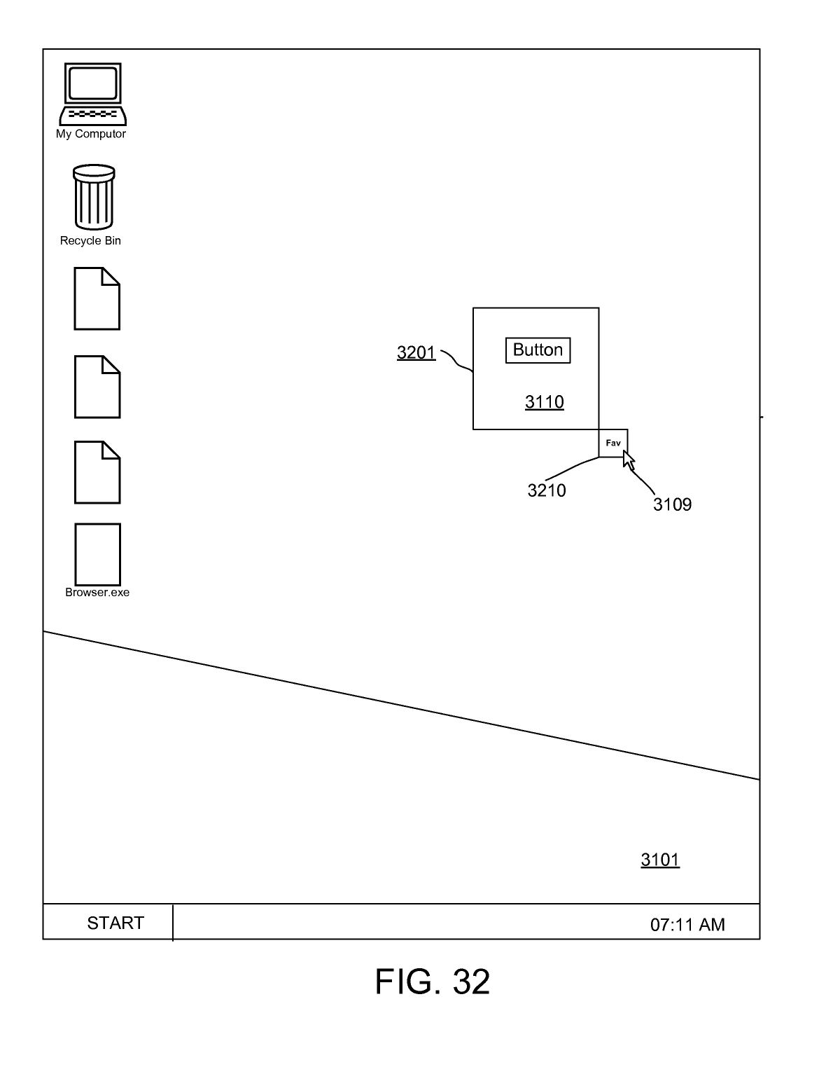

Once the content associated with the user defined area is identified or captured, the browser window 3105 is removed and the content instead is presented by the user device (e.g., on a desktop 3101 of the user device) in a chromeless capture area window 3201 of the browser, as shown in FIG. 32. The window is “chromeless” as the window is stripped of any border or other typical browser features, such as a title bar, tool bars, scroll bars, among other features. The chromeless capture area window also may be referred to as a foldable or collapsible browser because the browser window 3105 “folds” or collapses down to only the chromeless capture area window 3201. Once the browser folds, one or more attributes may be associated with the captured content. In one example, the browser displays a “chiclet” 3210 on the border of the chromeless capture area window 3201. For example, the chiclet may be attached to the bottom right corner of the chromeless browser capture area window. The chiclet provides a handle that the user may use to interact with or to select to manipulate the captured content and/or activate functionality of the browser or computer tool. In one example, the chiclet may be a website's Favicon, a logo, or a user defined graphic or graphic indicating the URL, or some combination of two or more of these. The chiclet may have some attributes of a title bar. For example, the chiclet along with attached chromeless capture area window can be moved in unison on the user's desktop, in the same manner that a window may be moved by selecting the title bar of a window (e.g., a mouse click and hold event) and moving a user input device (e.g., moving a mouse controlled pointer 3109 on the desktop that is associated with the selected chiclet).

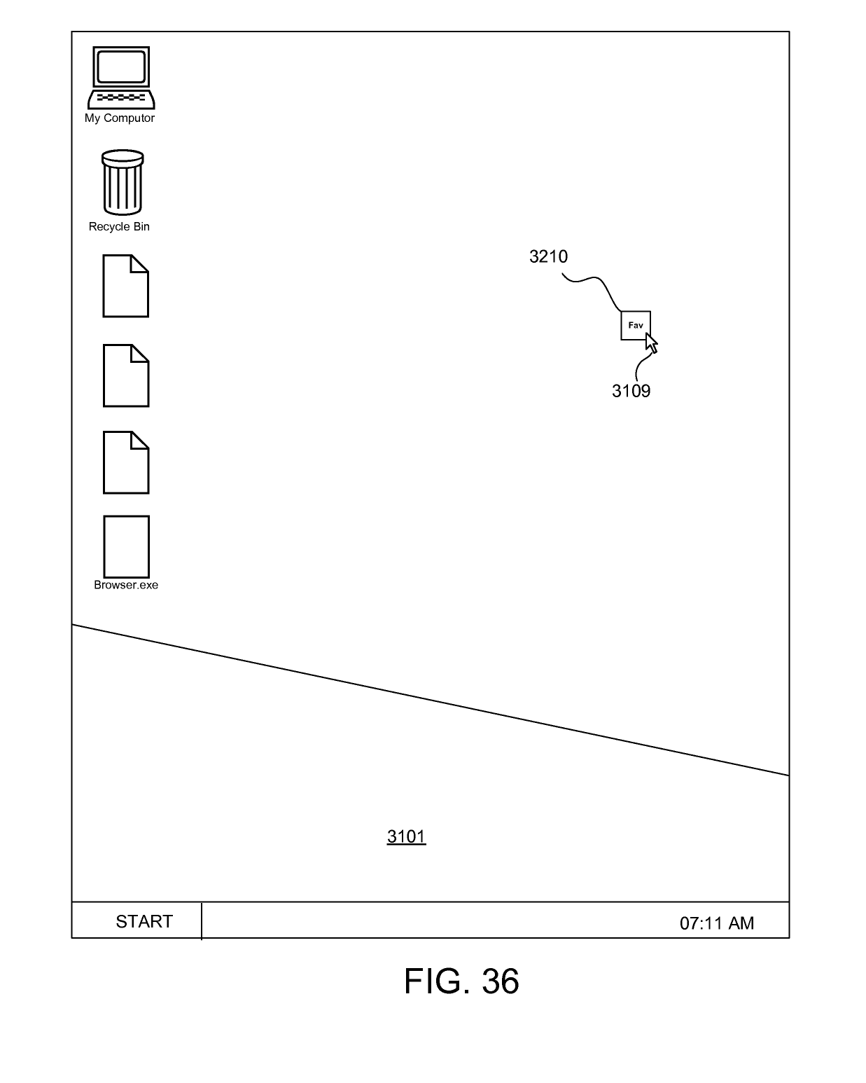

In one example, the user may repeatedly select (e.g., a single or series of clicks of the mouse associated with pointer 3109) the chiclet with a user input device to switch back and forth between 1) the showing only the Chiclet (e.g., as shown in FIG. 36) and 2) showing the Chiclet and the associated content (e.g., as shown in FIG. 32).

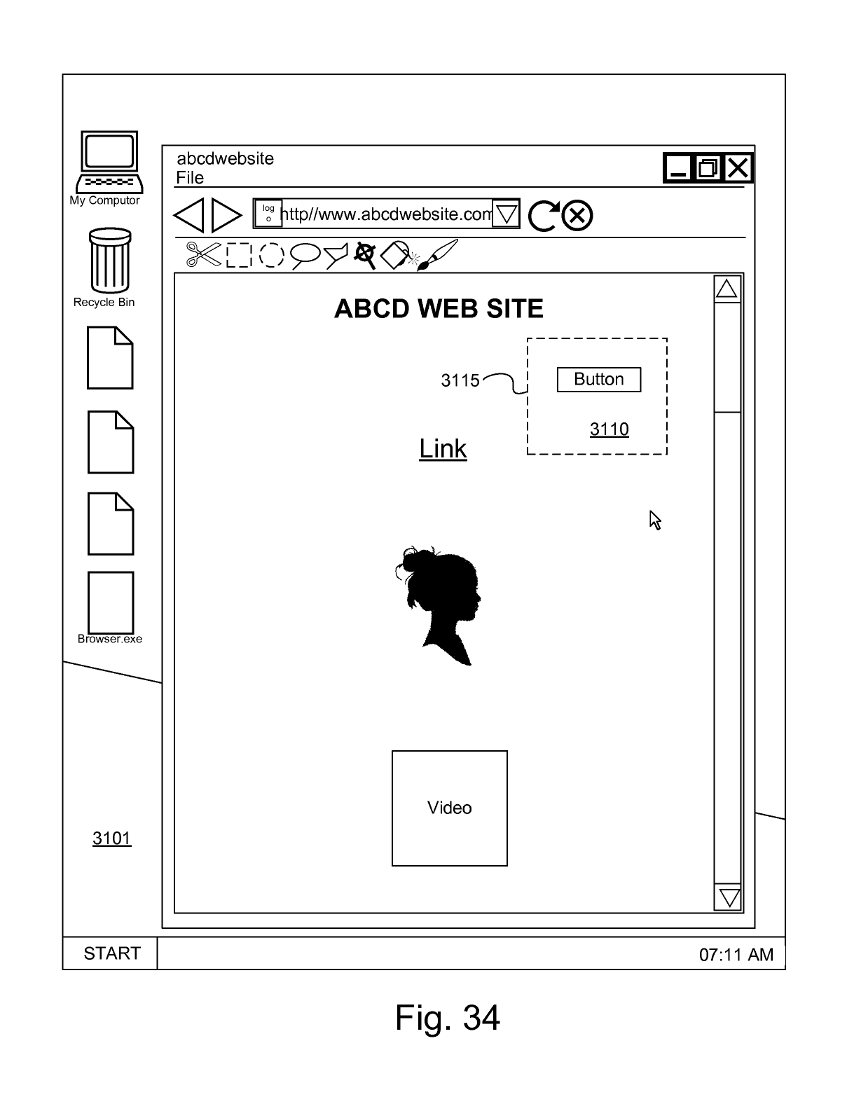

In yet another example, the user may repeatedly select (e.g., a single or series of clicks of the mouse associated with pointer 3109) the chiclet with a user input device to switch back and forth between 1) the expanded browser 3105 showing the defined content or the defined content plus the remainder of the web page rendered in the display window of the browser (e.g., as shown in FIG. 34) and 2) the collapsed, folded browser or chromeless capture area window 3201 presenting only the user defined or captured content of the web page with the chiclet (e.g., as shown in FIG. 32). In addition, the chiclet may be selected by a user input device to move the collapsed/folded browser window displaying only the user selected or captured content around the desktop or display screen of the user device, much like selecting the title bar of a window in the Window OS allows a user to move a display window on a desktop.

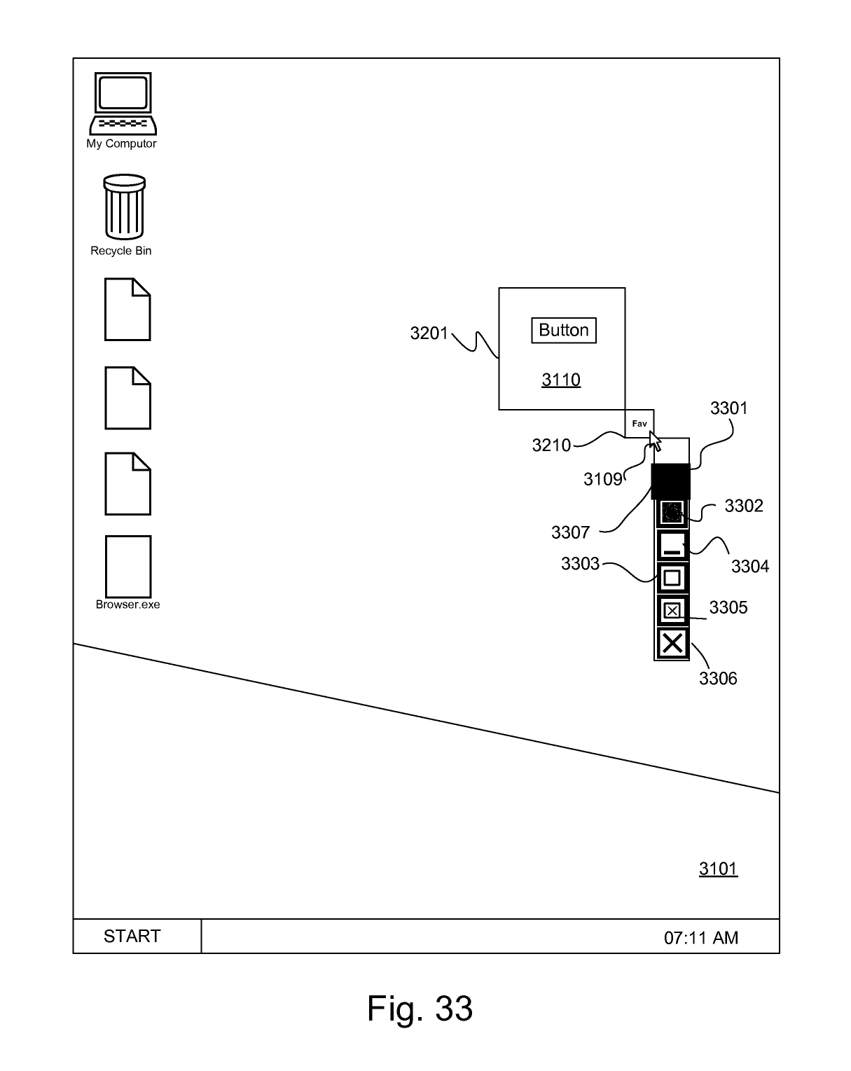

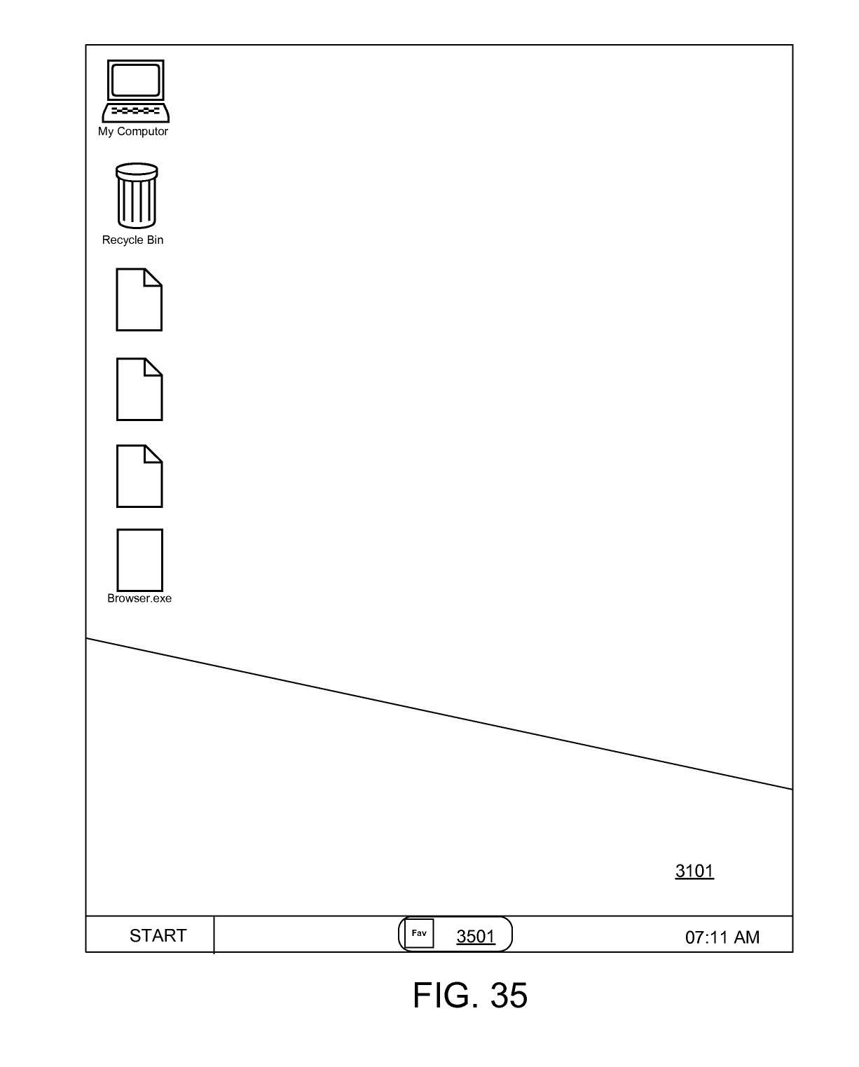

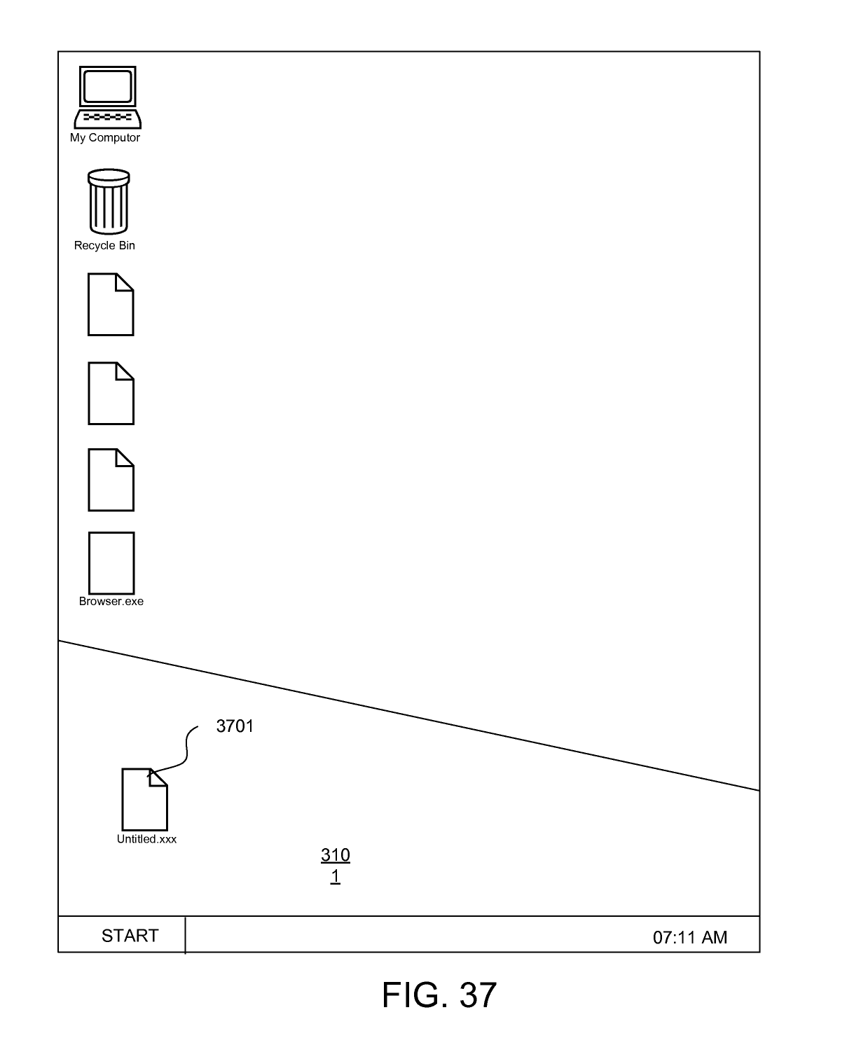

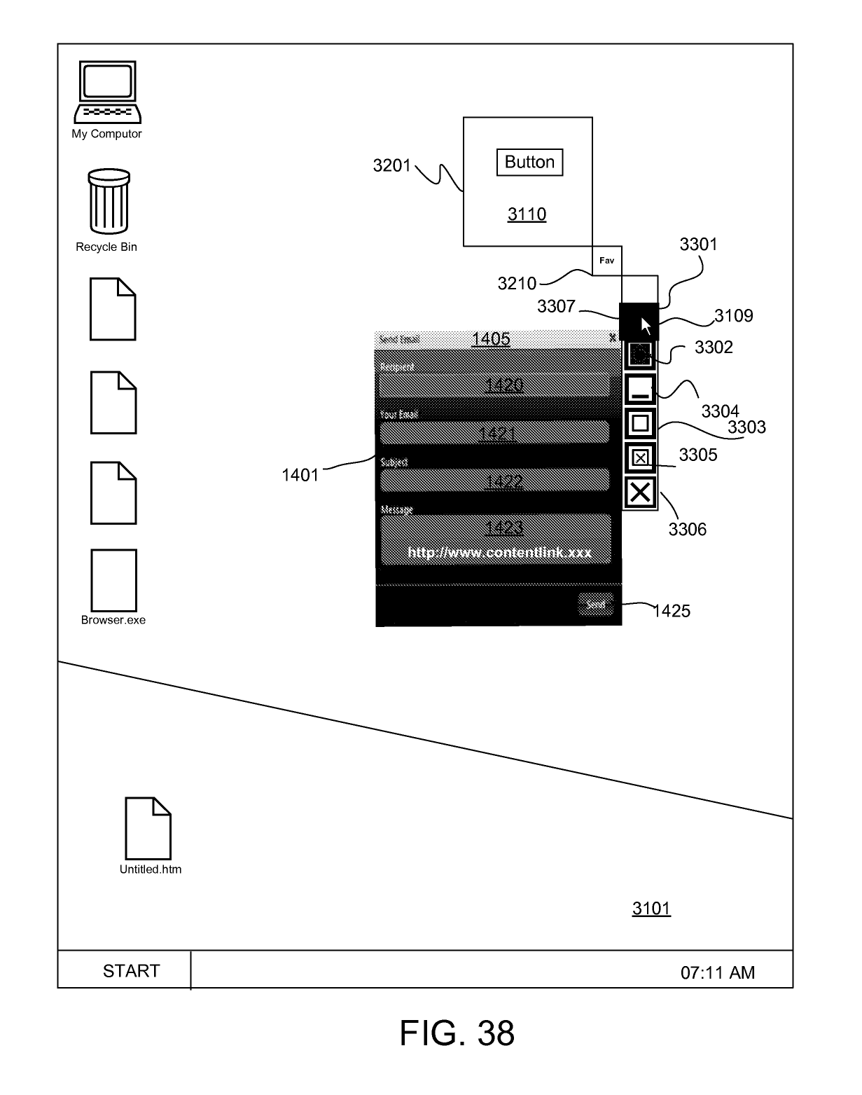

In another example, as shown FIG. 33, the user may select the chiclet (e.g., using a left click of the mouse controlling pointer 3109) using a user input device to cause a menu or a tool bar 3301 to appear to access additional functionality of the browser while the browser is collapsed or folded. For example, the menu or tool bar may include an input 3302 that is selected to refresh the captured content using the source URL or capture ID for the captured content displayed in the chromeless capture area window, an input 3303 that is selected to maximize the browser to the full browser window with an indication 3115 of the capture area 3110 (e.g., as shown in FIG. 34), an input 3304 that is selected to minimize the browser to a task bar 3501 (e.g., as shown in FIG. 35), an input 3305 that is selected to reduce the browser to just the chiclet (i.e., close the display of the chromeless capture area window to present only the chiclet on the display as shown in FIG. 36), an input 3306 that is selected to close the browser. If the user selects input 3306, the user can be prompted to save the captured content as a shortcut or file 3701 on the desktop (as shown in FIG. 37 I changed .html to .xxx). An input 3307 may be selected to cause the share interface 1401 to be displayed (as shown in FIG. 38) to share the content using a communications system or social networking site or personal start page or to access some other user defined functionality that has been added to the menu or tool bar.

The capture tools, processes, and systems provide extremely focused cataloging and easy retrieval of information gathered from the World Wide Web. This enables the user to select, save and later identify the selected content from the World Wide Web for future use by the user. With the proliferation of web content provided websites, the tool and system provide a quick and efficient means of navigating the content of the site. The user may go directly to a portion of the website that they find useful without having the distraction of other content on the site. For example, the user can select the daily weather forecast from a website. In addition, the user can interact with the portion of the webpage. The captured area also facilitates sharing of selected content via email, social media and other electronic means. Again, the capture area allows a user to share content efficiently by focusing another user's attention to the desired content without the distraction of other content on the webpage. However, the rendering is not merely a screenshot but an interactive portion of the webpage. This provides infinite control of web content by the user that is important to the user and not merely what a web master or designer thinks is important. In addition, analytics provided by the system allow web designers to analyze how content is being shared, what content is most popular, and to better target advertisements. In addition, users can promote products and services by sharing the captured content. In addition, the user can partake in the associated advertisement revenue wherein the end user is the advertiser partaking in a new world of social affiliate marketing.

A number of exemplary implementations have been described. Nevertheless, it will be understood that various modifications may be made. For example, suitable results may be achieved if the steps of described techniques are performed in a different order and/or if components in a described components, architecture, or devices are combined in a different manner and/or replaced or supplemented by other components. Accordingly, other implementations are within the scope of the following claims.

1-103. (canceled)

104. A method of providing a heat map configured to present capture operations corresponding to user specified content captured from a webpage of a content provider system, the method comprising:
displaying an iframe instance with a source attribute set to a uniform resource locator (URL) corresponding to the website;
iteratively displaying a collection of capture metadata objects associated with the capture operations of user specified captured areas within the webpage corresponding to the captured web content, including:
for each capture metadata object in the collection:
creating a transparent markup tag element; and
incrementing a z-index attribute for each markup tag element,
creating a series of floating layers stacked on top of the iframe for each markup tag element, wherein each markup tag element is created using capture metadata corresponding to a capture operation of a user specified captured area within the webpage.

105. The method of claim 104 wherein each markup tag element is created having a colored border configured to aid visual identification of a captured area associated with a corresponding capture operation.

106. The method of claim 105 wherein each markup tag element is created with a transparent masking configured to aid visually identification of a captured area associated with a corresponding capture operation.

107. The method of claim 104 wherein where two markup tag elements overlap the masking of the corresponding overlapping area is visually distinguished.

108. The method of claim 107 wherein where two markup tag elements overlap the masking of the corresponding overlapping area is visually distinguished.

109. The method of claim 104 wherein where two markup tag elements overlap the transparency of the corresponding overlapping area is decreased

110. The method of claim 104 wherein creating the markup element includes determining a center pixel of a corresponding capture area and creating a visual indication corresponding to the center pixel.

111-114. (canceled)
